(19) United States
(12) Patent Application Publication
(10) Pub. No.: US 2026/0070298 A1
(43) Pub. Date: Mar. 12, 2026

(54) EXPANDED SLIT SHEET VOID FILL DISPENSING SYSTEMS AND METHODS

(71) Applicant: HEXCELPACK, LLC, Sedona, AZ (US)

(72) Inventors: David Paul Goodrich, Sedona, AZ (US); Kyle Harris, Bristol, CT (US)

(21) Appl. No.: 19/283,548

(22) Filed: Jul. 29, 2025

Related U.S. Application Data
(63) Continuation-in-part of application No. 18/586,916, filed on Feb. 26, 2024.
(60) Provisional application No. 63/448,335, filed on Feb. 26, 2023.
(60) Provisional application No. 63/676,495, filed on Jul. 29, 2024.

(51) Int. Cl. B31D 5/00; B65H 35/00

(52) U.S. Cl. CPC B31D 5/0065; B65H 35/002; B65H 2301/415016; B65H 2301/5124; B65H 2404/1151; B65H 2701/1944

(57) ABSTRACT

According to some embodiments, a dispenser for expanding and dispensing paper void fill is provided. In some examples, the dispenser includes: a supply of expandable slit sheet paper; a support for holding the supply of expandable slit sheet paper; a friction member arranged proximate the supply of expandable slit sheet paper and arranged such that an end of the expandable slit sheet paper contacts the friction member as the expandable slit sheet paper is manually or automatically pulled based said friction member; and the friction member including a plurality of inwardly extending projections configured to provide frictional resistance to the expandable slit sheet paper to cause the expandable slit sheet paper to expand into an expanded state with open cells.

### CROSS-REFERENCES TO PRIORITY APPLICATIONS

The present application claims priority to U.S. provisional application Ser. No. 63,676,495, filed Jul. 29, 2024, the entire disclosure of which is incorporated herein by reference in its entirety.

The present application is also a continuation-in-part of U.S. application Ser. No. 18,586,916, filed Feb. 26, 2024, which 18,586,916 application is a non-provisional of U.S. Provisional App. No. 63,448,335, filed Feb. 26, 2023, the disclosures of which are both also incorporated herein by reference in their entireties.

### Cross-References to Patents and Patent Applications Incorporated by Reference

The entire disclosures of a) U.S. Pat. No. 10,669,086, issued Jun. 2, 2020, b), c) U.S. Pat. No. 10,226,907, issued on Mar. 12, 2019, d) U.S. application Ser. No. 16,274,028, filed Feb. 12, 2019, as a divisional of U.S. Pat. No. 10,226,907, and e) 16,870,195, filed May 8, 2020, entitled “Extensible Paper and its Use in the Production of Expanded Slit Packaging Wrap and Void Fill Products” are each incorporated by reference herein in their entireties, as though recited in full herein.

The entire disclosure of U.S. application Ser. No. 17,175,148, to David P. Goodrich, filed on Feb. 12, 2021, is incorporated herein by reference in its entirety, which 17,175,148 application is a non-provisional of each of the following prior provisional applications, the entire disclosures of which are all incorporated herein by reference in their entireties: (1) U.S. Provisional Application No. 62,975,678, filed Feb. 12, 2020; (2) U.S. Provisional Application No. 62,976,930, filed Feb. 14, 2020; (3) U.S. Provisional Application No. 62,980,122, filed Feb. 21, 2020; (4) U.S. Provisional Application No. 62,983,601, filed Feb. 29, 2020; (5) U.S. Provisional Application No. 63,000,390, filed Mar. 26, 2020; (6) U.S. Provisional Application No. 63,020,016, filed May 5, 2020; (7) U.S. Provisional Application No. 63,064,393, filed Aug. 11, 2020.

### BACKGROUND

### Field of the Invention

The preferred embodiments of the present invention relate to the use of expanded slit sheet paper for cushioning properties, and the most preferred embodiments provide novel and advantages systems and methods of employing expanded slit sheet paper as a void fill product in a manner that was previously unknown and not possible within the art of cushioning products.

According to some illustrative embodiments, a void fill dispenser is provided that advantageously dispenses unique void fill in a manner not previously possible. In some embodiments, the void fill dispenser is made with a recyclable material, such as, e.g., a corrugated box made from paper. In some embodiments, the void fill dispenser is made with metal and/or other rigid and/or non-recyclable materials. In some embodiments, the void fill dispenser can comprise an automated metal dispensing system that dispenses expanded slit sheet paper particularly for void fill in an automated manner.

### SUMMARY

The preferred embodiments of the present invention overcome and improve upon various problems and limitations in the background art.

In contrast to the background art, the present invention provides void fill dispenser systems and methods that highly effectively enable the easy and usable creation of void fill with expanded slit sheet paper in a manner unattainable in the existing art.

According to some illustrative embodiments, a void fill dispenser is provided that advantageously dispenses unique void fill in a manner not previously possible. In some embodiments, the void fill dispenser is made with a recyclable material, such as, e.g., a corrugated box made from paper. In some embodiments, the void fill dispenser is made with metal and/or other rigid and/or non-recyclable materials. In some embodiments, the void fill dispenser can comprise an automated metal dispensing system that dispenses expanded slit sheet paper particularly for void fill in an automated manner.

According to some preferred embodiments, the instant art of the void fill system is made from a roll of unexpanded extensible slit sheet material, such as, e.g., employing extensible papers as described herein and as described in U.S. Pat. No. 10,669,086. In preferred embodiments, this roll is placed into a box and oriented such that the dispensing of the expanded slit sheet material is done from center of the wound roll. In order to stabilize the roll and hold it in position, the dispensing system encapsulates or otherwise stabilizes the roll to provide ease of use and an opening to allow the material to exit continuously. In the preferred embodiments, the opening is also specially designed to provide frictional resistance to effect expansion of the slit sheet material.

The preferred embodiments of the present invention provide a very unique and novel structure that enables a highly useful void fill product to be created in a manner that was wholly impossible with the background art.

In some of the preferred embodiments, of the invention, a void fill dispensing system and method is provided that can—highly advantageously—create a viable void fill product from expandable slit sheet paper despite the fact that such was previously not feasible or was impossible with the background art.

According to some preferred embodiments, a novel dispenser mechanism includes a support for a roll of expandable slit sheet material (preferably, a roll of extensible slit sheet material), and a specially designed restricting orifice that is configured to receive expandable slit sheet paper that is laterally pulled from a center of the roll of expandable slit sheet material.

While this disclosure is not limited by proposed theories, the present inventor has found that by establishing a center pull mechanism, when employing an extensible slit sheet paper, and when employing a specially configured outlet that a) provides sufficient resistance to enable expansion, b) avoids premature tearing or “catching” of the cells of the paper, c) enables the paper to flow or move through the specially configured outlet in a manner that the expanded slit sheet paper freely twists and/or folds during expansion enables the creation of highly useful and advantageous expanded slit sheet paper void fill (e.g., directly or immediately after expansion) without requiring secondary steps such as, e.g., rolling or wrapping of the expanded sleet sheet paper. The present inventor theorizes that his unique system advantageously enables the paper to twist and/or to fold in a manner that causes the expanded cell to retain or substantially its expanded state without significant retraction. Thus, while one of ordinary skill in the art would expect that expanded hexagonal cell forming slit sheet material would retract and fail to provide adequate cushioning, it has now been found that the inventor's novel process of center pulling hexagonal cell forming slit sheet material can cause the expanded cells to remain expanded.

Although embodiments of the present invention could be implemented without the use of extensible slit sheet paper, the present inventor has also discovered that due to the unfavorable properties of expandable slit sheet papers that are not extensible, systems that do not employ extensible slit sheet paper would be substantially less viable.

In some of the preferred embodiments of the present invention, the present invention can include one or more of the following illustrative aspects (i.e., aspects 1-42 below).
1. According to a first embodiment (i.e., first aspect), a dispenser for expanding and dispensing paper void fill is provided that includes:
a supply of expandable slit sheet paper;
a support for holding the supply of expandable slit sheet paper;
a friction member arranged proximate the supply of expandable slit sheet paper and arranged such that an end of the expandable slit sheet paper contacts said friction member as said expandable slit sheet paper is manually or automatically pulled based said friction member; and
said friction member including a plurality of inwardly extending projections configured to provide frictional resistance to the expandable slit sheet paper to cause the expandable slit sheet paper to expand into an expanded state with open cells.
2. The dispenser of aspect 1 above, wherein said friction member is an outlet arranged proximate the supply of expandable slit sheet paper and arranged such that the end of the expandable slit sheet paper extends through said outlet, said outlet having a maximum cross dimension that is substantially smaller than the width of the expandable slit sheet paper
3. According to another embodiment, a dispenser for expanding and dispensing paper void fill is provided that includes:
a supply of expandable slit sheet paper;
a support for holding the supply of expandable slit sheet paper;
an outlet arranged proximate the supply of expandable slit sheet paper and arranged such that an end of the expandable slit sheet paper extends through said outlet, said outlet having a maximum cross dimension that is substantially smaller than the width of the expandable slit sheet paper; and
said outlet including a plurality of inwardly extending projections configured to provide frictional resistance to the expandable slit sheet paper to cause the expandable slit sheet paper to expand into an expanded state with open cells.
4. The dispenser of aspects 1 or 3 above, wherein said inwardly extending projections are configured to facilitate expansion of the expandable slit sheet paper without tearing the expandable slit sheet paper.
5. The dispenser of aspect 4 above, wherein said inwardly extending projections include bristles.
6. The dispenser of aspect 5 above, wherein said bristles have a length of between about ½ inch and 1½ inch.
7. The dispenser of aspects 1, 5 or 6 above, wherein said bristles are flexible.
8. The dispenser of any of aspects 5 to 7 above, wherein said bristles have a diameter of between about 0.005 to 0.01 inches.
9. The dispenser of any of aspects 5 to 8 above, wherein said bristles are made with plastic.
10. The dispenser of aspect 9, wherein said bristles are made with nylon.
11. The dispenser of any of the preceding aspects, wherein said supply of expandable slit sheet paper is a roll of expandable slit sheet paper.
12. The dispenser of aspect 11 above, wherein said outlet is arranged to receive said slit sheet paper from a center of the roll of expandable slit sheet paper.
13. The dispenser of any of aspects 11 or 12, wherein said outlet is aligned with a center axis of said roll of expandable slit sheet paper.
14. The dispenser of any of aspects 11 or 12, wherein said outlet is laterally positioned adjacent a lateral side of the roll to receive said slit sheet paper from a center of the roll of expandable slit sheet paper.
15. The dispenser of any of the preceding aspects, wherein the outlet includes a donut member fixed within a plate or panel.
16. The dispenser of aspect 15, wherein the donut member is made with plastic or metal.
17. The dispenser of any of the preceding aspects, wherein the dispenser is configured for manual operation with a user manually pulling the expandable slit sheet paper through the outlet.
18. The dispenser of any of the preceding aspects, wherein the dispenser is configured for automated operation and includes at least one roller configured to move the expandable slit sheet paper through said outlet.
19. The dispenser according to any of the preceding aspects, wherein said plurality of inwardly extending projections extend inwardly around at least ¼ of the perimeter of the outlet.
20. The dispenser according to any of the preceding aspects, wherein said plurality of inwardly extending projections extend inwardly around at least ½ of the perimeter of the outlet.
21. The dispenser according to any of the preceding aspects, wherein said plurality of inwardly extending projections extend inwardly around at least ¾ of the perimeter of the outlet.
22. The dispenser according to any of the preceding aspects, wherein said plurality of inwardly extending projections extend inwardly around substantially the entire perimeter of the outlet.
23. The dispenser according to any of the preceding aspects, wherein:
said outlet has a substantially circular perimeter.
24. The dispenser according to any of the preceding aspects, wherein:
said outlet has a substantially D-shape perimeter.
25. The dispenser according to any of the preceding aspects, wherein:
the outlet has a configuration that includes an arc that extends around at least ½ of the perimeter of the outlet.
26. The dispenser according to any of the preceding aspects, wherein:
the outlet has a configuration that includes an arc that extends around at least ⅔ of the perimeter of the outlet.

27. The dispenser according to any of the preceding aspects, wherein:
the outlet has a configuration in the shape of a semi-circle or half-circle or partial-circle.
28. The dispenser according to any of the preceding aspects, wherein said outlet has a maximum dimension across said outlet of less than 5 inches.
29. The dispenser according to any of the preceding aspects, wherein said outlet has a maximum dimension across said outlet of less than 4 inches.
30. The dispenser according to any of the preceding aspects, wherein said outlet has a maximum dimension across said outlet of between 1-½ to 5 inches.
31. The dispenser according to any of the preceding aspects, wherein said outlet has a maximum dimension across said outlet of between 2 to 4 inches.
32. The dispenser according to any of the preceding aspects, wherein said expandable slit sheet paper is made of an extensible paper having an extensibility in a machine direction in a range of between 5-20%.
33. The dispenser according to any of the preceding aspects, wherein said outlet is adjustable.
34. The dispenser according to any of the preceding aspects, wherein said outlet includes at least a portion that is movable such as to adjust the size or shape of the outlet.
35. The dispenser of aspect 1 above, wherein said inwardly extending projections are configured to facilitate tearing of the expandable slit sheet paper.
36. The dispenser of aspect 35 above, wherein said inwardly extending projections are projecting teeth.
37. According to another embodiment (i.e., another aspect), a method of forming a void fill product, comprising:
providing a sheet of expandable slit sheet paper in an unexpanded state, said sheet of expandable slit sheet paper having a length that is substantially greater than a width across the expandable slit sheet paper;
directing the expandable slit sheet paper through an outlet, said outlet having a maximum cross dimension that is substantially smaller than the width of the expandable slit sheet paper, and said outlet including a plurality of inwardly extending projections configured to provide frictional resistance to the expandable slit sheet paper; and
expanding the expandable slit sheet paper to an expanded state in which the slits of the expandable slit sheet paper expand into open cells due to friction applied by the outlet and causing regions of the expandable slit sheet paper across a widthwise direction of the expandable slit sheet paper to contact one another during said expanding or shortly after said expanding.
38. The method of aspect 37 above, further comprising:
during directing of the expandable slit sheet paper through the outlet, causing the expandable slit sheet paper to twist, rotate or move around an axis extending through the outlet.
39. The method of any of aspects 37 to 38 above, further comprising:
wherein said inwardly extending projections include bristles, said bristles engaging said expandable slit sheet paper as said expandable slit sheet paper is pulled through said outlet and said bristles flexibly bending while applying friction to said expandable slit sheet paper.
40. The method of any of aspects 37 to 39 above, further comprising:
wherein said bristles are made with plastic.
41. The method of any of aspects 37 to 39 above, wherein said bristles have a length of between about ½ inch and 1½ inch.
42. The method of aspect 41 above, wherein said bristles have a diameter of between about 0.005 to 0.01 inches.

### Expanded Slit Sheet Paper Art Incorporated by Reference

Further information relating to illustrative expandable slit sheet paper that can be employed in various embodiments of the present invention, slit patterns, and the expansion process by which such expandable slit sheet paper is expanded is found in U.S. Patents a) 5,538,778, b) 5,667,871, c) 5,688,578, d) 5,782,735, e) 3,908,071, f) 3,104,197, g) 3,220,116, h) 3,266,972, i) 3,269,393, j) 3,908,071, k) 6,024,832, l) 6,458,447 and m) 6,712,930, and in U.S. application Ser. No. 14,901,977, and in PCT application No. WO1984002936A1, and in U.S. Published Patent Application Nos. US 2002/0060034, US 2007/0240841, and the disclosures of which are all incorporated by reference herein in their entireties, as though recited in full herein.

In the preferred embodiments, the terminology “expandable” as applied to paper sheets, means a paper having a slit pattern that enables expansion of the paper, such as, e.g., as disclosed in U.S. Pat. Nos. (a) 5,538,778, (b) 5,667,871, (c) 5,688,578, (d) 5,782,735 and (e) 10,226,907, and in PCT Application No. PCT/US2014,054615, the entire disclosures of which patents and PCT application are all incorporated by reference herein as though recited in full. In the preferred embodiments, a slit pattern is configured to enable the paper to be expanded lengthwise, with a related decrease in width. In some embodiments, the slit pattern produces a paper that increases in length due to the slit pattern when processed in an expander, such as, e.g., an expander of the type described in any of the following U.S. and PCT applications (a) 2017/0203866, (b) 2018/022266, (c) 2018/0127197, and (d) PCT/US2014/054615, incorporated herein by reference in their entireties.

U.S. Pat. Nos. 5,667,871 and 5,688,578, slit Sheet Packing Material, teach the use of a plurality of individual slits forming parallel spaced rows forming a hexagonal expanded sheet with and without a separator sheet. It requires machinery to stretch the paper into its three-dimensional shape at the customer's location such as disclosed in U.S. Pat. No. 5,538,778 which teaches the method and apparatus for producing the expansion of the slit sheet material performed at the packing site's location. U.S. Pat. No. 5,782,735 discloses an expander for expanding the slit sheet material of U.S. Pat. Nos. 5,667,871 and 5,688,578.

For reference, FIGS. 3(A) and 3(B) correspond to FIGS. 1 and 3 of U.S. Pat. No. 5,667,871 (the '871 patent). These figures describe existing “slit sheet” expandable paper structure. As explained in the '871 patent:

“The slit paper, indicated generally as 10, is illustrated in FIG. [3(A)] as it would come off the slitting machine. The sheets can be formed on a flat-bed slitter and produced directly as rectangular sheets, as well as on a rotary slitter and cut into individual sheets or stored directly as a continuous sheet in roll form. The flexible sheet 10 is preferably manufactured from exclusively recycled paper with the grain of the paper running in the direction of arrow A. The flexible sheet 10 is provided with slits 14 and slits 16 are parallel to the edges 22 and 24 of the flexible sheet 12 and perpendicular to the paper grain. The slits 14 and slits 16 are placed in rows and separated from one another by land 20 and legs 21[shown in FIG. 3(B)]. The land 20 is a consistent size and provides the support required to prevent the paper from tearing into strips when opened. The cushioning effect is produced by the flexing of the lands and legs under a load. It is therefore necessary that the land 20 be of sufficient size to provide cushioning. The spacing between the rows of slits 14 and slits 16 must also be of sufficient size to prevent the paper from tearing. The offset positioning of the rows of slits 14 and slits 16 gives the paper resiliency when opened and is discussed in detail further hereinafter. The existence of partial slits 14 and 16 at the ends 25 and 18 of the flexible sheet 10 do not hinder the efficiency of the slit paper 10. The flexible sheet 10 when flat; lies in a first plane.”

“When expanded, the expanded sheet, indicated generally as 12, is formed of hexagonal cells 26, legs 21 and land 20 areas, as illustrated in FIG. [3(B)]. Preferably, at least a majority of the land 20 areas lie in a plurality of parallel planes. The planes of the land 20 areas form an angle of at least about 45 degrees with the plane of the sheet in flat form.”

“The slitting operation in which the slits are cut into the sheet material can take several forms. In one embodiment, rectangular sheets are provide with its total number of slits in one action. The term rectangular should be understood to include rectangles in which all four sides are equal, that is, square. Where the sheet material is subjected to rotary cutting or slitting, the pressure required for the cutting action is significantly lower that which is required for the flat bed cut, since essentially only a single row or a few rows of slits are cut simultaneously. Unlike prior art structures and systems, expansion contemporaneous with slitting is not desirable. Therefore a critical balance must be struck between resistance to opening of the cells during the rewind step and ease of opening of cells during the expansion step. By achieving this critical balance and producing a flat, unexpanded sheet, the sheet material has an effective thickness which is as much as one twentieth of the thickness of a sheet of expanded material. The compact configuration provides for the optimization of shipping and storage.”

In the preferred embodiments, the term “slit sheet” means an expandable paper sheet having a slit pattern. The following are direct quotes of U.S. Pat. No. 5,667,871 (the '871 patent).

First, column 10, lines 13-48, of the '871 patent explains:

“The length of the slit and the ratio of the land intervals between slit affects the dimensions of the polygons which are formed during the expansion step. The higher the ratio of slit length to interval length the greater is the maximum angle which can be formed between the plane of the sheet and the planes of the land areas. The greater the uniformity of the shape and size of the formed polygonal shaped open areas and the angle to which the land areas incline relative to the flat sheet, the greater is the degree to which interlocking of land areas can be achieved. Interlocking of land areas, that is, the nesting of layers of sheets, reduces the effective thickness of the sheets. However, the net effect is still a dramatic increase in effective sheet thickness. For example, 0.008 inch thick paper having a silt pattern of a ½″ slit, 3/16″ slit spacing, and ⅛″ row spacing, produces a ¼″ by 3/16″ land which can expand to under about one quarter of an inch thickness and will have a net effective thickness for two layers, when nested, of about 0.375 inches. It is noted that the land width is double the width of the legs. The net effect is a useful thickness expansion of roughly 20 times the unexpanded thickness of the paper.”

“The longer the slit relative to the rigidity of the sheet material, the weaker is the interlocking effect and the cushioning effect due to the weakness of the expanded structure. If the slits are too small, expansion can be severely limited and cushioning can be excessively limited. This does not mean that the dimensions are narrowly critical, but rather that the dimension must be selected relative to the characteristics of the paper, as for example the degree of rigidity, and the cushioning or energy absorbing effects which are required. The resistance to expansion increases relative to the increase in the size of the land areas. It should be understood that some resistance to opening is desired. The object rests on, or contacts the edge of the sheet formed by the incline of the land areas which turns the perimeter of the openings into upper and lower edges.”

Second, column 10, lines 58-67 and column 11, lines 1-6, of the '871 patent further explains:

“As heretofore mentioned, the slit dimensions can be varied to ease the process of opening. A ⅝″ slit, 3/16″ land by 3/16 row opens very easily since the number of hexagons is reduced. When the size of the hexagons are increased and the numbers decreased; the stretched thickness was increased, producing a very viable wrap material. This sizing increases the yield of the paper and provides almost the same protection as the ½″ slit. This sizing provides a less expensive product utilizing a larger content of post consumer waste while maintaining the integrity of the wrap product. The ½″ slit, 3/16″ land by ⅛″ row pattern produces a more protective wrap due to the greater number of wraps that can be made within the same volume. Thus, a 2½ pound vase dropped from a thirty inch height, with only ½″ of cumulative sheet thickness around the vase, can be protected with the ½″ slit, ¼ by 3/16 inch land pattern.”

### Various Embodiments

The above and/or other aspects, features and/or advantages of various embodiments will be further appreciated in view of the following description in conjunction with the accompanying figures. Various embodiments can include and/or exclude different aspects, features and/or advantages where applicable. In addition, various embodiments can combine one or more aspect or feature of other embodiments where applicable. The descriptions of aspects, features and/or advantages of particular embodiments should not be construed as limiting other embodiments or the claims.

### BRIEF DESCRIPTION OF THE DRAWINGS

This patent or application file contains at least one drawing executed in color. Copies of this patent or patent application publication with color drawing(s) will be provided by the Office upon request and payment of the necessary fee. The preferred embodiments of the present invention are shown by a way of example, and not limitation, in the accompanying figures, in which:

FIGS. 1-73 are incorporated from parent application Ser. No. 17/175,148, wherein:

FIG. 1 is a perspective view of roll of unexpanded slit sheet material;

FIG. 2 is a perspective view of the expanded void fill material being dispensed from the shipping/dispensing box;

FIG. 3 is a perspective view of a shipping box with unexpanded slit sheet material dispensed and resting flat on the top of the shipping/dispensing box;

FIG. 4 is a perspective view of a shipping box with unexpanded slit sheet material dispensed and resting flat and taped on the top of the shipping/dispensing box;

FIG. 5 is a side view of the dispensing donut;

FIG. 6 is a perspective view of the expanded slit sheet material exiting thought the dispensing donut;

FIG. 7 is a perspective view of an empty metal dispensing system;

FIG. 8 is a perspective view the unexpanded roll being loaded into the metal dispensing system;

FIG. 9 is a perspective view metal dispensing system dispensing the expanded slit sheet material;

FIG. 10 is a planar view of the die slit pattern of the manufacturing process of the slit sheet material;

FIG. 11 is a planar view of an alternative die slit pattern of the manufacturing process of the slit sheet material;

FIG. 12 is a planar view of the dispensing box;

FIG. 13 is a perspective view of the flattened slit sheet taped to the outer layer of the slit sheet roll material;

FIG. 14 is perspective view of an alternative metal dispensing system;

FIG. 15 is a close-up perspective view of the automated dispensing system;

FIG. 16 is a perspective view of the automated dispensing system;

FIG. 17 is a perspective view of an alternative dispensing donut that has a tearing tooth section for easy tearing;

FIG. 18 is a planar view of an alternative box design to ease the assembly of the dispensing donut;

FIG. 19 is an exploded perspective view of the alternative box and dispensing donut assembly;

FIG. 20 is a perspective view of the alternative box assembled with the dispensing donut;

FIG. 21 is a perspective view of closed carton of unexpanded slit sheet material ready to be shipped according to another embodiment;

FIG. 22 is a perspective view of the void fill material being expanded and dispensed from the shipping/dispensing box shown in FIG. 21;

FIG. 23 is a perspective view of the box shown in FIG. 21 including a roll of unexpanded slit sheet material with all upper dispensing panels folded outward and away from the box so that the roll can be loaded;

FIG. 24 is a planar view of the cutting die pattern of the box manufacturing process for forming a box as shown in FIG. 21;

FIGS. 25A-25C show perspective views of an alternative box design with an alternative slit sheet dispensing hole according to some illustrative embodiments;

FIG. 26 is a perspective view of a first illustrative automated dispenser embodiment employing a combination of rubber rollers and hook filament rollers;

FIG. 27 is a perspective view of a second illustrative automated dispenser embodiment utilizing an illustrative semi-circular opening in combination with the illustrative hook filament rollers;

FIG. 28 is a perspective view of a modification of the second illustrative automated dispenser embodiment in which the stretching area is changed to the vertical;

FIG. 29 is an illustrative close-up perspective view of an exit feed including attached serrated edges according to some embodiments;

FIG. 30 is a top perspective view of an illustrative dispensing box according to some embodiments including a removable core;

FIG. 31 is a top perspective view similar of the embodiment shown in FIG. 30 showing a state of usage in which an interior core is being removed through the end face of the box;

FIG. 32 is an explanatory perspective view of a paper roll employed within the embodiment of FIG. 31 without a central core;

FIG. 33 is another explanatory perspective view of a paper roll employed within the embodiment of FIG. 31, which, however, shows a central core in a partially withdrawn state;

FIG. 34 is a perspective view of another void fill dispenser embodiment employing a shipping/dispensing box depicting a closed state of the box or carton containing unexpanded slit sheet material ready to be shipped;

FIG. 35 is a perspective view of the void fill material being expanded and dispensed from the shipping/dispensing box shown in FIG. 34;

FIG. 36 is a perspective view of the void fill dispenser embodiment shown in FIG. 34 showing a roll of unexpanded slit sheet material with all upper dispensing panels folded outward and away from the box so that the roll can be loaded;

FIG. 37 is a planar view of the cutting die pattern of the box manufacturing process for forming a shipping/dispensing box as shown in FIG. 34;

FIG. 38 is a perspective view of an alternative box design with an alternative slit sheet dispensing hole;

FIG. 39 is a perspective view of an alternative design for a unit for supporting a roll of unexpanded slit sheet material and having a member for opening access to the roll of unexpanded slit sheet material;

FIG. 40 is a perspective view of an alternative design for a unit for supporting a roll of unexpanded slit sheet material and having a member for opening access to the roll of unexpanded slit sheet material through a crescent shaped opening;

FIG. 41 is a perspective photograph showing a view of an expanded slit sheet paper being dispensed from a crescent shape opening according to some illustrative embodiments;

FIG. 42 is a schematic drawing show the end face of a roll of expandable slit sheet paper for explanatory purposes;

FIGS. 43A-43E are explanatory views representing illustrative manners of causing a tubular void fill tube to overlap such that contact occurs between the opposite ends and/or regions near the opposite ends and/or regions at different locations within the transverse direction of the expanded slit sheet paper;

FIGS. 44A-44C, FIGS. 45A-45C, FIGS. 46A-46B, and FIGS. 47A-47B show illustrative outlet configurations according to some illustrative embodiments;

FIGS. 48-52 show an illustrative embodiment of a manually operated cardboard box dispensing system according to some illustrative examples;

FIG. 53 is an explanatory schematic diagram depicting handling of expanded slit sheet paper in accordance with some embodiments of the invention in a manner to achieve contact between different portions of the slit sheet paper during expansion; and

FIG. 54A is a perspective view of a roll of slit sheet paper that is in a state of being unwound from an exterior end of the roll, and FIG. 54B is a side view of the roll of slit sheet paper from the right side of FIG. 54A;

FIG. 55 is a perspective view of an alternative, less preferred, embodiment of a slit sheet paper void fill dispensing mechanism according to another alternative embodiment in which the slit sheet paper is fed in a machine direction into a contraction device;

FIG. 56 is a perspective view of an alternative, less preferred, embodiment of a slit sheet paper void fill dispensing mechanism according to another alternative embodiment in which the slit sheet paper is fed laterally to the machine direction into a contraction device;

FIG. 57 is a perspective view of another alternative dispenser according to some illustrative embodiments of the invention;

FIG. 58 is a front view of another alternative dispenser according to some other illustrative embodiments;

FIG. 59 is a perspective view of another alternative dispenser according to some other illustrative embodiments;

FIG. 60 shows an advantageous combination system in which a dispenser similar to that shown in FIG. 59 is placed proximate an expansion device that is used to wrap items;

FIGS. 61 to 62 are perspective views of another alternative dispenser according to some further illustrative embodiments;

FIGS. 63 to 66 show another illustrative embodiment which pertains to a non-automated dispenser made of, e.g., recyclable material such as, e.g., cardboard or paper or the like;

FIG. 67 shows another illustrative embodiment which also pertains to a non-automated dispenser made of, e.g., recyclable material such as, e.g., cardboard or paper or the like;

FIGS. 68A-68C show an illustrative embodiment in which at least one wall of a dispenser box is adapted to include at least one tab member for supporting a roll within the dispenser; and

FIGS. 69-73 describe illustrative expansion of expandable slit sheet paper in some embodiments.

FIGS. 74-86 are incorporated from parent application Ser. No. 18,586,916, wherein:

FIG. 74, which corresponds to FIG. 5A from Ser. No. 18,586,916, is a top perspective view of an expansion system for expandable slit sheet paper employing a friction brush according to a first illustrative embodiment of the invention;

FIG. 75, which corresponds to FIG. 5C from Ser. No. 18,586,916, is a schematic side view showing an interface between a friction brush and an expandable slit sheet paper in some implementations of embodiments of the present invention;

FIG. 76, which corresponds to FIG. 5D from Ser. No. 18,586,916, is a side view showing an illustrative friction member according to some embodiments of the present invention;

FIG. 77, which corresponds to FIG. 5E from Ser. No. 18,586,916, is a side view showing an illustrative adjustor including an adjustor connector according to some illustrative embodiments of the invention employing an adjustable friction member;

FIG. 78, which corresponds to FIG. 5F from Ser. No. 18,586,916, is a side view showing an illustrative adjustor including an adjustable plate member;

FIG. 79, which corresponds to FIG. 6A from Ser. No. 18,586,916, is a top perspective view of an expansion system for expandable slit sheet paper employing a friction brush according to a third illustrative embodiment of the invention;

FIGS. 80-82, which correspond to FIGS. 6E-6G from Ser. No. 18,586,916, are perspective views of an expansion system for expandable slit sheet paper employing a friction brush according to other embodiments of the invention;

FIG. 83, which corresponds to FIG. 7A from Ser. No. 18,586,916, is a top view of an expandable slit sheet paper employed in some embodiments of the invention having a common expansion pattern;

FIG. 84, which corresponds to FIG. 7B from Ser. No. 18,586,916, is a top view of an expandable slit sheet paper employed in some embodiments of the invention having an alternating expansion pattern;

FIGS. 85-86, which correspond to FIGS. 8A-8B from Ser. No. 18,586,916, are views of existing McMaster™ brushes that can be employed in some illustrative embodiments of the invention, and as found at https://www.mcmaster.com/catalog/129/1550/; and

FIG. 87 shows a brush for expanding void fill according to a further embodiment of the invention.

In the attached drawings, some figures are photograph(s) of actual products. Accordingly, these photographs show illustrative examples, to scale, such that such figures show illustrative examples to scale and angles and relative dimensions shown in these figures are as shown in these figures in such illustrative examples. Additionally, other figures also show illustrative embodiments, to scale, such that the figures show illustrative examples to scale and angles and relative dimensions shown in these figures are as shown in these figures in such illustrative examples. Moreover, in some alternative embodiments, all shown angles and relative dimensions can be varied slightly, such as, e.g., plus or minus 15% in some examples, or plus or minus 10% in some other examples.

### Definitions

For the purposes of the present invention, the term “dispensing donut” refers to a device having a central opening that is configured to receive expandable slit sheet material. In the preferred embodiments, a dispensing donut is specially configured to control the friction applied to achieve unique expansion while avoiding pre-mature tearing and while facilitating movement of the paper there-through that leads to contact of expanded cells in a manner to inhibit retraction after expansion. In some preferred embodiments, the dispensing donut is made of molded paper, plastic, metal or the like, and has a smooth surface that reduces the friction created from the edges of the dispensing area of the dispenser (such as, e.g., to avoid rough cardboard edges of a dispensing box or sharp cut edges of a metal dispenser). As described herein below, in some preferred embodiments the central opening of the dispensing donut is referred to as a “donut aperture” and is, in some embodiments, adjustable in size. The terminology “donut” does not require any particular shape, and can be circular, non-circular or any other shape.

For the purposes of the present invention, the term “stretching direction” refers to the direction that is transverse to the direction of the slits of the slit sheet material. Typically, this is the machine direction.

### DETAILED DESCRIPTION OF THE PREFERRED EMBODIMENTS

While the present invention may be embodied in many different forms, the illustrative embodiments are described herein with the understanding that the present disclosure is to be considered as providing examples of the principles of the invention and that such examples are not intended to limit the invention to preferred embodiments described herein and/or illustrated herein.

### INTRODUCTION TO THE PREFERRED EMBODIMENTS

### a) Embodiments Described in 62,980,122, 62,976,930 and 62,975,678

The disclosures of non-provisional applications 15,428,144 (US 2018/0222665) and 16,018,702 (PCT/US2018/039416) are incorporated by reference in their entirety, referenced and recited herein as if in full as part of the description of the present invention.

Patent application 16,018,702 (PCT/US2018/039416) describes a use of extensible paper to greatly reduce the tension required to stretch the slit sheet material. It is intended for the new art shipping box and tensioning device of this application to utilize the extensible paper of the provisional pending application but, not necessarily exclusively.

The instant art of the void fill system is made from a roll of unexpanded slit sheet material as found in the present Goodrich art that dispenses wrapping material. This single roll is placed into a box and oriented such that the dispensing of the expanded slit sheet material is done at the center of the wound roll. In order to stabilize the roll and hold it in position, a dispensing system encapsulates the roll to provide ease of use and an opening to allow the material to exit continuously. The opening is also the area that provides the friction to facilitate expansion of the slit sheet material. The corrugated dispensing box also acts as the shipping box.

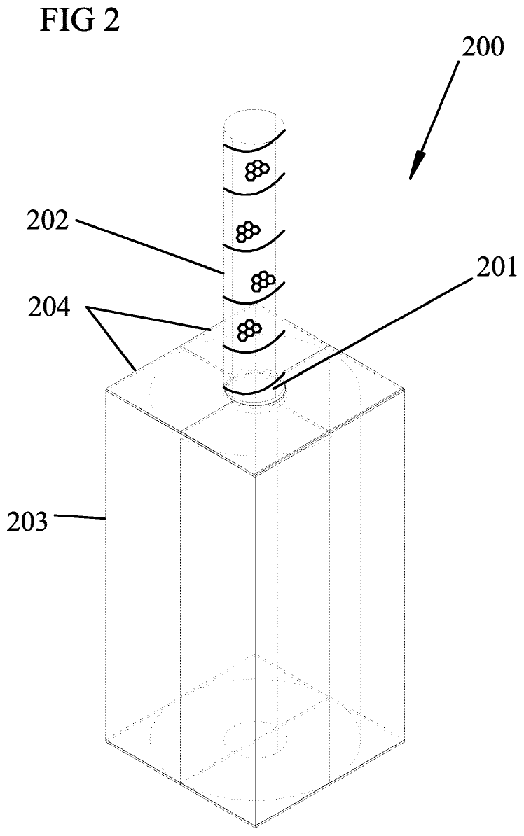

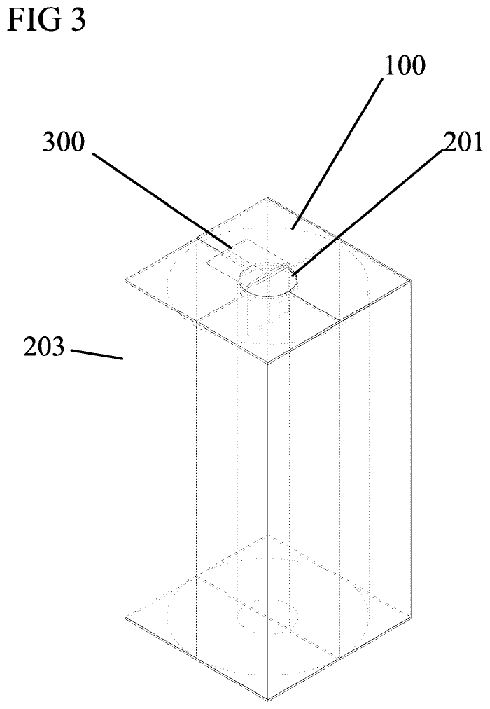

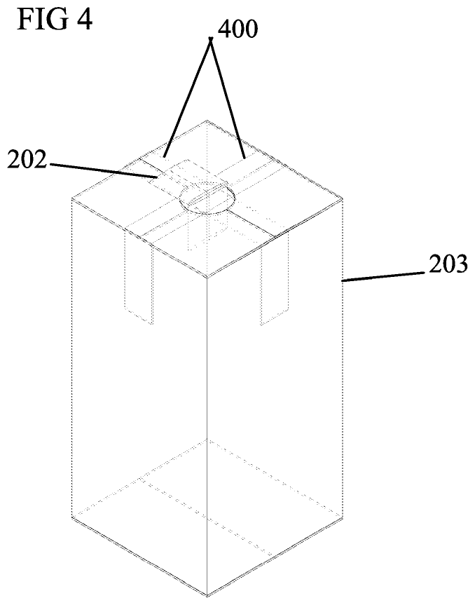

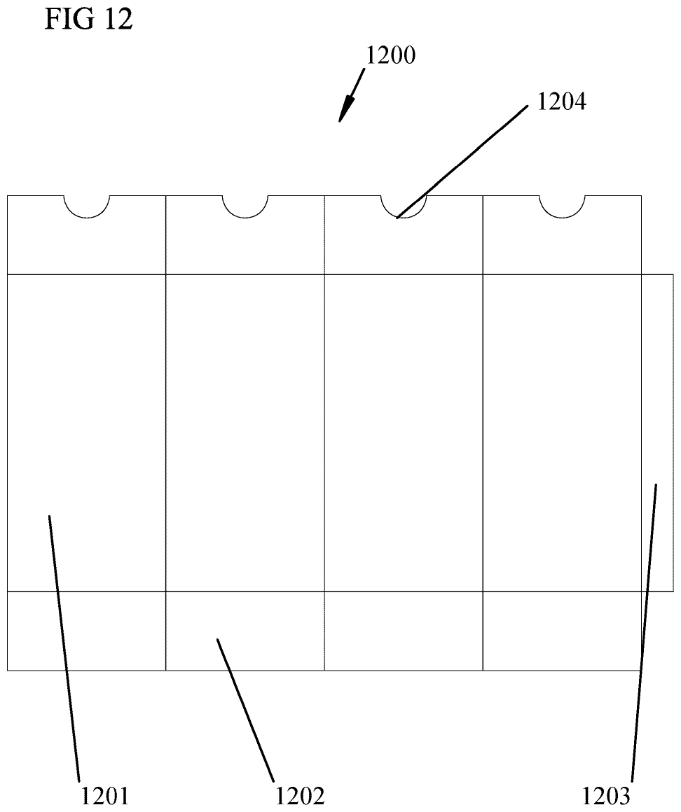

The shipping box and the tensioning device in its preferred embodiment is to be made from paper and further it is to be made from corrugated paper normally found within the art. The shipping box, as shown in FIG. 2 is made with a hole in the center where it aligns with the center of the unexpanded slit sheet roll. This enables the slit sheet material to feed outward from the center of the roll in a turning tube-shaped action that stretches the paper based on the friction that is exerted at the exit point. The hole of the box is made by cutting into the flaps of the paper box as shown in FIG. 12, 1204. A small amount of dispensed material 300 is fed from the roll and is fed through the dispensing box to be placed on top of the corrugated box as shown in FIG. 3. It is then taped to the box as part of the overall securing to the box for shipping as shown in FIG. 4, 400. The purpose of this is to enable the user to quickly obtain the slit paper for immediate use.

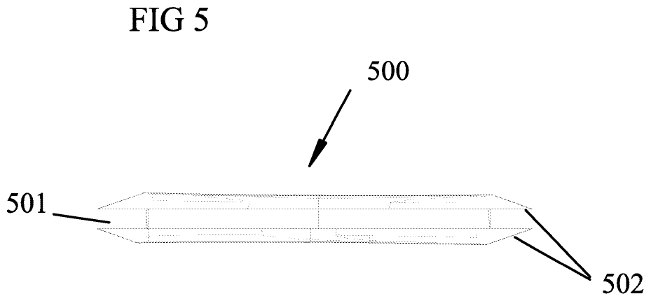

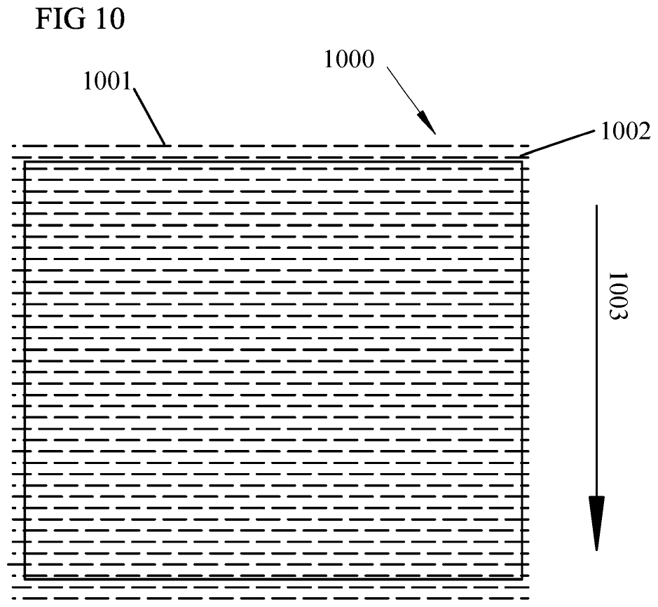

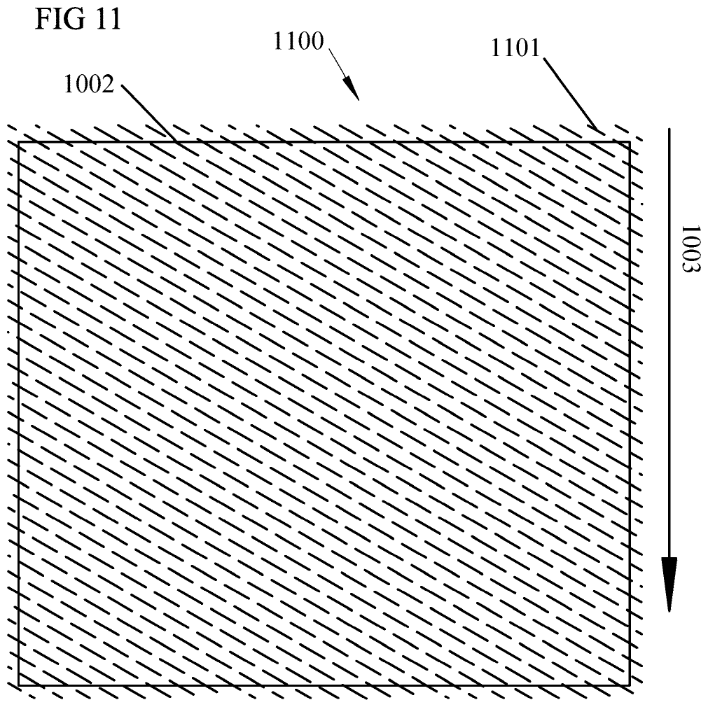

Another preferred embodiment of the shipping box is with the use of a dispensing donut. The Slit sheet material 202 can be made from a variety of Kraft papers. The use of a recycled Kraft paper would require reduced friction at the exit point of the dispensing box to inhibit tearing. Also a reduction in friction is required where the expansion, as compared to the expanded slit sheet wrapping product, utilizes an angled knife, as shown in FIG. 11, that would allow the slit sheet to stretch prior to being dispensed from the box. A dispensing donut 500, as shown in FIG. 5, is placed within the hole of the dispensing box. The use of extensible paper, as found within the prior art of Ser. No. 16,018,702 (PCT/US2018/039416) incorporated by reference and recited herein as if in full as part of the description of the present invention, reduces the stretching tension by over 66%. This reduction in force to stretch further is facilitated by the use of the dispensing donut 500 for even faster friction free dispensing as the extensible expands very easily with little resistance and with a low level of required friction.

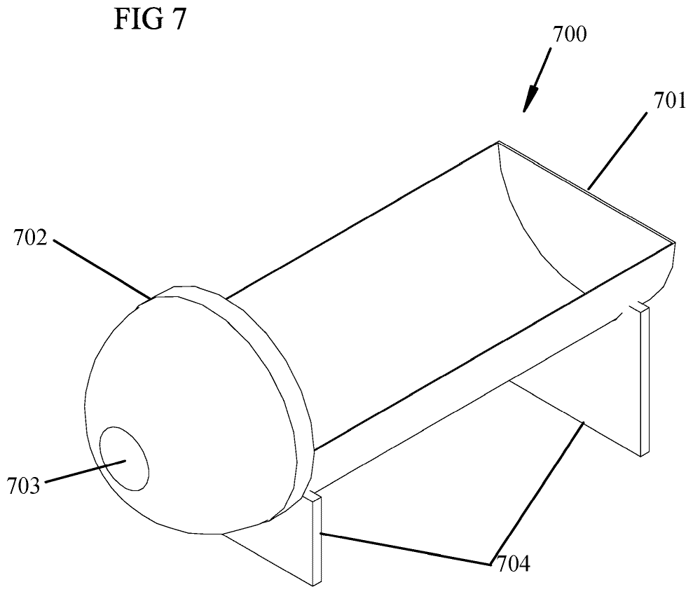

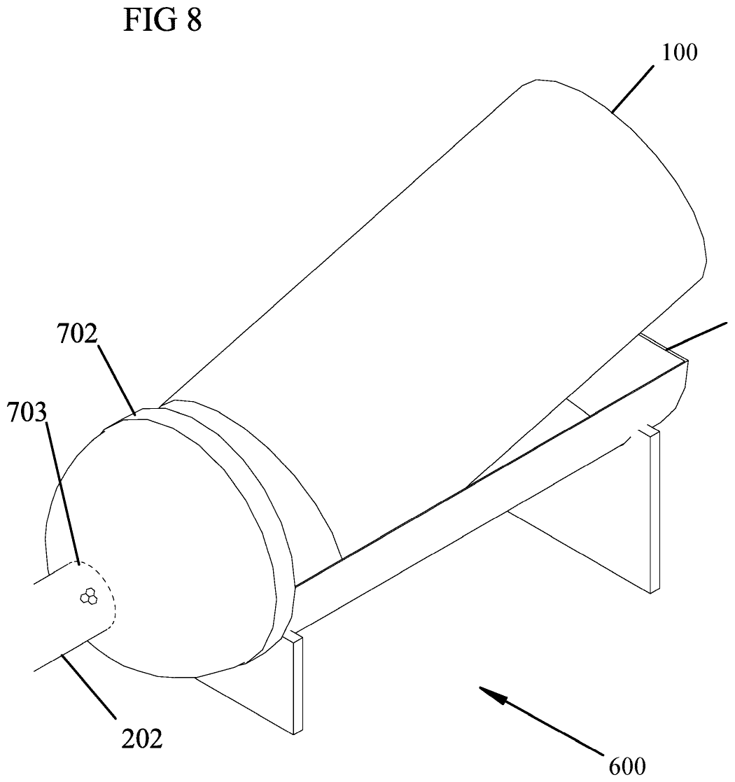

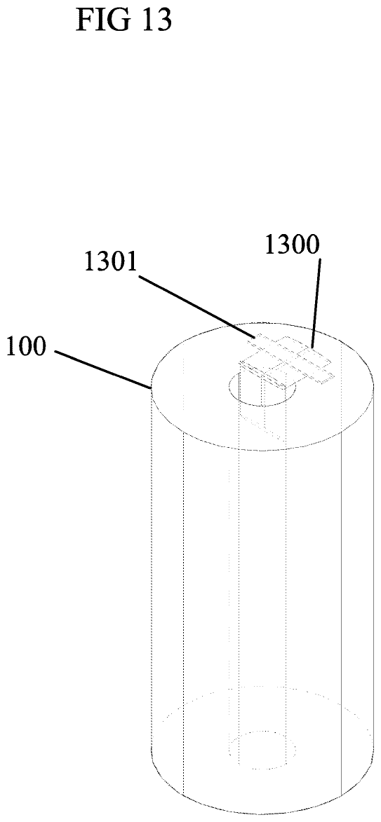

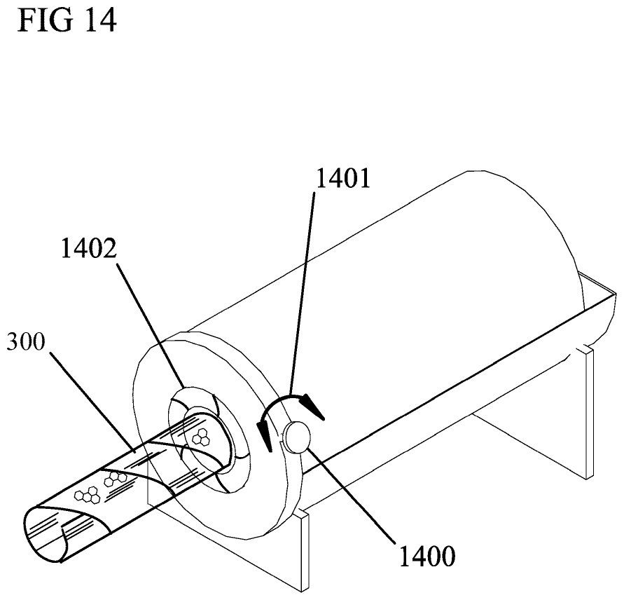

Another preferred embodiment is with the use of a metal dispensing system 700 as shown in FIG. 7. In the case were high volume of material is used daily the dispenser can be made of metal and conveniently positioned and or mounted to the table. In this case a shipping box design would be less convenient. In this instance the dispenser is shaped to load a slit sheet roll quickly as shown in FIG. 8. Loading quickly requires a certain amount of slit sheet material to be available for the user to feed through the dispenser 202 as shown in FIG. 8. To facilitate this, a small portion of slit sheet material is taped (1300) to the top of the slit sheet material as found in FIG. 13. In another embodiment, the exit feed hole can be made into an aperture as found in FIG. 14 1402 with adjustment screw 1400 so that the hole diameter can be optimized in size for the best stretching and feeding speed.

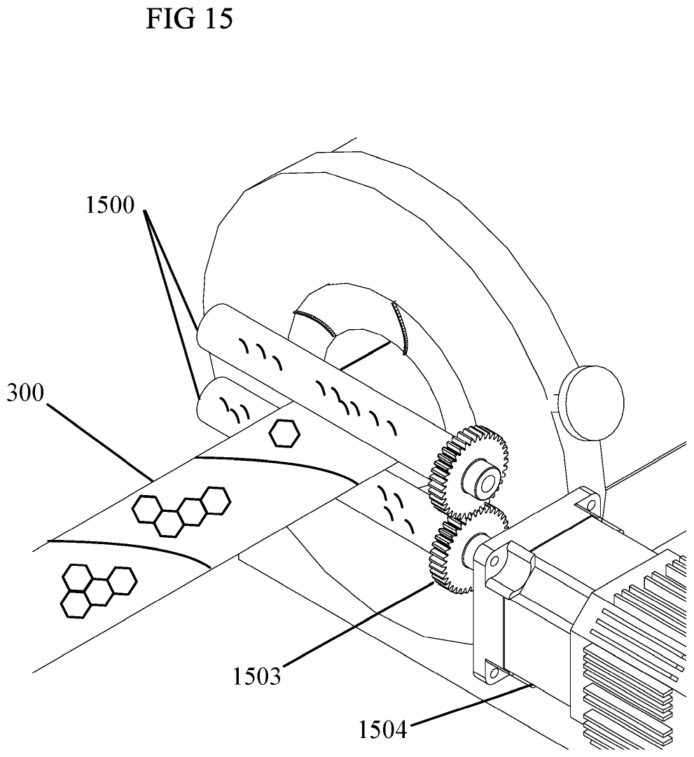

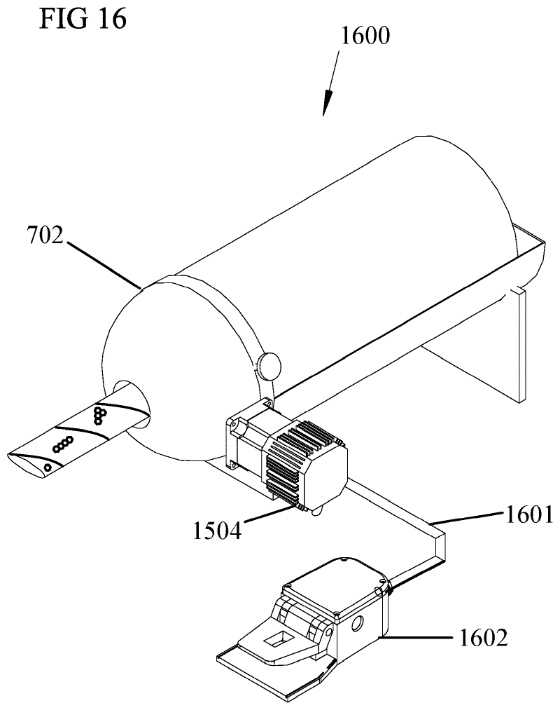

Another preferred embodiment is with the metal dispenser being powered with an electric motor and a foot switch or the like as shown in FIG. 16. The Motor is attached to the manual metal dispensing system with a set of barb-type rollers as found in FIG. 15 1500 and feeds the slit sheet material continuously through the use of an electric foot pedal switch or the like. It is intended that the Goodrich art 14,480319 with the use of parallel rollers separated narrow enough to grip the exiting paper and wide enough to allow the tubular slit sheets to flex into itself such that the cells are not crushed.

Another preferred embodiment is with the use of an angled slit pattern so that the expansion occurs more easily. FIG. 10 shows the standard slit pattern that has been used for the wrapping equipment. The slits are transverse to the manufacturing direction and is transverse to the unwinding of the roll. This makes it easy to utilize the product from the outside layer of the roll but, in the instant art, the slit paper has to expand somewhat transverse to the machine direction. To facilitate a more immediate and easy expansion, the cells are angled so that the cells begin expansion as soon as it begins the unwinding process. To determine the right angle it is important to know which paper is going to be used and the slit pattern desired. Therefore, there is a myriad of angles that would be best suited for the application.

It is also optimal in some instances to turn the slits up to 90 degrees parallel to the direction of manufacture as indicated by arrow 1003, so that the expansion is immediate. As illustrated in FIG. 11, the slitting blades can be at an angle of less than 90° to the machine direction, as for example, in the range from and preferably in the range from 40° to 85°. To best determine the angle of the die cutting blades three aspects of the slit paper are necessary, the type of paper, the slit pattern size, and the width of the roll used. If the paper is 20″ wide and therefore 20″ of paper in a circular form is exiting the core, the buildup of material within the paper core could overfill the area and jam prior to exit. To solve this issue the paper roll would be made with a shorter length so that there is less buildup within the core. If the slit pattern is reduced in size, then the buildup will be less and a longer roll can be used. Another way to solve the problem of premature buildup in the inner core is to increase the size of the core itself.

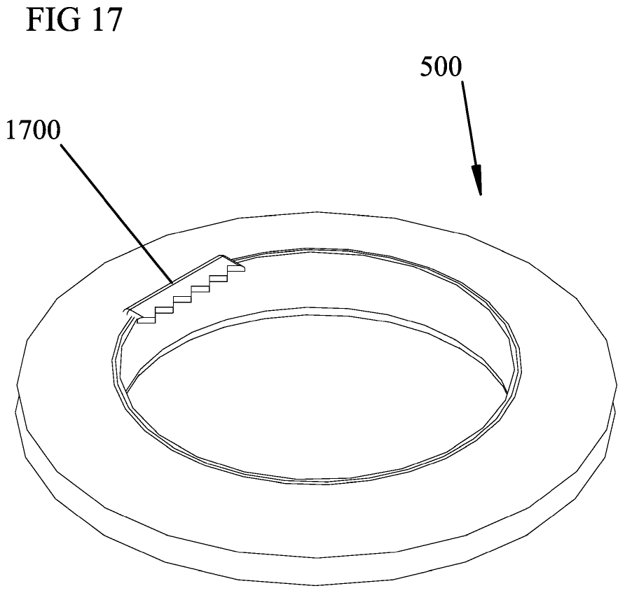

Another preferred embodiment is with the use of molded notches or blades within the dispensing donut as found in FIG. 17. A single notch or small notches as shown in FIG. 17, 1700 at only at one side of the dispensing donut so that the user can dispense at a slight angle away from the notches when dispensing. When it is time to tear the product, the user would engage the notches by angling the slit sheet material upward or slightly towards the notches thereby, inhibiting the exit flow and facilitating the tearing process.

Another preferred embodiment to facilitate ease of assemble of the dispensing donut into the box is to use the two inner opposing box panels for the insertion of the dispensing donut to be almost exact to the inner dimensions of the dispensing donut. The exterior opposing flap pairs would have larger openings that would move the edge of the corrugated away from the opening of the dispensing donut to remove any friction created by the panel radial edge as shown in FIG. 20, 1801. This approach eases the assembly process but, remains a durable design since the outer larger radial cutaway on the outer flaps still rest on the dispensing donut to inhibit dislodging of it.

### Further Discussion of the Figures

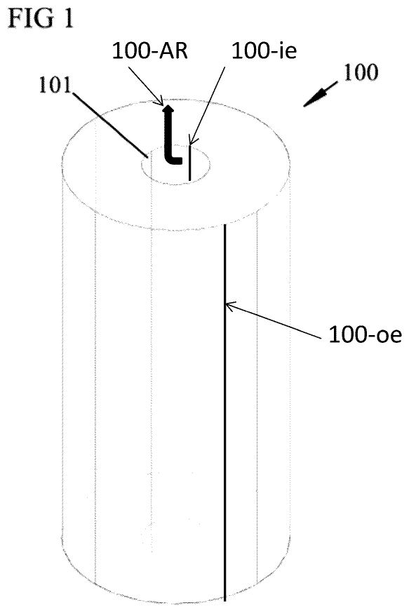

FIG. 1 is a perspective view of the unexpanded slit paper in roll form 100, where the intended unwinding/feeding section 101 is the center of the roll in the preferred embodiments. As shown in FIG. 1, the roll 100 is wound such that the sheet is formed of numerous wound layers of sheet material, including an interior end 100-ie and an exterior outer end 100-oe of the sheet. In the preferred embodiments described herein, the sheet is fed from the center by feeding the interior end 100-ie upwardly in the direction of the arrow 100-AR shown in FIG. 1.

FIG. 2 is a perspective view of the dispensing system 200 where the slit sheet material 202 is being expanded through hole 201 die cut into box flaps 204.

FIG. 3 is a perspective view of the expanded slit material where the hidden slit sheet roll 100 is in the box 203. A small portion of the slit sheet material 300 is drawn through hole 201 flattened and placed against the top of the box 203.

FIG. 4 is a perspective view of the box 203 where flattened slit sheet material is placed under and releasably secured by packing tape 400.

FIG. 5 is the dispensing donut 500 with reduced radius area 501 creates upper and lower smooth edge areas 502.

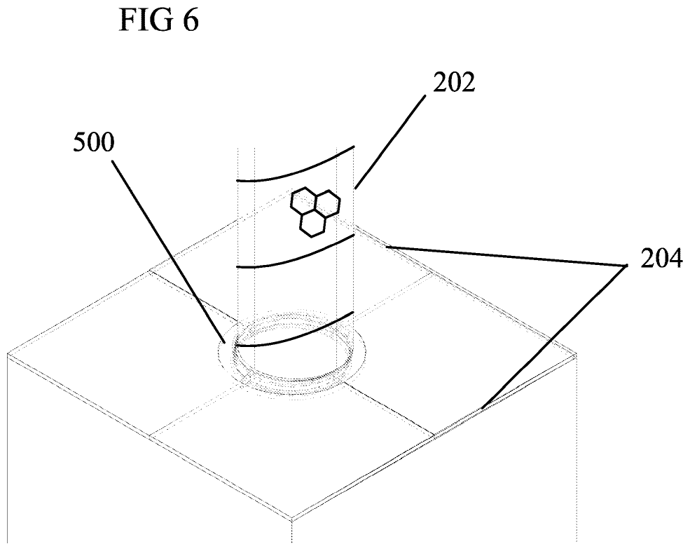

FIG. 6 is a perspective view of the dispensing donut 500 in position and secured within the layers of flaps 204 to reduce the friction of the dispensed expanded slit sleet material 202.

FIG. 7 is a perspective view of an empty metal dispensing system 700 where empty loading area 701 is connected to hollow holding fixture 702 that has the exit feed hole 703. Feet 704 hold the dispensing system 700 slightly higher than the packing table.

FIG. 8 is a perspective view of the loading of the slit sheet roll 100 into the metal dispensing system into loading area 701 to be pushed under hollow holding fixture 702 while simultaneously making sure slit sheet material 202 is fed through hole 703.

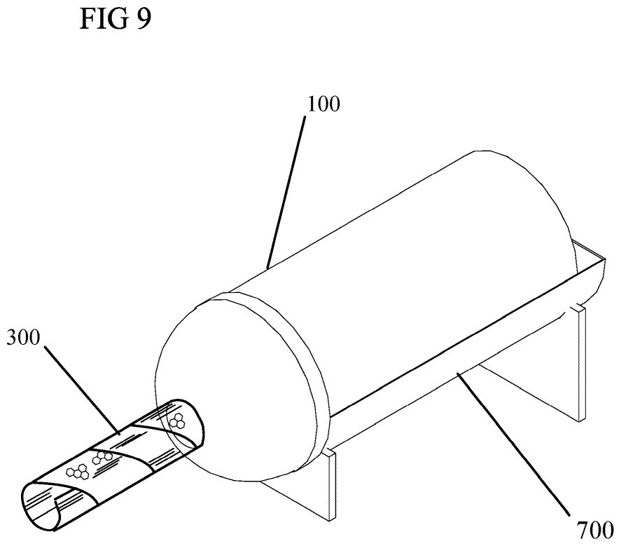

FIG. 9 is a perspective view of the metal dispensing system 700 has slit sheet roll 100 mounted with expanded slit sheet material exiting the dispenser.

FIG. 10 is a planar view of the die cut pattern 1000 where slit knives 1001 are transverse to manufacturing direction 1003. The slit paper outline 1002 depicts the area in which the paper is to be die cut to be completely cut edge to edge.

FIG. 11 is the angled die cut pattern 1100 where 1101 slit knives are angled towards but, not completely transverse to the machine direction 1003. Outline 1002 shows the position of paper as it passes over the knives to be completely cut edge to edge.

FIG. 12 is a planar view of the manufactured box layout 1200 prior to being glued together with box flap 1203 being joined to first panel 1201. Cut out half-circle 1204 in each of the four flap panels 1202 that make up the round hole of FIG. 2,101.

FIG. 13 is a perspective view of the unexpanded slit sheet roll 100 with flattened expanded sheet 1300 placed on the top of the roll for ease of and releasable secured with tape 1301.

FIG. 14 is a perspective view of a manual dispensing system with that includes modulating screw 1400 that turns clockwise and counterclockwise, as shown with curved arrow 1401, to enable donut aperture 1402 to adjust in diameter and thereby affecting the exit tension of expanded slit sheet roll 300.

FIG. 15 is a perspective view of the motor and barbed powered rollers 1500 that are connected to motor 1504 through gearing rollers 1503. The barbed power rollers feed the expanded slit sheet tube 300.

FIG. 16 is a perspective view of the powered dispensing system 1600 showing electric motor 1504 connected to electric powered foot operating foot pedal 1602 through electrical wires 1601. Hollow holding fixture 702 hides the powered barb rollers and gears for safety.

FIG. 17 is a perspective view of an alternative donut 500 that shows the molded teeth or notches 1700 that are part of the edge of the dispensing donut 500.

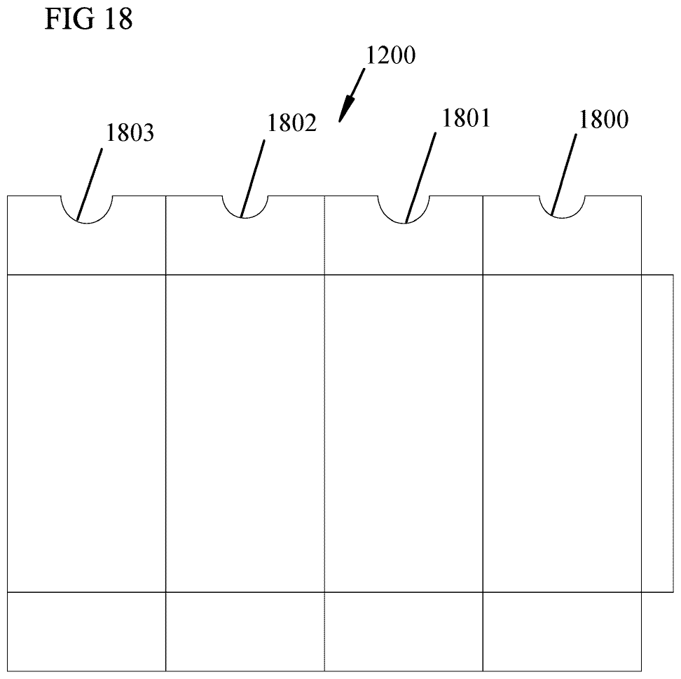

FIG. 18 is a planar view of the alternative box where opposing outer panels with radial cuts 1803 and 1801 are larger than inner opposing panels with radial cuts 1800 and 1802 that are used to fit securely the dispensing donut of FIG. 5, 500.

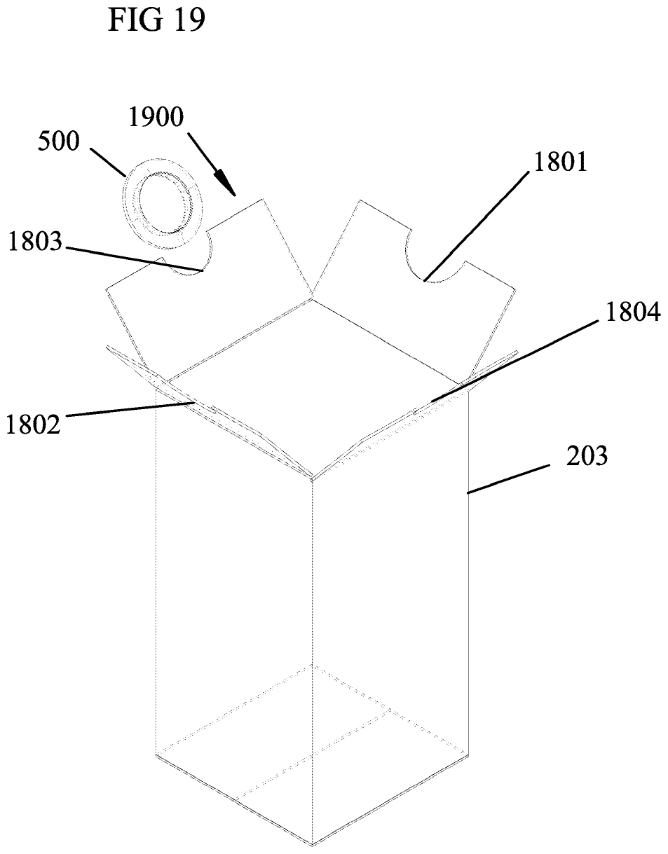

FIG. 19 is a perspective view of the exploded view of the box panels with radial cuts 1800-1804 in the open position. Dispensing donut 500 is placed in a downward motion 1900 into the inner radial cut of the box panel 1803 and subsequently 1804 as the two panels are rotated to the horizontal position as shown in FIG. 20. Box panels with radial cuts 1801 and 1802 are closed over the inner box panels 1803 and 1804 to trap and securely inhibit any movement or tearing of the inner box panels 1803 and 1804 during use.

FIG. 20 is a perspective view of all radial cut panels 1800-1804 cut and placed in the horizontal closed position that is ready for shipment with dispensing donut securely trapped with outer panels 1801 and 1803.

### b) Embodiments Described in 62,983,601

As discussed above, in the background art, there are devices for expanding slit sheet paper. However, those devices are particularly designed for the use as a wrapping product and are not appropriate for creation of a void fill product.

As described in the background above, the present inventor pioneered the use of expanded slit sheet paper for cushioning products. Since the present inventor's introduction of expanded slit sheet paper as a cushioning product, dispensing systems have been used that expand the slit sheet paper in a manner to enable the expanded slit sheet paper to be wrapped around a product. Towards that end, prior expansion devices of expanded slit sheet paper feed the slit sheet paper in a uniform and flat manner so that the cells of the paper are substantially uniformly opened upon expansion. Then, the expanded paper, while in this flat state, is wrapped around an item to protect that item.

Rather than wrapping an item, a prior expansion device could have theoretically been used to expand the paper (i.e., in its flat state) and then the expanded paper could have theoretically been rolled upon itself in a manner not to surround a product, but to create a void fill for cushioning. However, it was not previously possible to create a viable and useful void fill product using such prior expansion devices.

For example, when paper is expanded with such prior expansion devices, after expansion, the paper has a tendency to retract. That is, the expanded paper needs to remain under tension to remain expanded. Accordingly, such prior expansion devices are useful when wrapped around an item because the act of wrapping the item maintains the expanded state of the expanded slit sheet paper, and once the item is wrapped a few times by the expanded slit sheet paper, the layers of the wrapped expanded paper can interlock around the item and, hence, remain in an expanded state around the item.

However, if the expanded paper was not wrapped around an item and attempted to be used as a void fill, there would be a problem in that the expanded paper would have a tendency to retract and lose its expanded state (which expanded state is necessary for cushioning capabilities).

Moreover, as the expanded slit sheet paper is, by itself, thin (even in an expanded state), it would be difficult to wrap the paper around itself to form a void fill product.

Moreover, in order to form a void fill product with such prior expansion devices, the paper would first need to be expanded and second would need to be wrapped around itself to avoid contraction. Thus, such prior expansion devices do not lend themselves to the creation of a viable void fill product.

According to some further embodiments, a novel dispenser is provided that is even more uniquely capable of suitable creating a void fill product by expanding of expandable slit sheet paper.

In some illustrative embodiments, a modified semi-circular opening is provided for the dispensing of slit sheet material in both manual-type and automated-type systems, which modified semi-circular opening has been unexpectedly now found to be more reliable for continuous stretching without tearing until so desired.

According to some alternative embodiments, one or more of the embodiments described herein-above can be modified to employ a novel and advantageous opening or outlet or donut aperture.

In particular, the use of a semi-circular shape, partially circular shape, or crescent shape opening has now been found to be highly advantageous in some preferred embodiments and implementations. While it would be expected that the use of a semi-circular opening would result in premature tearing of the slit paper during the expanding of the slit paper, the present inventor discovered that, surprisingly, the opposite occurs. On the contrary, the present inventor has discovered that the tendency of the slit sheet paper to tear in an uncontrolled manner has been reduced by the implementation of such novel openings, rather than being exacerbated.

The use of a semi-circle exit feed or crescent shaped exit feed unexpectedly provides tension to expand the slit sheet material completely while simultaneously increasing the feeding speed without the fear of ripping the material prematurely. This shape of a crescent can be used in some embodiments within all of the dispensing systems described herein. In particular, while an exemplary implementation is described in relation to a corrugated box embodiment, such a novel opening shape can be implemented within any of the void fill dispensing systems described herein. The opening exposes edges of the corrugated paper and the edges of the corrugated paper is employed to resist the dispensing of the slit sheet material.

In the preferred embodiment, the crescent shape is a type of lune (e.g., partial moon shape), which includes a generally circular disk shape with a portion of another generally disk shape removed from it, so that what remains is generally a shape enclosed by two circular arcs which intersect at two points. In a crescent, the enclosed shape does not include the center of the original disk. The tapered regions towards the points of intersection of the two arcs are known as the “horns” of the crescent. See: Wikipedia. It should be noted that in the preferred embodiments, the horns of the crescent are advantageously rounded at their ends, rather than tapering to a point.

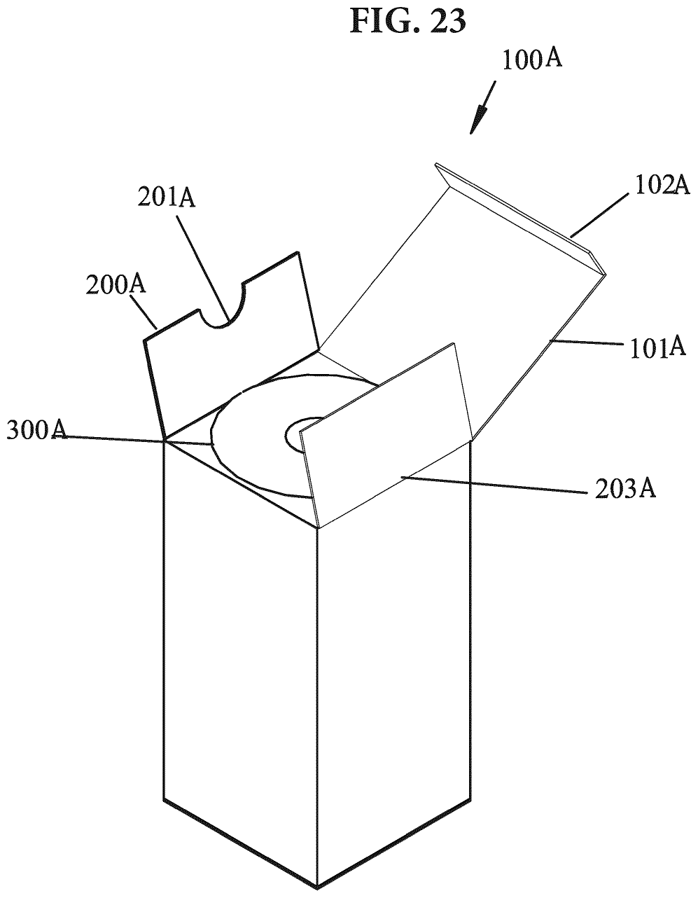

The shape can be slightly adjusted dependent upon the slit pattern which varies the tension and ease of feed necessary to dispense well. FIG. 23 shows opening 201A as a semi-circle with the opposing flap 203A being rectangular/square and, therefore, forcing the expanded slit material 204A material through an irregular shape.

By way of an example, the semi-circle could be made smaller to increase tension or the panel 203A could be adjusted (e.g., curved) to enable a fuller circular. This is very easily accomplished by increasing the length of panel 203A beyond the centerline of the two flaps making it greater in length while panel 200A is reduced in length and therefore reduces the semi-circular hole. Conversely, the panel 203A could be made shorter and the panel 200A made longer which would increase the circumference of the circle.

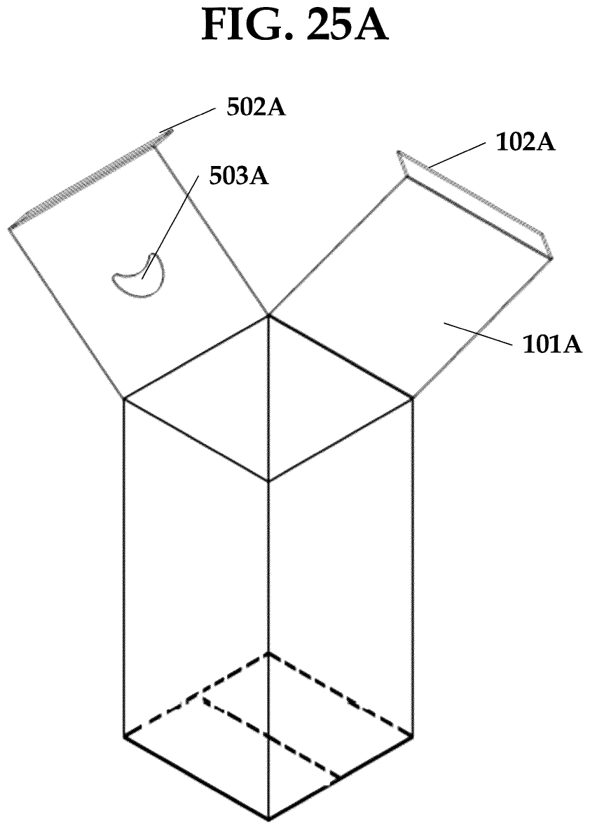

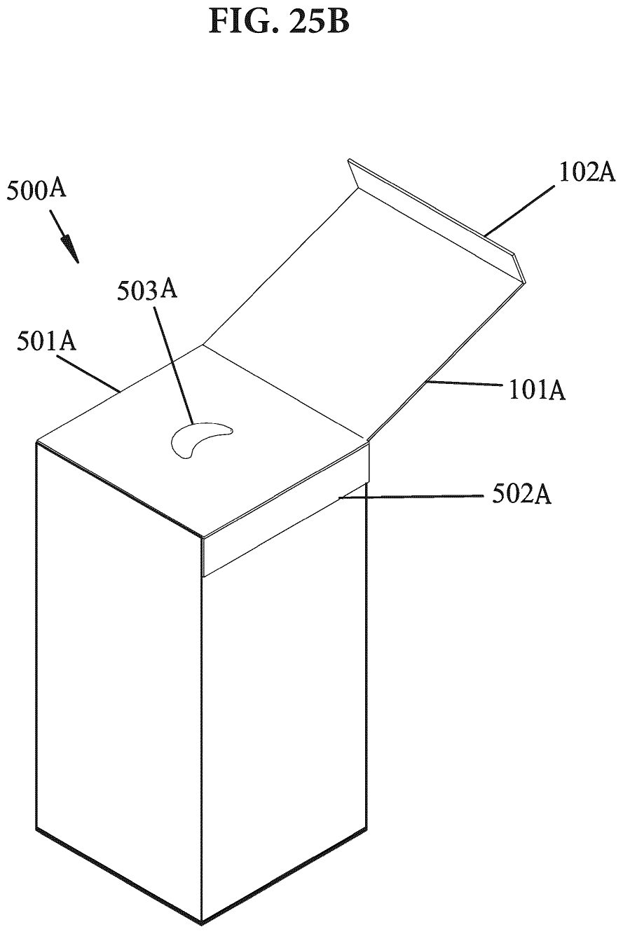

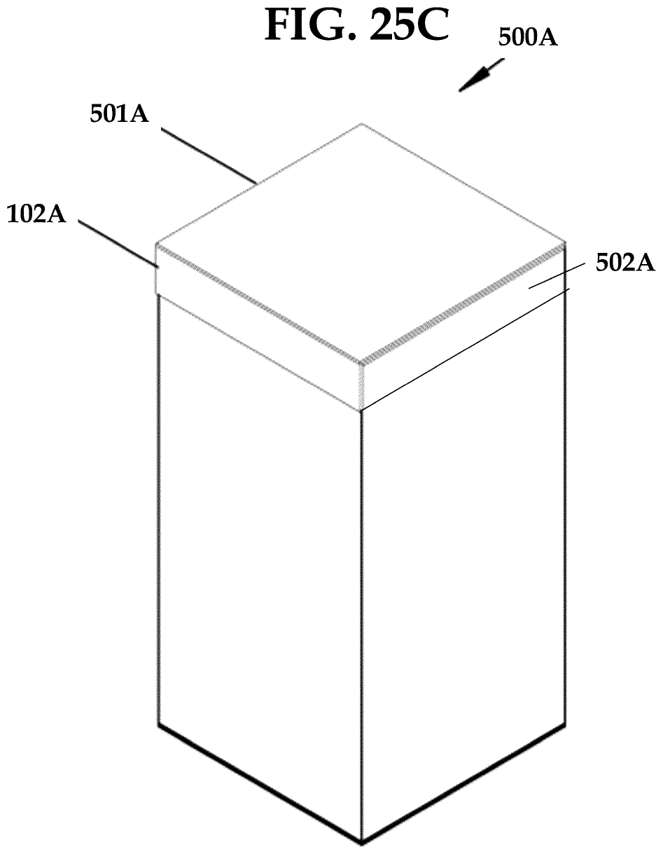

FIGS. 25A-25C show perspective views of an alternative box design with an alternative slit sheet dispensing hole according to some illustrative embodiments. Towards this end, FIG. 25A shows a perspective view of a dispensing box in an open configuration without a roll of expandable slit sheet material therein. In addition, FIG. 25B shows a perspective view of the dispensing box in a use configuration in which a panel having a dispensing opening is positioned over the upper end of the box. In such a position, with a roll of slit sheet material within the box, the slit sheet material can be dispensed and expanded through the opening in the dispensing opening. Furthermore, FIG. 25C shows the dispensing box in a fully closed position in which both of the top panels have been closed. This position is suitable for shipping (e.g., with a roll of slit sheet material contained within the box) and/or storage or the like.

FIGS. 25A-25C shows a variation of design from other embodiments described above, but, overall, the purpose is to create variations to obtain the desired shape of the hole. One skilled within the art can create a multitude of designs to accomplish the required end results based on this disclosure. Thus, there are a variety of ways to provide a desired opening configuration, each of which can produce essentially functionally similar results.

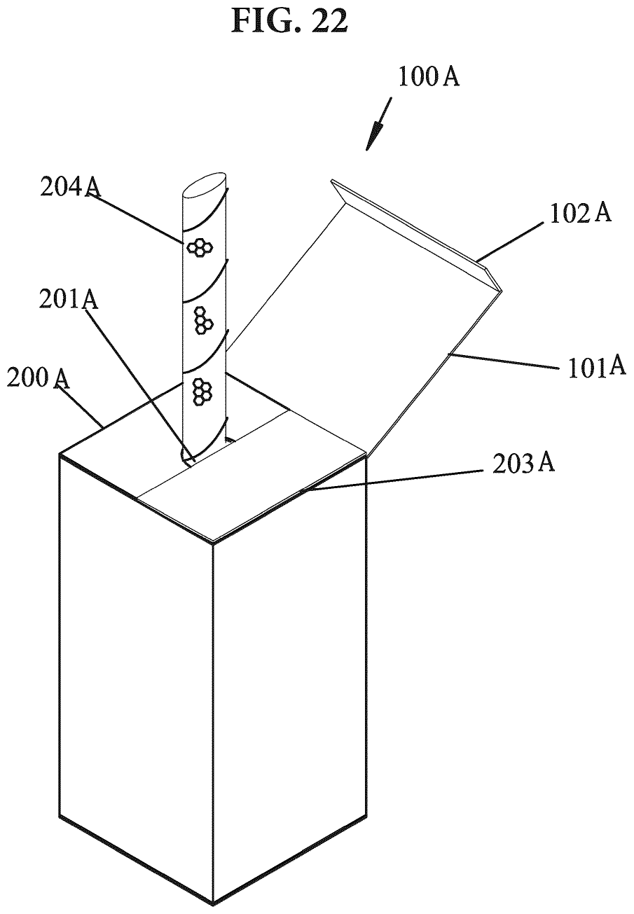

The opening as shown in FIG. 22 is in the form of an archway. The archway can be in the form of a semicircle but can be in the range from a semicircle, plus/minus 25%. Preferably the archway can be in range from a semicircle, plus/minus 15%, and more preferably the range can be a semicircle, plus/minus 5%. As employed herein, the term “semicircle” is inclusive of a half of circle, plus/minus 25% and thus encompasses the term “partial-circle.”

The opening can have other than a straight line in combination with a curved section as shown by example in FIG. 25B, 503A (e.g., in which a substantially smile-shaped configuration is shown). The perimeter of the opening can have a semi-circular segment in combination with an inner curved section where the length of the perimeter of the semi-circular segment is greater than the length of the perimeter of the curved section. The length of the inner curved section 503aA can be in the range from 10% to 50% of the length of the semicircular section. The semi-circular opening can be in the form of shape of a crescent, tapering to rounded edges at the ends. The semi-circular opening shapes are inclusive of a half-moon, sickle-shape, arc, curve, bow, the letter “D”, and an arch. The crescent shape is preferable because the inner curved section applies a resistance to the drawing of the slit material and facilitates the opening of the cells without tearing the slit sheet material.”

It should be appreciated that the dispensing box could be designed with varying top panels and or varying designs to provide the same effect of a semi-circle pattern as can be done with one skilled in the art of box design. In the most preferred embodiments, as shown, feeding of the slit sheet material comes from the center of the roll of slit sheet material 300A as shown in FIG. 23 and feeds directly out of a dispensing box through a semi-circular hole.

### Further Discussion of the Figures

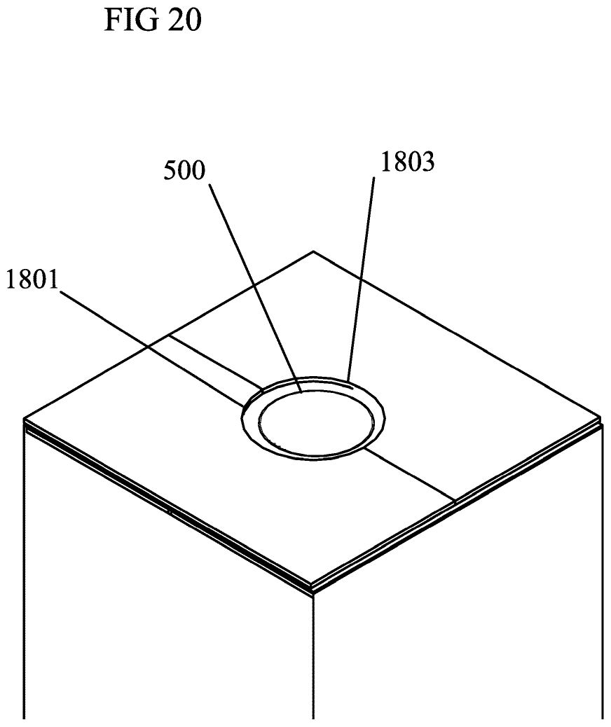

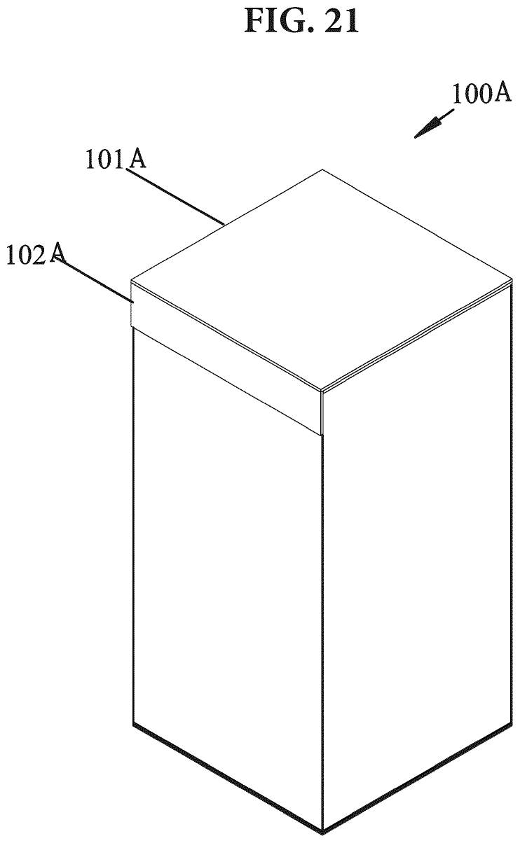

FIG. 21 is a perspective view of the dispensing box 100A where securing panel 101A is folded over the top section of the box and connected subpanel 102A is folded over the side of the box for secure shipping.

FIG. 22 is a perspective view of the dispensing box 100A with securing panel 101A and subpanel 102A is folded away to enable dispensing of the slit sheet material 204A through semi-circular hole 201A of horizontal panel 200A that is kept in place using horizontal panel 203A.

FIG. 23 is a perspective view of the dispensing box 100A with all panels in the open position for loading of the slit sheet material 300A. Semi-circle opening 201A is easily visible within panel 200A. Panel 203A is easily visible as square. Securing subpanel 102A is attached securing panel 101A.

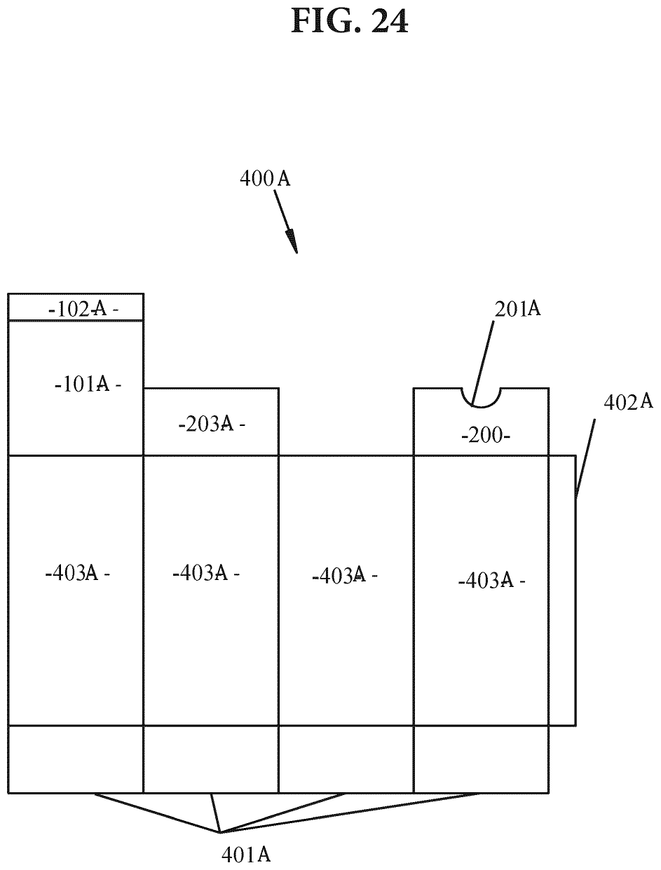

FIG. 24 is a planar view of the manufacturing die that will create the dispensing box 400A. Bottom panels 401A make up the foldable panels that make up the bottom of the box. Identical sidewall panels 403A create the four sides of the dispensing box and is adhesively secured, as found typically within the art of corrugated box making, with panel 402A on the first sidewall panel 403A. Securing panel 101A and subpanel 102A make up the top of the box. Panel 203A is the opposing panel to panel 200A that has semi-circular hole 201A that allows the slit sheet material to exit.

FIGS. 25A to 25C show a perspective view of an alternative box design 500A with a dual partial-circle or crescent shaped opening 503A. Panels 501A and subpanel 502A are identical in design to securing panels 101 and subpanel 102A.

### c) Embodiments Described in 63,000,390

In accordance with some other embodiments of the invention, an automated slit sheet void fill system is provided.

In particular, in some embodiments, an automated machinery can be employed that dispenses the slit sheet material from the center of a coreless roll.

In accordance with some illustrative embodiments, the void fill dispensing systems described herein can include a roller mechanism to pull and/or push the void fill through the opening of the dispenser.

In some preferred embodiments, an automated dispenser includes two pairs of rollers with one pair being rubber and the other the hook material, such as, for example, hook material sold under the mark Velcro that can accept the multi-layer spiraling slit sheet material and expand it into its three-dimensional shape as disclosed in U.S. Pat. Nos. 5,688,578 and 5,782,735, the disclosures of which are incorporated herein as if recited in full. In particular, in some embodiments, the pair of rollers having hook material (or other material that would grab the slits of the expandable slit sheet paper) can be further downstream then the rubber rollers and forcefully pull the expandable paper such as to expand the paper being dispensed.

The present inventor has further discovered that the use of a slit sheet expansion system that uses a first pair of rubber rollers and a second pair of hook filament rollers as described in U.S. Pat. No. 5,782,735 successfully stretches the multi-layer spiral wound slit sheet paper as it is fed from the center core of the unexpanded slit sheet roll. The slit sheet paper can, in some preferred embodiments, feed upward in a generally spiraling manner such that the slits leave the core at an approximate 45-degree angle, and travel upward and into the first set of rubber rollers. These rollers firmly grip the material and send it forward to the hook filament rollers. The hook filament rollers turn more quickly than the back (upstream) rubber rollers such as to achieve the expansion of the slit sheet material on a continuous basis. The expanded material passes through the exit hole that allows it to feed outward.

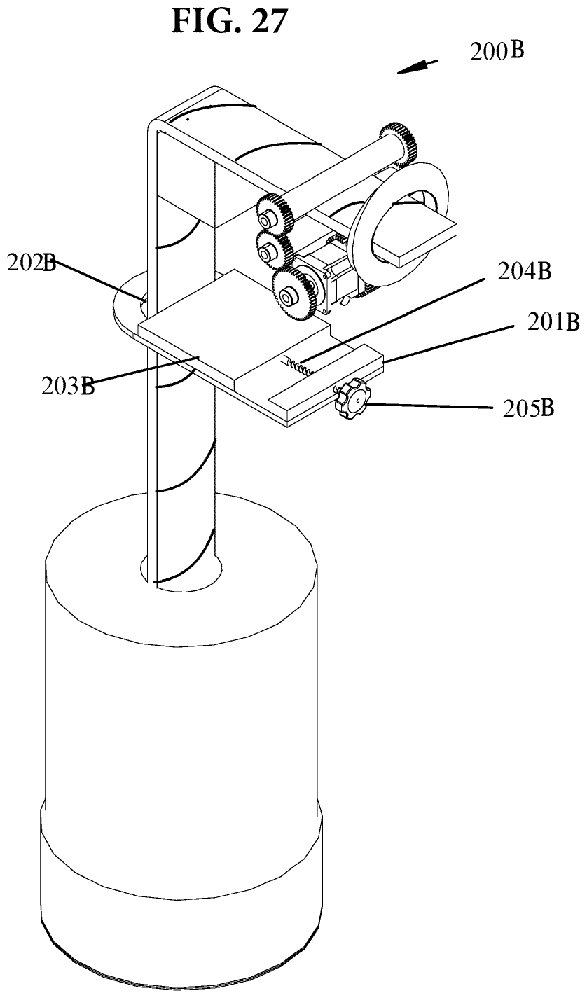

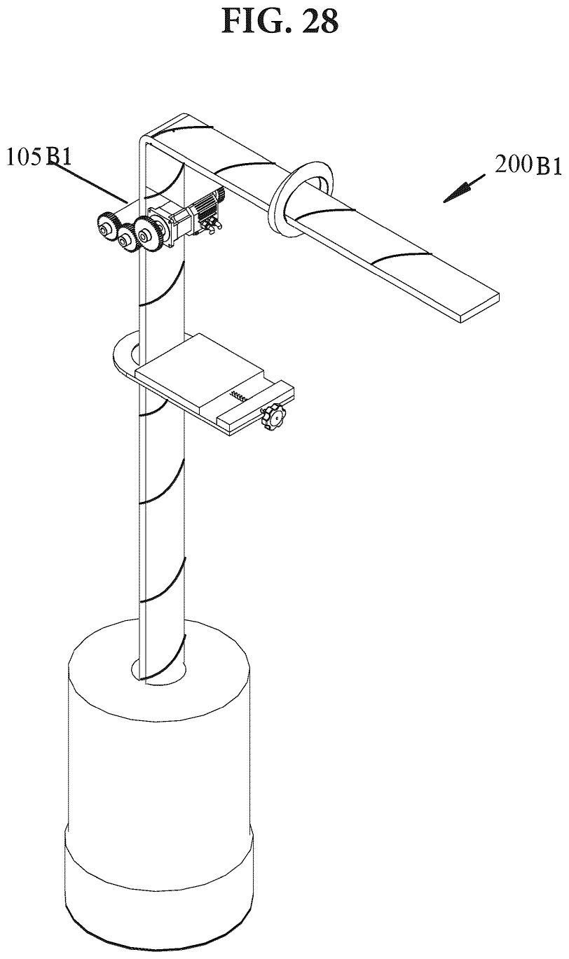

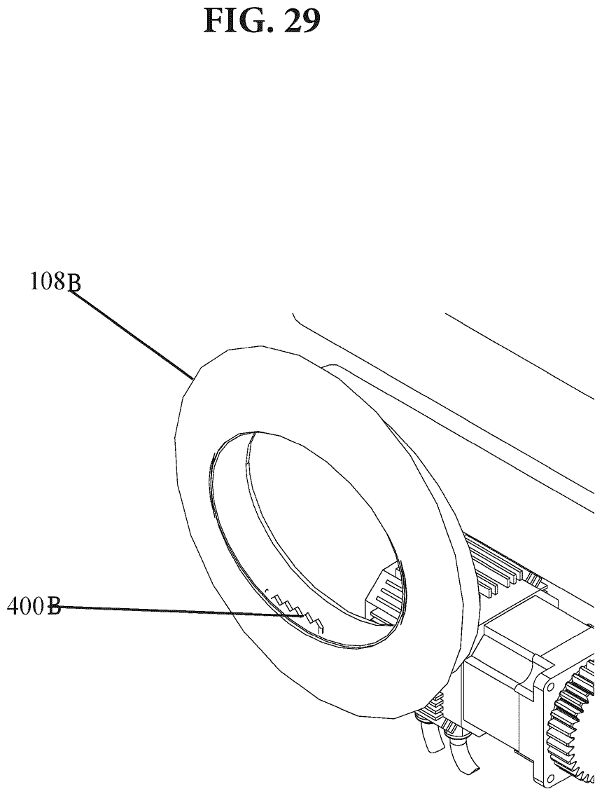

In some preferred embodiments, when enough material is dispensed for a desired purpose (such as, e.g., to void fill a box or a pack), the operator can cause the serrated teeth to engage the void fill tube being dispensed (such as, e.g., by the operator pulling downward on the expanded slit sheet tube material against the serrated teeth to rip the required length). For reference, an illustrative serrated teeth cutting edge is shown in FIG. 29 at the exit hole 400B. In some alternative embodiments, the cutting of the void fill tube (i.e., expanded slit sheet tube) can be fully automated, such as, e.g., by employing an automated solenoid-reciprocated cutting blade or the like.

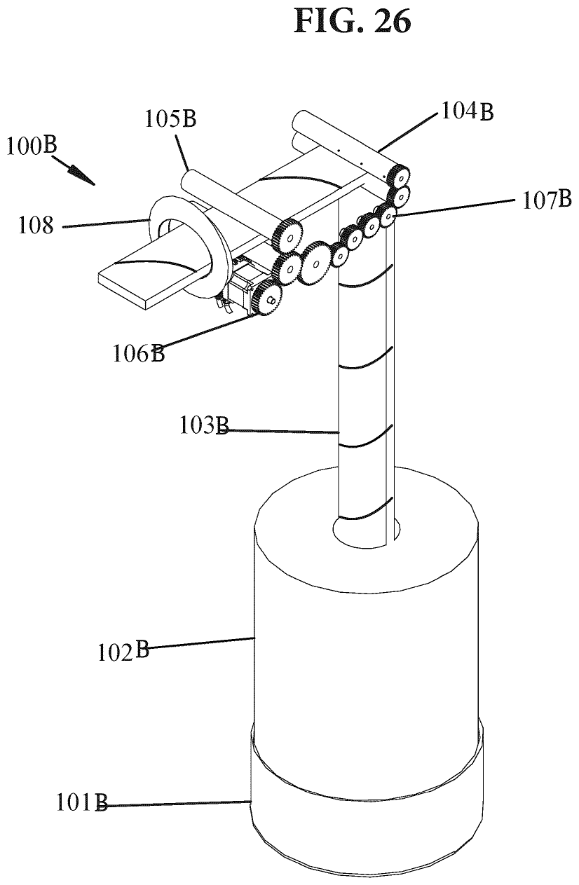

As shown in the example depicted in FIG. 26, in some embodiments, the stretching can be done in a horizontal direction to save space in areas where overhead space is plentiful. As shown in FIG. 27, in some other embodiments, the stretching can be done in the vertical direction where adjacent space is available, but where overhead space is limited. In either configuration, in some embodiments, the ejection of the material through the exit hole and cutting with the serrated teeth can be implemented in a similar manner.

In some embodiments, as shown in FIG. 27, a semi-circle shaped adjustable restriction area adjuster 201B can be employed to impart a desirable degree of restriction to enable expansion. The shape of the restriction area 202B of the adjuster 201B can be similar to that described herein in relation to other embodiments described herein, such as to advantageously provide the tension to expand the slit sheet material completely while simultaneously increasing the feeding speed without the fear of ripping the material prematurely. Similarly, the adjustable restriction area adjuster 201B shown in FIG. 27 can be employed within other dispensing devices described in this application. As also shown in FIG. 27, in this illustrative example, the shape of the opening is preferably adjustable by rotation of a knob 205B that causes rotation of a screw 204B that laterally moves the panel 203B such as to enable the size of the restriction area 202B to be modified.

The semi-circle can be adjusted dependent upon the slit pattern used. This adjustment varies the tension and ease of feed necessary to dispense well.

### Further Discussion of the Figures

FIG. 26 is a perspective view of the dispensing system 100B with paper holder 101B supporting the slit sheet roll 102B with slit sheet spiral 103B spiraling upward to motor driven rubber rollers 104B feeding the slit sheet spiral 103B through to hook filament rolls 105B while being powered by electric motor 106B transferring the motion with multiple gears 107B. The stretched slit sheet spiral 103B then exits through exit hole 108B.

FIG. 27 is a perspective view of the alternative dispensing system 200B that uses adjustable restriction adjuster assembly 201B that applies pressure to the spiral wrap 103B as it passes through restriction area 202B. As indicated above, the restriction area 202B is adjustable using sliding block or panel 203B by turning thumbscrew or knob 205 clockwise (or counterclockwise) that drives threaded shaft or screw 204B and sliding block 203 into restriction area 202B and counterclockwise (or clockwise) to reverse direction of the block 203B.

FIG. 28 is a perspective view of the alternative design of the alternative dispensing system 200B where hook filament assembly 105B is moved into a vertical position along spiral slit sheet 103B.

FIG. 29 is a perspective view of an illustrative exit hole 108B that shows serrated teeth 400 according to some illustrative embodiments.

### d) Embodiments Described in 63,020,016

According to some embodiments, void fill dispensing systems and methods described in any of the embodiments and implementations described herein can employing coreless expandable slit sheet rolls according to some of the preferred embodiments of the present invention. In particular, in order to remove the expandable slit sheet paper from an interior of the roll, the interior of the roll of expandable slit sheet paper should be free of obstruction. However, for handling and/or transporting of rolls of slit sheet expandable paper, it is advantageous to supply an interior core for structural rigidity and support of the roll.

In some implementations, aspects of the preferred embodiments described in this section related to the use of removable cores can be implemented within systems and methods according to any other embodiments described herein.

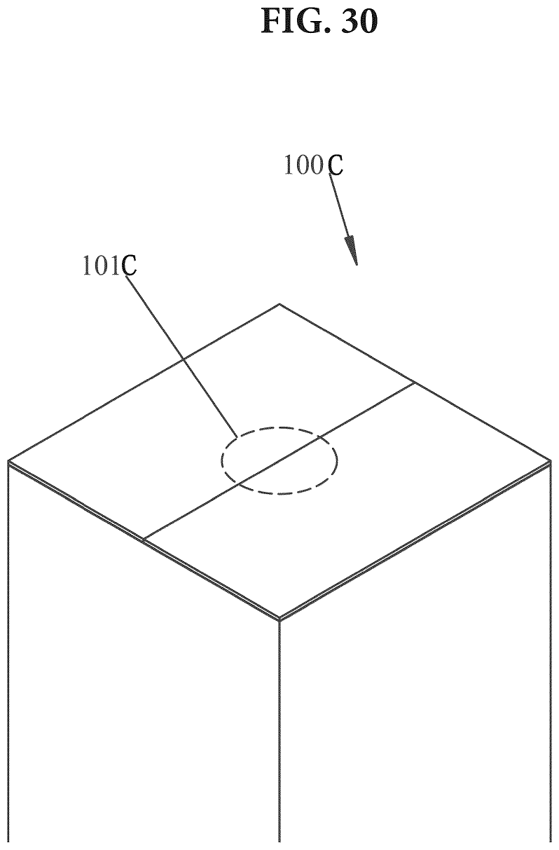

With respect to FIG. 30, this figure shows a top perspective view of an illustrative dispensing box 1000 according to some embodiments. In some embodiments, the dispensing box 100C can be similar to any of the dispensing boxes described in other embodiments herein. In some preferred embodiments, the dispensing box is made of materials similar to that of the dispensing boxes described herein. By way of example, the materials of the dispensing box can be paper, cardboard, corrugated paper board and/or other paper materials. Preferably, the material of the dispensing box is made with a recyclable material, most preferably, with a recyclable paper material.

As shown in FIG. 30, in some preferred embodiments, an end face of the dispensing box 1000 includes a perforated region 101C. In the preferred embodiments, the perforated region is configured to remain in place during initial use and transport of the box, and then, at a later date, the perforated portion preferably enables a region of the end face of the corrugated box to be removed or opened such as to enable the core 2000 to be pulled or pushed through an opening in the end face of the dispensing box caused by opening or removing of a section of the end face of the box that is surrounded by the perforated region 101C. In some preferred embodiments, the perforated region 101C forms a completely enclosed shape (such as, e.g., a circular shape or other desired shape that is sufficient to allow passing of the core through the end face of the box), whereby the completely enclosed shape upon application of a force along the perforations of the perforated region will cause an entire element within the confines of the perforated region to be removed. Alternatively, the perforated region can be non-fully enclosing such that the interior region can be simply pivoted outwardly to allow the core to pass through the end face of the box 100C.

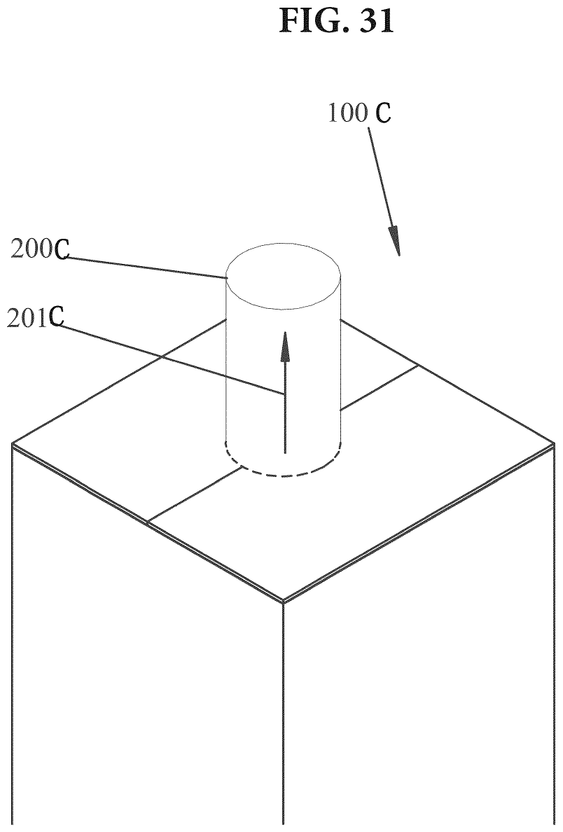

With respect to FIG. 31, in this figure, a state of usage is illustrated in which the interior core 2000 is being removed through the end face of the box 1000, by being pulled or pushed along the direction of the arrow 201C (e.g., in a direction along the axis of the core 2000). In the state shown in FIG. 31, it should be appreciated that the perforated region 101C of the end face would have already been opened (e.g., fully removed or pivoted outwardly) to allow the core 2000 to be removed from the box 100C.

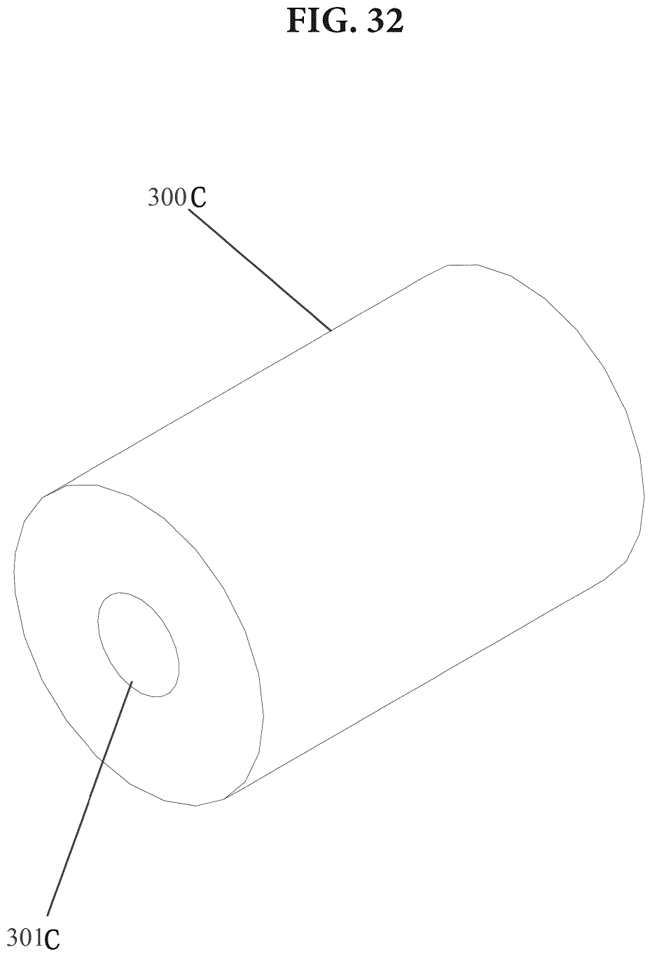

With respect to FIG. 32, FIG. 32 is an explanatory perspective view of a paper roll 3000 without a central core 2000, such that the paper roll 3000 has an internal open center conduit 301C delineated by the innermost layer of paper within the roll 3000. In preferred embodiments, during use, the paper roll 3000 would be a roll of slit sheet expandable paper that is contained inside the box 1000. Accordingly, in some preferred embodiments, a dispensing box 1000 would have a roll 3000 contained therein, along with a core 2000 extending within the center conduit 301C of the roll. In some preferred embodiments, the product could be shipped in this state, and, then, prior to usage (i.e., prior to usage as a dispensing of void fill material similar to embodiments described herein), a user can remove or open the portion delineated by the perforated region 101C (e.g., which can be a “punched out” region), then the user can slide the core 2000 out of the dispensing device.

Among other things, such a removable core can be advantageous for maintaining the integrity of the paper roll 3000 during shipping and transport.

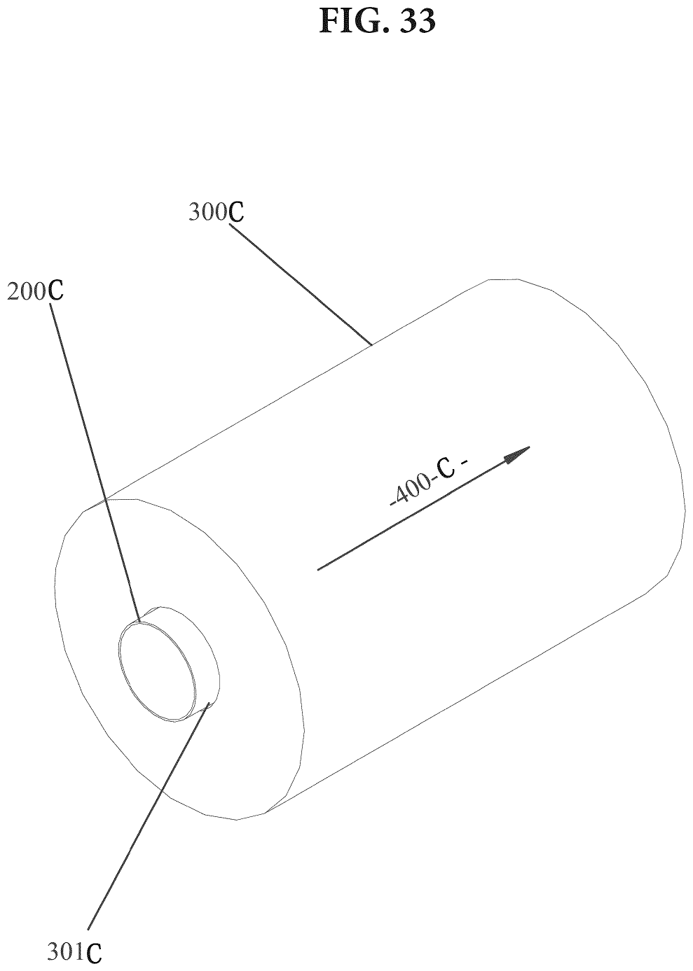

With respect to FIG. 33, FIG. 33 is another explanatory perspective view of a paper roll 3000, which, however, shows a central core 2000 in a partially withdrawn state from the internal open center conduit 301C delineated by the innermost layer of paper within the roll 3000. As with FIG. 32, FIG. 33 shows the roll 3000 without the presence of the exterior box for explanatory purposes. However, in the preferred embodiments, the roll would be contained within such a dispensing box 1000 during use, and the core 2000 would be removed via the opening in the end of the box as described above.

As illustrated by the direction of the arrow 4000 shown in FIG. 33, in the preferred embodiments, while the core 2000 is pulled or pushed from the core in the leftward direction shown in FIG. 33, in use of the dispenser (i.e., which contained within the dispensing box 1000), the expandable slit sheet paper is removed or extended in an opposite direction to the direction of the core, which opposite direction is designated by the arrow 4000 shown in FIG. 33.

Thus, in the preferred embodiments, after removal of the perforated region portion, the core 2000 can be pushed or pulled axially in a first direction for removal from the dispensing box. Then, the expandable slit sheet paper can be dispensed from the dispenser device in an opposite direction to the direction of the removal of the core.

Although the preferred embodiments include a perforated region 101C to enable the core 2000 to be readily removed after shipping, in other embodiments a variety of other structures could be employed to allow removal of the core 2000. For example, in some embodiments, an end face panel of the box can simply be pivoted open to allow the core to be removed. Alternatively, in some embodiments another removable connection mechanism (i.e., rather than perforations) can be employed, such as, e.g., employing a removable cover that is glued, stitched, clipped and/or otherwise mechanically or chemically openably or removably coupled to the box.

Although not shown in FIGS. 30-33, it should be understood that as with other embodiments described herein, the dispensing box 1000 would also include a similar dispensing opening (i.e., similar to that described in relation to other embodiments herein to effect dispensing) on a side of the dispensing box opposite to the perforated region 101C shown in FIG. 30. Moreover, it should be appreciated that any of the shapes and configurations of the dispensing openings as described in any of the embodiments described herein can be employed in illustrative embodiments, including, but not limited to the use of a semi-circle exit feed or crescent shaped exit feed, such as, e.g., to provide tension to expand the slit sheet material during dispensing.

Although the preferred embodiments discussed above include a core 2000 that is removed from the dispenser box 1000 by being axially drawn in a direction (e.g., direction 201C shown in FIG. 31) which is opposite to the axial direction 4000 shown in FIG. 33, in some alternative embodiments, the core 2000 could be removed in the same axial direction that the expandable slit sheet material is removed from the dispensing box. For example, in some embodiments, the core 2000 could consist of a plurality of lengthwise core segments that can be individually removed through the dispensing opening. For example, in some embodiments, the core 2000 can include two elongated pieces having half-circle cross-sectional shapes that are fitted together within the interior of the roll 3000 to form a dual-piece core 2000. In some embodiments, the core could even consist of three or more separable pieces.

According to the preferred embodiments, a dispensing system employing a removable core can advantageously provide substantial benefits facilitating handling, transport or shipping of the dispensing device. Notably, as described above, in some preferred embodiments, an internal core 2000 can be mounted within the dispensing system and included within the original product. Then, the original product, with the internal core 2000 can be readily shipped or otherwise handled, and, upon reaching or being located at a dispensing location, the core 2000 can be readily removed and the device can be conveniently used to dispense void fill material in accordance with various embodiments as described herein above.

Moreover, in some preferred embodiments, the core 2000 would be removed prior to use and then discarded. However, in some embodiments, if the device is later desired to be stored, transported or otherwise manipulated, the core 2000 could potentially be replaced within the center conduit of the paper roll for ease in transport, handling and/or the like.

In the preferred embodiments, the paper roll 3000 is initially manufactured such as to be formed without an internal core. Then, upon fabrication of the dispensing system, the paper core 2000 is preferably inserted within the interior of the paper roll 3000. In the preferred embodiments, the paper core 2000 has an axial length that is the same or approximately the same as the axial width of the paper roll 300. However, in some embodiments, the paper core 2000 can have an axial length that is slightly greater than the axial length of the paper roll 3000, such that the paper core extends slightly beyond the edge of the paper roll 3000 to facilitate manual grasping of the paper core 2000 for removal by pulling in the direction of the arrow 201C shown in FIG. 31. Moreover, in the preferred embodiments, the core 2000 is made of paper or cardboard such as to be recyclable and/or is made of another recyclable material.

### e) Embodiments Described in 63,064,393

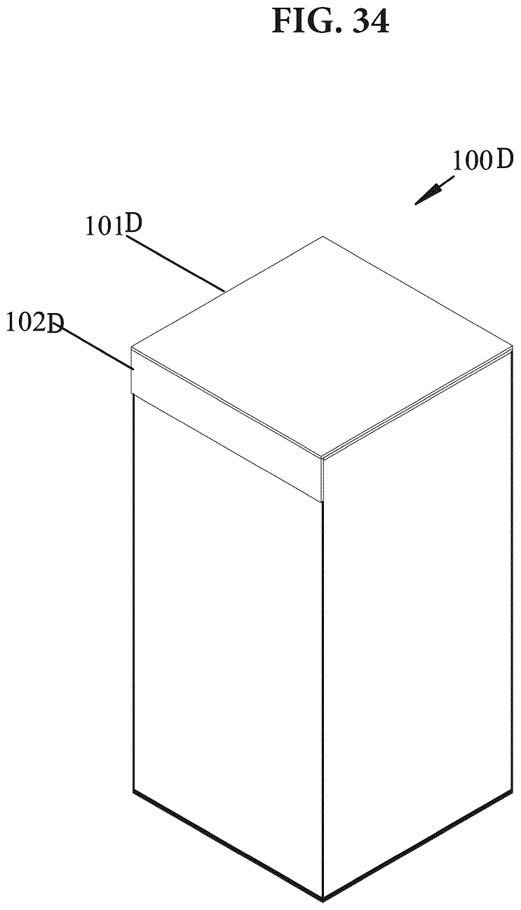

FIGS. 34-37 depict additional embodiment of the invention which involves a shipping/dispensing box that includes another novel opening configuration according to some illustrative embodiments.

In fabricating of the embodiment shown in FIGS. 34-37, the shape of the opening can be slightly adjusted dependent upon the slit pattern which varies the tension and ease of feed necessary to dispense well. Alternatively, in some embodiments, the opening can be configured to be adjustable to enable adjustment as desired during use of the device.

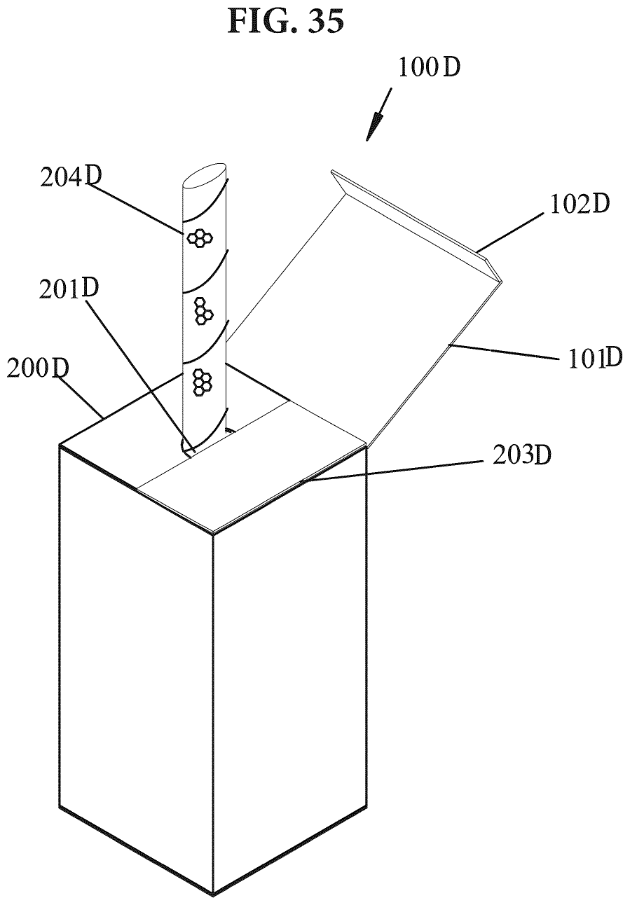

As shown in FIG. 35, in this example, the opening 201D has a substantially semi-circle or “D” shape with the opposing flap 203D being square (straight) and, therefore, forcing the expanded slit material 204D material through an irregular shape opening 201D. As described above, the shape of the opening 201D as shown in FIG. 35 falls within the term “semi-lune” which is in the configuration of the letter “D”.

By way of an example, in some embodiments, the semi-circle could be made smaller to increase tension or the panel 203D could be adjusted to enable a fuller circular shape (e.g., to enable a larger % of a circular shape). This is very easily accomplished by increasing the length of panel 203D beyond the centerline of the two flaps making it greater in length while panel 200D is reduced in length and therefore reduces the semi-circular hole. Conversely, in some embodiments, panel 203D could be made shorter and panel 200D made longer which would increase the circumference of the circle. Additionally, in some embodiments, the end position of the panel 203D can be made adjustable (such as, e.g., by employing a releasable attachment mechanism, such as, e.g., a hook and loop fastening fabric on the rear of the panel 203D to enable the position to be adjusted adjacent the opening 201D).

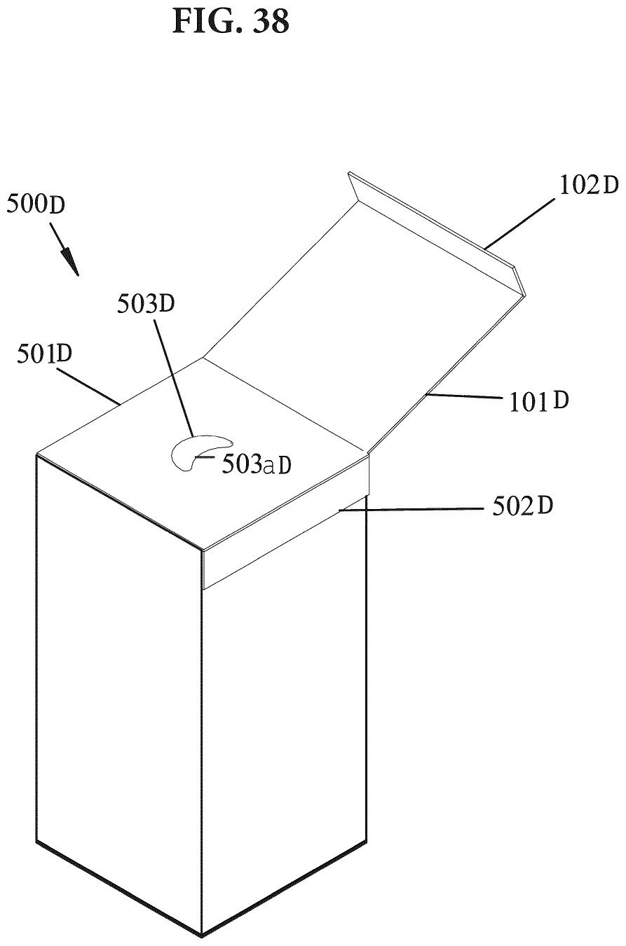

FIG. 38 shows a variation of the design shown in FIG. 35, but, overall, the purpose is to create variations to obtain the desired shape of the hole. One skilled within the art can create a multitude of designs to accomplish the required end results. Thus, there are a variety of ways to provide a desired opening configuration, each of which can produce essentially functionally similar results. In some preferred embodiments, a common characteristic of the designs is to provide an opening whose area is less than that of a full circle and, preferably, with a portion of the periphery in the form of an arc or semi-circle which, in combination with the remainder of the periphery of the opening, produces an opening that is less than that of a full circle and serves to facilitate the expansion of the slit paper 300D.

The opening as shown in FIG. 35 is in the form of an archway. The archway can be in the form of a semicircle but can be in the range from a semicircle, plus/minus 25%. Preferably, the archway can be in range from a semicircle, plus/minus 15%, and, more preferably, the range can be a semicircle, plus/minus 5%. As employed herein, the term “semicircle” is inclusive of a half of circle, plus/minus 25% and, thus, encompasses the term “partial-circle”. The term “semicircle” also encompasses the term semi-lune as noted above.

Preferably, the opening is a concave figuration formed by the intersection of the arcs of two circles on a plane, or on a sphere the intersection between two great semicircles

The opening can have other than a straight line in combination with a curved section as shown by example in FIG. 38, 503aD. The perimeter of the opening can have a semi-circular segment in combination with an inner curved section where the length of the perimeter of the semi-circular segment is greater than the length of the perimeter of the curved section. The length of the inner curved section 503aD can be in the range from 10% to 50% of the length of the semicircular section. The semi-circular opening can be in the form of shape of a crescent, tapering to rounded edges at the ends. The semi-circular opening shapes are inclusive of a half-moon, sickle-shape, arc, curve, bow, the letter “D”, and an arch. The crescent shape is preferable because the inner curved section applies a resistance to the drawing of the slit material and facilitates the opening of the cells without tearing the slit sheet material.

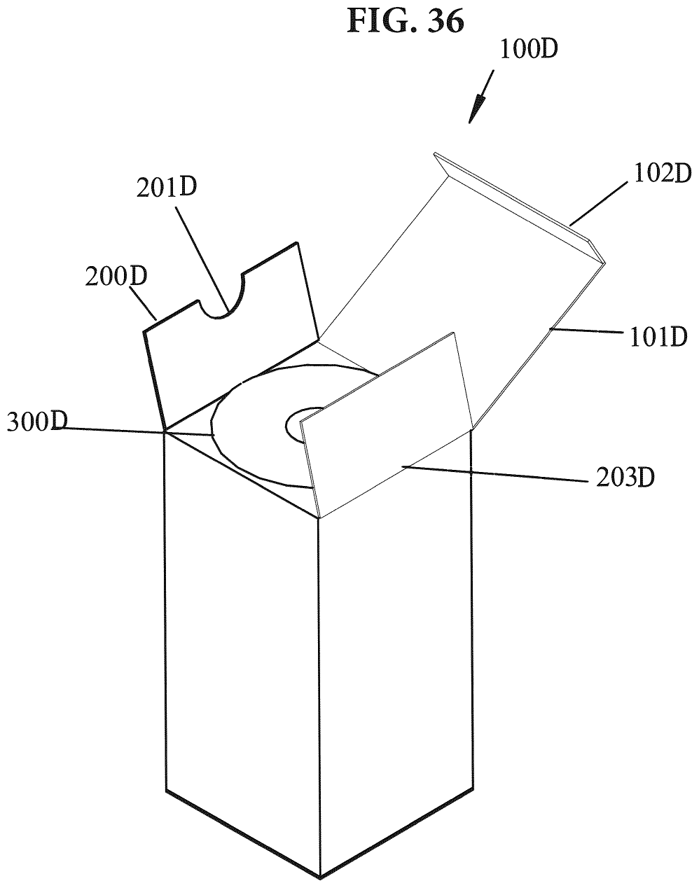

In other embodiments, the dispensing box could be designed with varying top panels and or varying designs to provide the same effect of a semi-circle pattern as can be done with one skilled in the art of box design. Notably, feeding of the slit sheet material comes from the center of the roll of slit sheet material 300D as shown in FIG. 36 and feeds directly out of a dispensing box through a semi-circular hole.

In further embodiments, the opening is in the shape of a concave figure formed by the intersection of the arcs of two circles on a plane.

### Further Discussion of the Figures

FIG. 34 is a perspective view of the dispensing box 100D where securing panel 101D is folded over the top section of the box and connected subpanel 102D is folded over the side of the box for secure shipping.

FIG. 35 is a perspective view of the dispensing box 100D with securing panel 101D and subpanel 102D folded away to enable dispensing of the slit sheet material 204D through semi-circular hole 201D of horizontal panel 200D that is kept in place using horizontal panel 203D.

FIG. 36 is a perspective view of the dispensing box 100D with all panels in the open position for loading of the slit sheet material 300D. Semi-circle opening 201D is easily visible within panel 200D. Panel 203D is easily visible as square. Securing subpanel 102D is attached securing panel 101D.

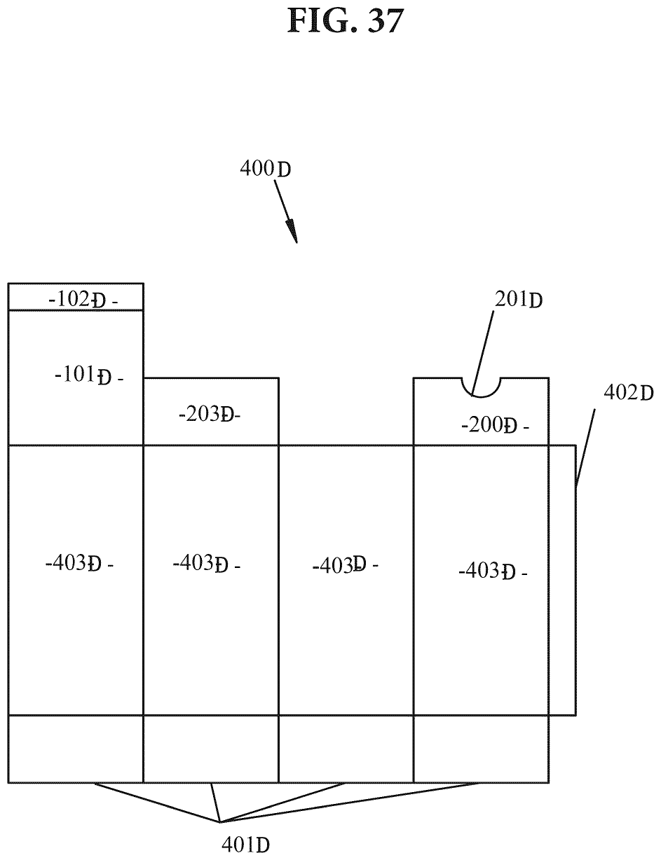

FIG. 37 is a planar view of the manufacturing die that will create the dispensing box 400D. Bottom panels 401D make up the foldable panels that make up the bottom of the box. Identical sidewall panels 403D create the four sides of the dispensing box and are adhesively secured, as found typically within the art of corrugated box making, with panel 402D on the first sidewall panel 403D. Securing panel 101D and subpanel 102D make up the top of the box. Panel 203D is the opposing panel to panel 200D that has semi-circular hole 201D that allows the slit sheet material to exit.

FIG. 38 is a perspective view of an alternative box design 500D with a dual partial-circle or crescent shaped opening 503D. Panels 501D and subpanel 502D are identical in design to securing panels 101D and subpanel 102D.

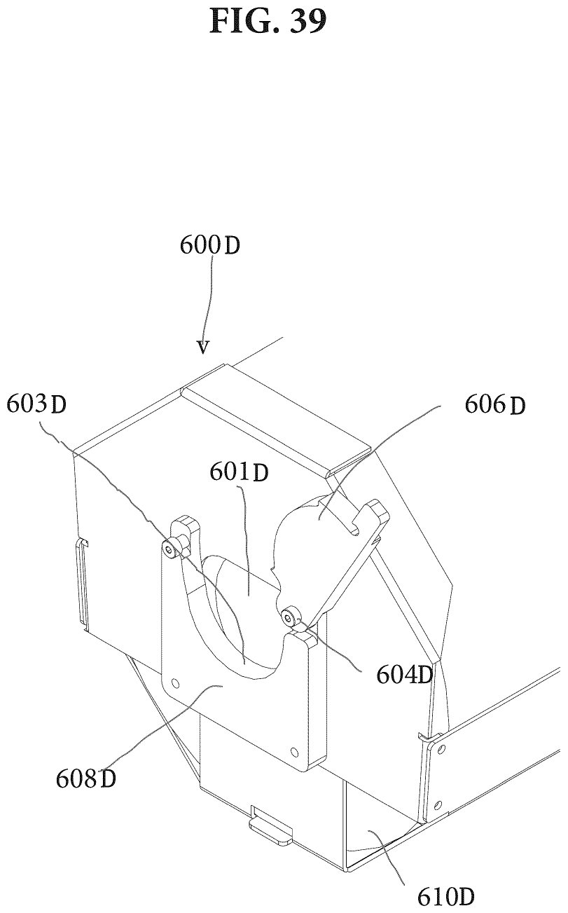

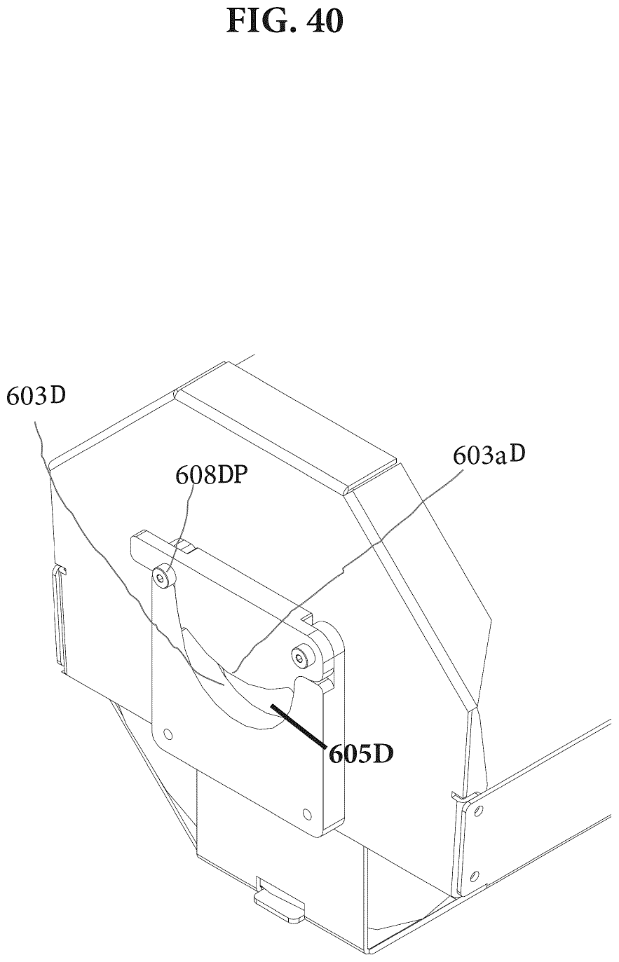

FIG. 39 is a perspective view of an alternative design indicated generally as 600D, for a unit for supporting a roll 610D of unexpanded slit sheet material. The frame member 600D has an opening 601D for access to the roll of unexpanded slit sheet material 610D. The paper is fed through opening 601D access to which is regulated by a member 606D for partially blocking the opening 601D. In some embodiments, the member 606D preferably pivots or rotates around the pin 604D, such as to move between a raised position such as shown in FIG. 39 and a lowered position such as shown in FIG. 40. In some embodiments, the pin 604D can be positionable to adjust the height of the member 606D so as to adjust the width of the opening. Similarly, in some embodiments, a second pin (shown in FIG. 39) can be adapted to be adjustably engaged to a distal end of the member 606D so as to allow adjustability of the position of the member 606D so as to allow for adjustment of the opening by varying the position of the member 606D.

In some alternative or variation embodiments, the member or device 606D can include one or more of the following:
A) a guillotine blade that slides along guides or rotates about a pivot or otherwise is movable such as to be able to adjust the position and, thus, be able to adjustably partially or incompletely comes down towards the slit expandable paper and cause the paper to expand as it passes beneath the guillotine blade by applying friction thereto;
B) a broad flat or convex blade that moved into the path of the slit paper and causes the paper to expand as it passes between the concave solid member 608 and the blade by applying friction thereto;
C) a blade that is a movable piece that can be, e.g., guided along the member upon which it slides;
D) a flap, or a closure, or a gateway, that is a movable, solid barrier for opening and closing an exit from a receptacle, container or housing that turns on hinges, slides in grooves, rotates about a pivot, or otherwise moves via some mechanical moving mechanism or support;
E) a door that slides in grooves, rotates about a hinge, pivots, or otherwise moves via some mechanical moving mechanism or support, or that otherwise provides a movable barrier that allows egress of paper from a roll of paper, by moving from an open position to a partly closed position;
F) a shutter that is a movable cover for opening or closing the aperture of the paper's passageway from the paper support 600D;
G) a lid that is a movable cover for an egress from a hollow receptacle or box containing a roll of expandable slit paper; and/or
H) a cover plate that is a structure for closing an opening or egress from a receptacle that contains a roll of center pull expandable slit paper.

FIG. 40 is a perspective view of the device of FIG. 39, indicated generally as 600D, for a unit for supporting a roll 610D of unexpanded slit sheet material. The blade 606D is rotated about the pivot member 604D until it comes into contact with the pin 608DP of the member 608D. The rotation mechanism can be a pivot pin, or shaft on which the blade 606D turns or rotates.

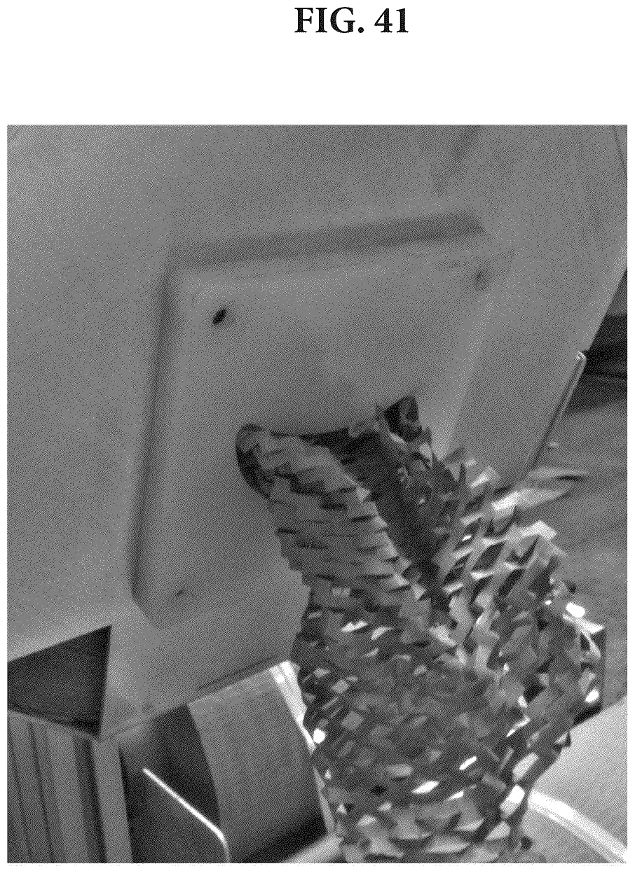

In FIG. 40, the frame member 600D opening 601D for access to the roll of unexpanded slit sheet material 610D is shown in the closed position that provides a partial opening that is a crescent shaped opening 605D. The paper can be manually or by a powered system pulled through the crescent shaped opening formed by the plate 603D and the blade 606D. The edges 603aD and 603D, in combination, produce an opening 605D that restricts or resists the movement of the slit paper. The restriction of the flow of the paper causes the slit paper to expand as shown in, e.g., FIG. 35 and/or FIG. 41.

Towards that end, FIG. 41 is a photograph of an expanded slit sheet paper being dispensed from a crescent shaped open such as to illustrate a manner of expansion according to some preferred embodiments.

In some preferred embodiments, the paper roll 300D is initially manufactured such as to be formed without an internal core. Then, upon fabrication of the dispensing system, the paper core (such as, e.g., core 2000 in FIG. 33) is preferably inserted within the interior of the paper roll 300D. In the preferred embodiments, the paper core 2000 has an axial length that is the same or approximately the same as the axial width of the paper roll 300D. However, in some embodiments, the paper core 2000 can have an axial length that is slightly greater than the axial length of the paper roll 300D, such that the paper core extends slightly beyond the edge of the paper roll 300D to facilitate manual grasping of the paper core 2000 for removal by pulling in the direction of the arrow 201C shown in FIG. 31.

### f) Discussion of Further Embodiments and Features

As explained herein-above, in some of the preferred embodiments, of the invention, a void fill dispensing system and method is provided that can—highly advantageously—create a viable void fill product with expandable slit sheet paper despite the fact that such was previously impossible with the background art.

In some embodiments, the present inventor discovered a means to create such novel and unique systems and methods by identifying the following:
a) The present inventor identified that prior expandable slit sheet paper had properties that prevented the ability to create viable void fill product, including that prior expandable slit sheet paper a) required too great of a force to expand the paper and b) was not sufficiently strong enough to avoid tearing.
b) The existing slit sheet expansion devices were not capable of creating an expanded slit sheet paper that resists retraction upon expansion, without requiring a second further step of wrapping the expanded slit sheet paper or otherwise retaining the expanded slit sheet paper in an expanded state.

In some preferred embodiments, a novel void fill dispensing system is provided that includes both a) a novel extensible slit sheet paper and b) a novel dispenser mechanism. In the preferred embodiments, the novel dispenser mechanism is specially configured to provide a sufficient amount of resistance to enable expansion of the novel extensible slit sheet paper, but, at the same time, avoiding pre-mature tearing of the novel extensible slit sheet paper.

Additionally, in the preferred embodiments, the novel dispenser mechanism is also specially configured to cause the expandable slit sheet paper to have surfaces of the expanded cells contact one another during the expansion process, shortly after expansion, and/or shortly before expansion such that when the novel dispenser mechanism expands the novel extensible slit sheet paper, the expanded sheet has a tendency to inhibit retraction of the expanded sheet. For example, the expanded sheet is preferably expanded in a state such that adjacent expanded cells a caused to contact one another and interlock at least to some degree so as to resist retraction of the expandable slit sheet product.

According to some preferred embodiments, a novel dispenser mechanism includes a support for a roll of expandable slit sheet material (preferably, a roll of extensible slit sheet material), and a specially designed restricting orifice that is configured to receive expandable slit sheet paper that is laterally pulled from a center of the roll of expandable slit sheet material.

The use of a hexagonal cell forming slit pattern in such a center pull system would have been expected to fail or at least produce low cushioning because expanded hexagonal cells have an inherent tendency to retract/un-expand. Furthermore, it would have been expected that pulling a slit sheet paper in this manner would not be viable because the expansion forces required would be too great, especially in relation to the low tear strength of existing expandable slit sheet papers. Additionally, as expandable slit sheet papers had only previously been expanded in a flat state to enable uniform opening of cells, it would not have been appreciated that a center pull system could be used to expand a special extensible paper type expandable slit sheet paper. However, the present inventor has discovered that by employing a novel extensible slit sheet paper, it is possible to expand extensible slit sheet paper with a center pull mechanism by having a specialized outlet in a manner to create adjacently contacting opened cells (e.g., an expanded sheet with expanded hexagonal cells) that contact one another in a manner to substantially inhibit or to be even free of retraction, advantageously retaining its expanded state and cushioning properties.

While this disclosure is not limited by proposed theories, the present inventor has found that by establishing a center pull mechanism, when employing an extensible slit sheet paper, and when employing a specially configured outlet that a) provides sufficient resistance to enable expansion, b) avoids premature tearing or “catching” of the cells of the paper, c) enables the paper to flow or move through the specially configured outlet in a manner that the expanded slit sheet paper freely twists and/or folds during expansion enables the creation of highly useful and advantageous expanded slit sheet paper void fill (e.g., directly or immediately after expansion) without requiring secondary steps such as, e.g., rolling or wrapping of the expanded sleet sheet paper. The present inventor theorizes that his unique system advantageously enables the paper to twist and/or to fold in a manner that causes the expanded cell to retain or substantially its expanded state without significant retraction. Thus, while one of ordinary skill in the art would expect that expanded hexagonal cell forming slit sheet material would retract and fail to provide adequate cushioning, it has now been found that the inventor's novel process of center pulling hexagonal cell forming slit sheet material can cause the expanded cells to remain expanded.

Although embodiments of the present invention could be implemented without the use of extensible slit sheet paper, the present inventor has also discovered that due to the unfavorable properties of expandable slit sheet papers that are not extensible, systems that do not employ extensible slit sheet paper would be substantially less viable.

According to some alternative embodiments, one or more of the embodiments described herein-above can be modified to employ a novel and advantageous opening or outlet or donut aperture.

### Novel-Shaped Outlet

As described herein-above, in preferred embodiments, the dispenser is preferably configured with a unique and novelly-shaped outlet in accordance with embodiments described herein. As also indicated herein-above, by combining such a unique outlet with unique extensible slit sheet paper and/or other advantageous features of dispensers described herein, a highly effective void fill dispensing device can be achieved.

In some examples, as discussed above, the use of a semi-circular shape, partially circular shape, or crescent shape opening has been determined by the inventor to be highly advantageous in some preferred embodiments and implementations. While it would be expected that the use of a semi-circular opening would result in premature tearing of the slit paper during the expanding of the slit paper, the present inventor discovered that, surprisingly, the opposite occurs. On the contrary, the present inventor has discovered that the tendency of the slit sheet paper to tear in an uncontrolled manner has been reduced by the implementation of such novel openings, rather than being exacerbated.

The use of a semi-circle exit feed or crescent shaped exit feed unexpectedly provides tension to expand the slit sheet material completely while simultaneously increasing the feeding speed without the fear of ripping the material prematurely. This shape of a crescent can be used in some embodiments within all of the dispensing systems described herein. In particular, while an exemplary implementation is described in relation to a corrugated box embodiment, such a novel opening shape can be implemented within any of the void fill dispensing systems described herein. In the preferred embodiment, the crescent shape is a type of lune (e.g., partial moon shape), which includes a generally circular disk shape with a portion of another generally disk shape removed from it, so that what remains is generally a shape enclosed by two circular arcs which intersect at two points. In a crescent, the enclosed shape does not include the center of the original disk. The tapered regions towards the points of intersection of the two arcs are known as the “horns” of the crescent. See: Wikipedia. It should be noted that in the preferred embodiments, the horns of the crescent are advantageously rounded at their ends, rather than tapering to a point.

As employed herein, the term “crescent” describes a shape that is formed by two arcs intersecting at two points. Similarly, the term “lune” describes a concave-convex area or region bounded by arcs of equal or different radii. The arcs radii can have the same radii centers or spaced radii centers. Advantageously, the corners of the lune are rounded. As employed herein, the term “arc” is generic and includes, inter alia: a circular arc (arc of a circle); a parabolic arc is (the arc of a parabola); and an oval arc (the arc of an oval).

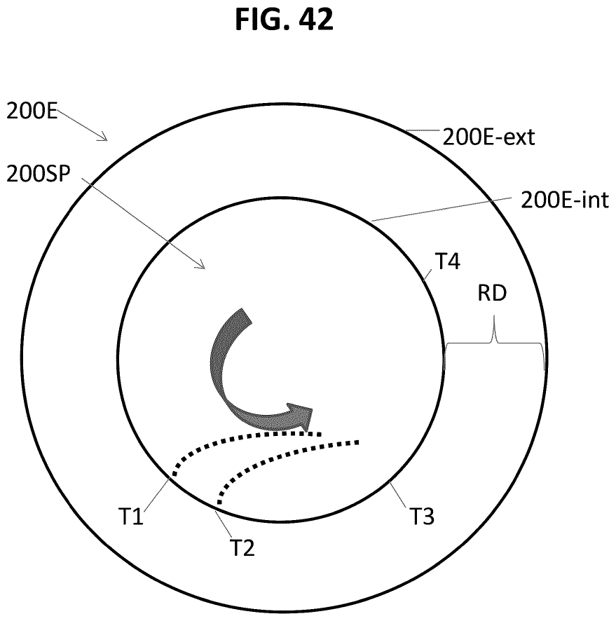

With reference to FIG. 42, FIG. 42 is a schematic drawing show the end face of a roll of expandable slit sheet paper 200E. In this illustrative example, the perimeter or exterior of the roll is shown at 200E-ext and the interior of the roll is shown at 200E-int. As described herein, in preferred embodiments in which the slit sheet paper is “removed” by being laterally pulled from an “interior end of the roll” at the interior region 200E-int rather than from the exterior end of the roll at the exterior region 200E-ext, as the slit sheet paper is continuously pulled from the center of roll, the paper is caused to laterally exit from the center interior of the roll by disengaging from the contacting layers of sheet within the roll, and being laterally pulled within the interior space 200SP within the center of the roll 200E.

In this manner, it should be appreciated that as the slit sheet paper is continuously pulled from the interior of the roll 200E, the roll thickness diameter RD will continually decrease until all of the paper is eventually removed from the center of the roll 200E.

During this continued process, the interior end of the roll will disengage from the interior of the roll progressively in a manner to continuously change the point of disengagement in a circular pattern (which is dependent of the direction in which the roll is wound around the core. For example, as shown in FIG. 42, the roll may first disengage at a point T1, then later at a point T2, then later at a point T3, then later at a point T4, etc., and continuously progress in this manner as illustrated by the curved arrow shown in FIG. 42.

The present inventor has discovered that, in some embodiments, by capitalizing on this rotational quality, such as, for example, by imparting a unique dispenser outlet that a) provides sufficient resistance to enable cell expansion while b) enabling the withdrawn product to continue to follow with a circling or spiraling pattern, a highly advantageous void fill product can be achieved. Moreover, as indicated above, the present inventor also discovered that such a product is most viable by employing an extensible slit sheet paper in the preferred embodiments.

In some preferred embodiments, the outlet opening of the dispenser is configured in a manner to accommodate two goals: a) to provide sufficient resistance to enable the cells of the slit sheet paper to be expanded (e.g., upon manually pulling the slit sheet paper through the outlet or automatically pulling the slit sheet paper through the outlet) and b) to provide sufficient accommodation to allow the slit sheet paper to smoothly flow through the outlet in a manner that avoids premature tearing of the slit sheet paper and that enables the slit sheet paper that exits the outlet to form a properly configured void fill product.

Towards that end, in some preferred embodiments, the outlet is configure to enable the slit sheet paper that exits the outlet to form a properly configured void fill product by enabling the paper to continue to rotate during passage through the outlet in a manner to create a tubular void fill tube member that exits the outlet.

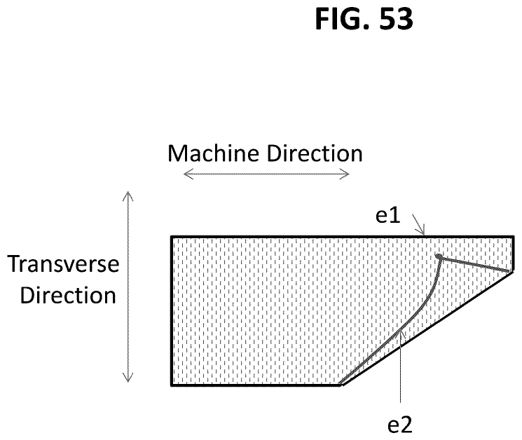

In the preferred embodiments, this void fill tube member is a uniquely configured member in which the expandable slit sheet paper has been expanded such that cells of the expandable slit sheet paper are opened, and, at the same time, the expandable slit sheet paper forms a tubular shape in which opposing portions of the expandable slit sheet paper contact one another such as, e.g., to form a tubular or generally tubular shape. For example, as shown in the explanatory schematic diagram of FIG. 53, in some preferred embodiments, opposing portions of the expandable sleet sheet paper that is pulled from the roll (i.e., from the interior) is caused to form a tubular configuration in which the opposite ends e1 and e2 in a transverse direction of the slit sheet paper is caused to contact one another and/or in which regions near the opposite ends e1 and e2 or regions at different locations within the transverse direction of the slit sheet paper are caused to contact one another.

In this manner, by virtue of such contact with the slit sheet paper in an expanded state, the open cells of the expanded slit sheet paper can interlock in a manner to cause the tubular void fill tube member to retain or substantially retain its expanded form.

Furthermore, in the preferred embodiments, the continued pulling of the tubular void fill tube imparts a rotation that increases contact or enhances contact between the opposite ends e1 and e2 and/or regions near the opposite ends e1 and e2 and/or regions at different locations within the transverse direction. Thus, the dispensing is preferably configured in a manner to enhance formation of such a tubular void fill member, and to enhance interlocking of cells thereof.

Additionally, in the formation of the tubular void fill member, the cells preferably interlock not only in a direction that is parallel to the length of the tubular void fill member, but in preferred embodiments, the cells also preferably interlock in a direction transverse to the length of the tubular void fill member. Accordingly, by interlocking in a direction transverse to the length of the tubular void fill member, the tubular void fill member can be even further inhibited from retraction after expansion.

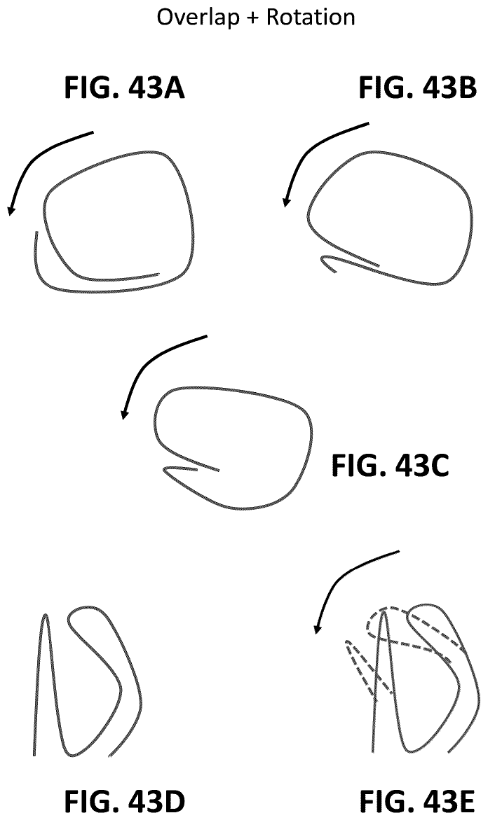

For further reference, FIGS. 43A-43E are explanatory views representing illustrative manners of causing a tubular void fill tube to overlap such that contact occurs between the opposite ends e1 and e2 and/or regions near the opposite ends e1 and e2 and/or regions at different locations within the transverse direction of the expanded slit sheet paper.

For example, as shown in the illustrative example in FIG. 43A, in some embodiments, the expandable slit sheet paper forms a substantially tubular shape with at least a portion of one end overlapping the other end as shown. Here, this view is a schematic representation of a cross-section taken through the tubular void fill tube. However, as the tubular void fill tube is continuously rotating, it should be appreciated that in actual preferred embodiments, multiple layers and variations are formed during expansion. As shown in FIG. 43A, in this illustrative example, an underside of one end (e.g., e1) of the expanded slit sheet paper extends around and contacts an upper-side of the other end (e.g., e2) of the expanded slit sheet paper.

In the example shown in FIG. 43B, one end (e.g., e1) is flipped outwardly but still extends over the other end (e.g., e2).

In the example shown in FIG. 43C, one end (e.g., e1) is flipped inwardly but still extends over the other end (e.g., e2). However, in this illustrative example in FIG. 43C, an upper-side of one end (e.g., e1) of the expanded slit sheet paper contacts an upper-side of the other end (e.g., e2) of the expanded slit sheet paper.

In some embodiments, as this formation is a continuous process, the tubular void fill tube can include a variety of different regions, with sections similar to one or more of FIGS. 43A, 43B and/or 43C. Of course, in other embodiments, other forms of overlapping and/or contact can be achieved.

As also further depicted in FIGS. 43A-43C, in the preferred embodiments, during the formation of the expanded tubular void fill tube, the expanded paper is caused to rotate, such as, e.g., in the direction of the arrows shown in the respective figures. As described herein, in the preferred embodiments, this rotation, thus, enhances the contact pressure between the above-noted portions of the void fill tube such as to further enhance the formation of the void fill tube and the tendency for the open cells to interlock and the expanded slit sheet paper to, thus, retain its expanded state.

Although FIGS. 43A-43C show embodiments in which a substantially tubular shape is created in which opposite ends in a traverse direction contact one another, in other embodiments, although less preferred in many instances, such a configuration is not required to be created. For example, in some embodiments, rather than employing a center pull of the paper, or by controlling the rotation in a manner to avoid rotation through the outlet, the outlet can be adapted to provide another form of contact between the cells of the expanded slit sheet paper. For example, as shown in FIG. 43D, in some embodiments, the outlet can cause the slit sheet paper to overlap in another manner (such as, e.g., by one or more portion folding back as shown in FIG. 43D) such that upon expansion the cells interlock. However, without rotation, such an embodiment is less desirable. For example, as shown in FIG. 43E, where rotation is imparted, even if an overlapping similar to that shown in FIG. 43D is provided, the product will have a tendency to further rotate to cause further contact and interlocking, such as, e.g., illustrated by the dashed lines in FIG. 43E which represent the expanded slit sheet paper being twisted in a manner to bring opposite ends into contact with one another.

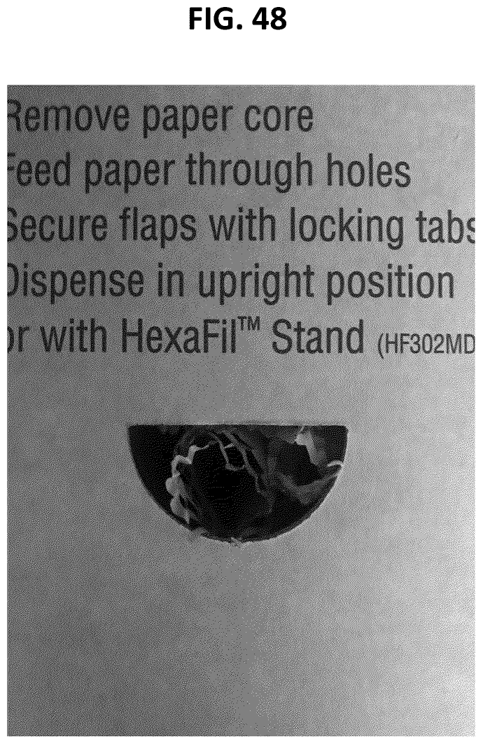

For further reference, FIGS. 48-52 show an illustrative embodiment of a manually operated cardboard box dispensing system in which a roll of slit sheet expandable paper is retained within a cardboard box that is substantially similar to the device shown in, e.g., FIG. 22, but employing a different flap structure (e.g., in which the opening in FIGS. 48-52 is within a single top panel. In this illustrative embodiment, a substantially semi-circular shaped opening is employed.

Towards that end, FIG. 48 shows a top view of the dispensing device showing the dispensing opening and an end of the expandable slit sheet paper shown below the dispensing opening.

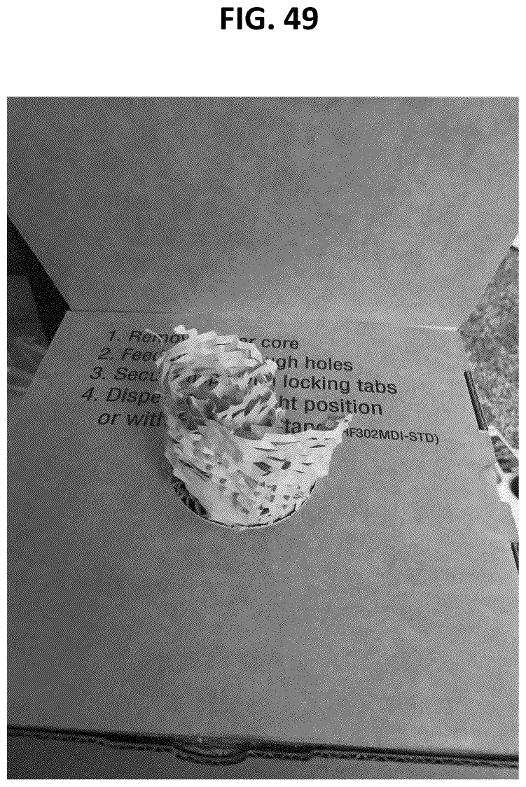

In use, a user can manually grasp the end of the expandable slit sheet paper and pull the paper upward through the opening. This pulling of the paper causes the paper to rotate in the manner described above, while concurrently engaging the edges of the semi-circular opening. As shown in FIG. 49, as the paper exits the opening, it begins to form a tubular void fill member having a spiraling configuration and in which the expanded cells begin to interlock as described above.

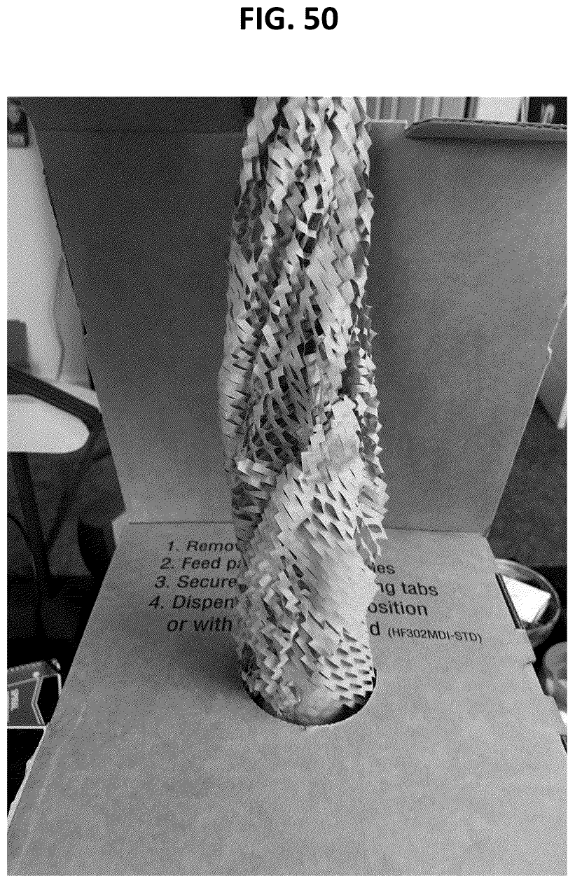

As shown in FIG. 50, during continued pulling of the tubular void fill tube, the expanded void fill tube continues to substantially maintain its configuration, and to maintain a relatively consistent tubular form. And, as also shown, the tubular void filled tube also has a spiraling configuration as described above.

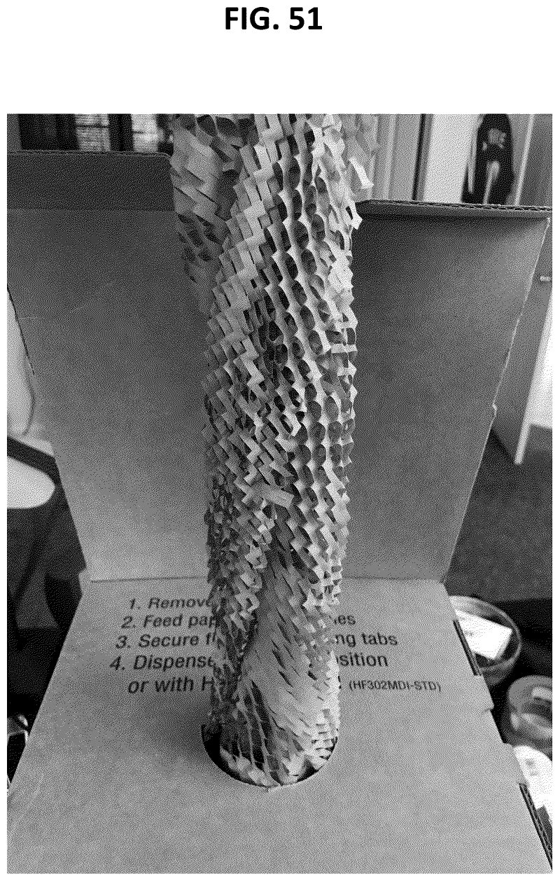

As further shown in FIG. 51, even after further pulling of the tubular void fill tube from the position shown in FIG. 50, the tubular shape continues to be formed.

In use, a user can readily manually grasp the tubular void fill tube with both hands and severe a desired length of the void fill tube. Then, the void fill tube can be placed within a box or package as void fill to protect an item and/or to otherwise product cushioning and/or protection.

In the preferred embodiments, the tubular void fill tube is readily manipulated by hand, such that a long length of tube can be removed and rolled, folded or otherwise manipulated to fill a desired space within a box or package or the like.

In the illustrative embodiment shown in FIGS. 48 to 52, the semi-circular outlet opening is substantially a half circle, with a diameter of about 2.4 inches. Accordingly, as the opening is a half-circle, the maximum width between the flat side of the opening and the peak of the arc is about 1.2 inches. In this illustrative example, the device, thus, creates a void fill tube having a diameter transverse to the longitudinal direction of the tube of about 2-3 inches (e.g., approximately 2.4 inches) as shown. In this illustrative embodiment, the slits of the slit sheet paper are about % inch slits, and the paper employed is an extensible paper. In this illustrative embodiment, the size of the tubular void fill is advantageous and convenient for many applications and uses of void fill.

In some other embodiments, a tubular void fill product can be created with difference diameters, such as, e.g., in some embodiments a diameter of even just about 1 inch or less, or in some embodiments, a diameter of about 1.5 inches or more, or in some embodiments, a diameter of about 2.0 inches or more, or in some embodiments, a diameter of about 3.0 inches or more, or in some embodiments, a diameter of about 4.0 inches or more, or even larger in some embodiments.

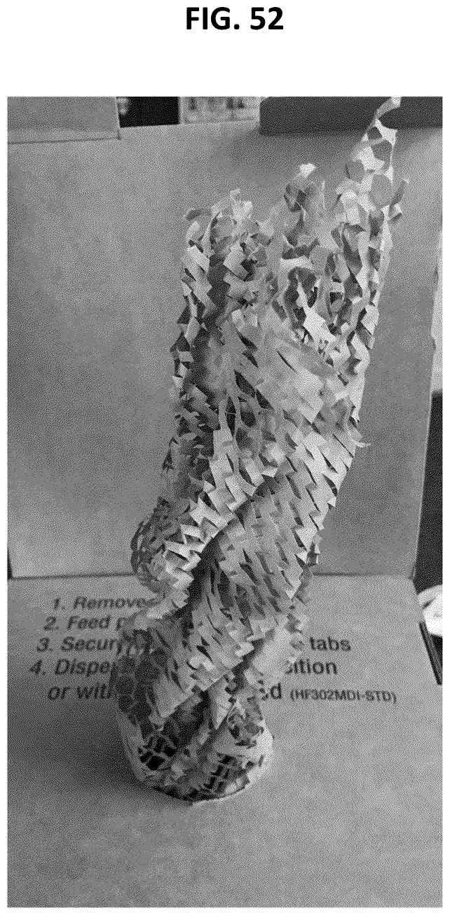

As illustrated in FIG. 52, the tubular void fill product is advantageously configured such that due to the interlocking of a sufficient % of opened cells, the tubular void fill member is inhibited from simply retracting after expansion and can retain a substantially expanded state to facilitate use and operation as a void fill product.

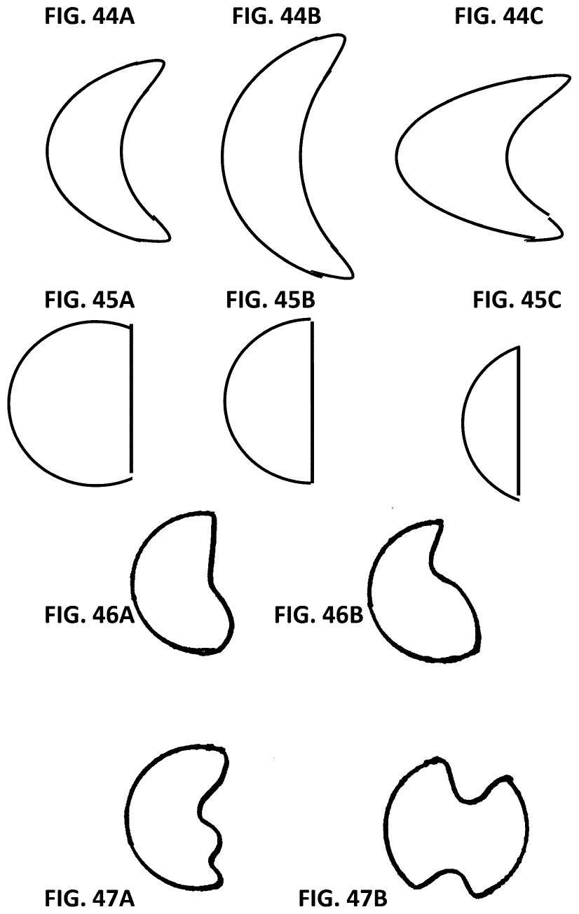

With reference to FIGS. 44A to 47B, a variety of illustrative outlet configurations are shown according to a plurality of alternate embodiments. It should be appreciated that some embodiments may have greater qualities for achieving purposes of the preferred embodiments herein. It should also be appreciated that these are merely some exemplary embodiments and that other constructions can be implemented in other embodiments.

In all of these illustrative embodiments, the outlet is configured to have a non-circular shape, but the outlet is configured to include a substantially arc or curve shaped outer wall that spans (extends around) at least about ⅓ or more, or preferably about ½ or more of the perimeter of the outlet. In some preferred embodiments, such as, e.g., the embodiment shown in FIG. 48, the arc shape portion spans or extends around about ⅗ or more of the perimeter of the outlet.

In some embodiments, the arc or curved portion is substantially circular (i.e., having a substantially constant curvature). However, in some other embodiments, the curvature does not need to be substantially circular or constant. By way of example, FIGS. 44A, 44B and 44C show illustrative embodiments employing various degrees of curvature of a crescent type shape or smile-face type shape according to some illustrative embodiments.

For reference, FIGS. 45A, 45B and 45C show other illustrative embodiments in which FIG. 45B depicts a substantially semi-circular configuration, while FIG. 45A shows a configuration similar to FIG. 45B in which a fuller or larger portion of a circle is created, while FIG. 45C shows a configuration in which a smaller portion of a circle is created. As described in illustrative embodiments discussed above, in some embodiments, a single outlet can have a movable member that can vary the positioning of the flat or straight side of this type of outlet to adjust to outlet configuration between these configurations shown in FIGS. 45A, 45B and 45C, etc.

While some preferred embodiments have been described herein in which the outlet opening is semi-circle shaped or crescent shaped or smile-shaped, in some other embodiments, other shapes of the outlet can be provided. In the preferred embodiments, however, the shapes of the outlets are preferably provided in a manner to achieve advantages and qualities of embodiments described herein.

For example, FIGS. 46A and 46B show some other illustrative embodiments in which the outlet includes an arc shaped section that spans about ½ or more of the perimeter of the outlet. However, in these illustrative embodiments, the remaining portion has a different configuration from that of the semi-circle type or crescent type configuration. In the preferred embodiments, the remaining portion is not configured in a manner that will snag or otherwise substantially interfere with the rotation or twisting of the tubular void fill tube as it passes through the opening. Accordingly, as shown in FIGS. 46A and 46B, in some embodiments, the remaining portions preferably include smooth and gradual curvatures.

As some other examples, FIG. 47A shows an example that is similar to that shown in FIGS. 46A and 46B, but with the remaining portion having a more varied configuration, and FIG. 47B shows an example in which the outlet has a plurality of arc-shaped portions, with a first arc shaped portion shown at the left side of FIG. 47B and a second arc-shaped portion shown at the right side of FIG. 47B.

In the preferred embodiments, the arc-shaped portions shown in the various embodiments are preferably provided to enable the expandable slit sheet paper to relatively freely flow and rotate to assume a tubular void fill tube form as described above. Accordingly, it should be appreciated that while an exact circular arc or an arc having a constant curvature may not be required in various embodiments, the arc-shaped portions should be curved in relation to the interior of the outlet, whereby the arc-shaped portion presents a smooth surface that does not substantially impede rotation of the tubular void fill tube as it is expanded and passes through the outlet opening.

Although the most preferred embodiments of the invention very advantageously dispense void fill from the center of a roll of expandable slit sheet paper that is wound into a roll without a central core or central support member such that the inner end of the roll of slit sheet paper can be grasped and laterally pulled from the interior of the roll, in some alternative embodiments, rather than dispensing the void fill from the center of the expandable slit sheet paper, a dispenser is employed that dispenses and expands the paper from the outer perimeter end of the expandable slit sheet paper.

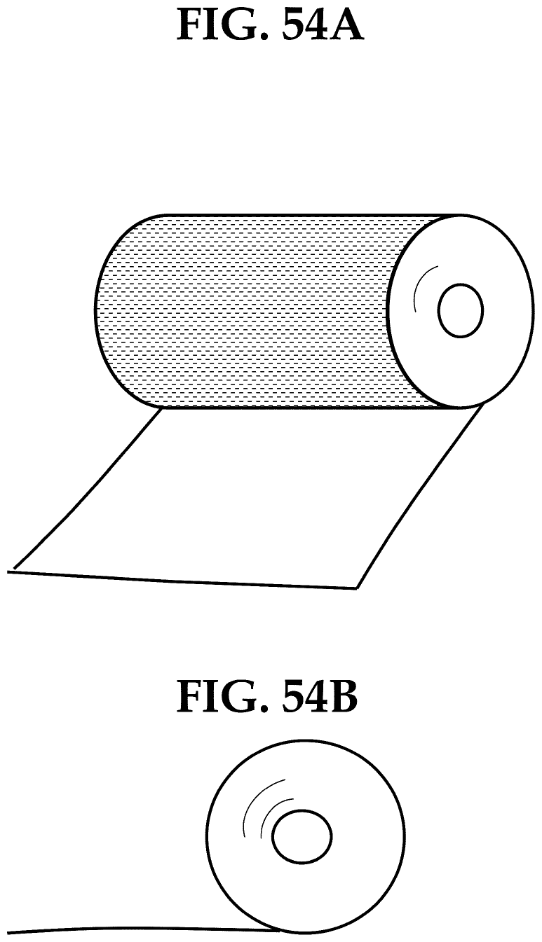

For example, FIG. 54A is a perspective view of a roll of slit sheet paper that is in a state of being unwound from an exterior end of the roll, and FIG. 54B is a side view of the roll of slit sheet paper from the right side of FIG. 54A. According to some alternative embodiments, a dispenser can be provided that supports a roll in a state similar to that shown in FIGS. 54A and 54B, such as, e.g., by supporting the roll on a device having an interior rod that extends through the roll. In this regard, structure similar to that of prior expansion systems and devices as incorporated herein by reference can be employed, as long as the structure enables the roll to be supported and the expandable paper to be fed from a perimeter end as show in, e.g., FIGS. 54A and 54B.

FIG. 55 is shows a perspective view of an illustrative alternative, less preferred, embodiment of a slit sheet paper void fill dispensing mechanism according to another alternative embodiment in which the slit sheet paper is fed in a machine direction into a contraction device. Towards that end, as shown in FIG. 55, the roll of slit sheet material (which starts as a roll similar to that shown in FIGS. 54A and 54B) is fed in the machine direction (shown by the large black arrow) into a contraction device 700E, which is configured in the shape of a funnel with a wider inlet opening that receives the expandable slit sheet paper and a smaller outlet opening 710E through which the expandable slit sheet paper is dispensed.

In the preferred embodiments, as the expandable slit sheet paper is fed through the contraction device, the expandable slit sheet paper is fed in such a manner that regions of the expandable slit sheet paper are caused to contact one another (e.g., at a plurality of locations transverse to the machine direction) such that upon expansion the expandable slit sheet paper has open cells that contact one another in a manner to inhibit retraction after expansion. As illustrated in FIG. 55, in the preferred embodiments, the expandable slit sheet material exiting the outlet of the contraction device preferably forms a generally elongated or tubular configuration 200E-VF in which the expandable slit sheet material has been expanded and a plurality of regions of the expandable slit sheet material along a direction transverse to the machine direction are in contact with one another such as to inhibit retraction of the generally elongated or tubular member.

In some most preferred implementations, the outlet 710E is arranged and configured in a manner such as to impart or facilitate a twisting motion such as to cause the expandable slit sheet paper to expand in a tubular form generally similar to some of the embodiments described herein above. By way of example, in some embodiments, the outlet 710E can be formed in a curved or arcuate manner, or in a spiral manner, such as to initiate a rotational motion as the expandable slit sheet material exits the outlet 710E. In the preferred embodiments, the outlet 710E is configured in such a manner as to enable the slit sheet paper to freely flow through the outlet without tearing, but at the same time to provide sufficient resistance to enable expansion of the expandable slit sheet paper as it is pulled through the outlet. As with other embodiments described herein, in some embodiments, a device similar to FIG. 55 can be a manual dispensing device. On the other hand, in some alternative embodiments, a device similar to FIG. 55 can be configured as an automated device in accordance with embodiments described herein. Moreover, in various embodiments, the outlet 710E could also be configured to have a shape that is similar or the same as that of other outlets described herein with respect to other embodiments of the invention described herein. Furthermore, in some other alternative variations of the embodiment shown in FIG. 55, in some alternative embodiments a mechanism can be provided upstream of the contraction device 700E or within the contraction device 700E that causes the expandable slit sheet paper to twist in a manner similar to that of other embodiments herein. For example, such a device that causes the expandable slit sheet to twist could include one or more guide surface and/or one or more rotating mechanism that imparts rotation to the expandable slit sheet material. However, it should also be appreciated that in some embodiments, such a twisting or rotational motion of the expandable slit sheet material would not be implemented or employed.

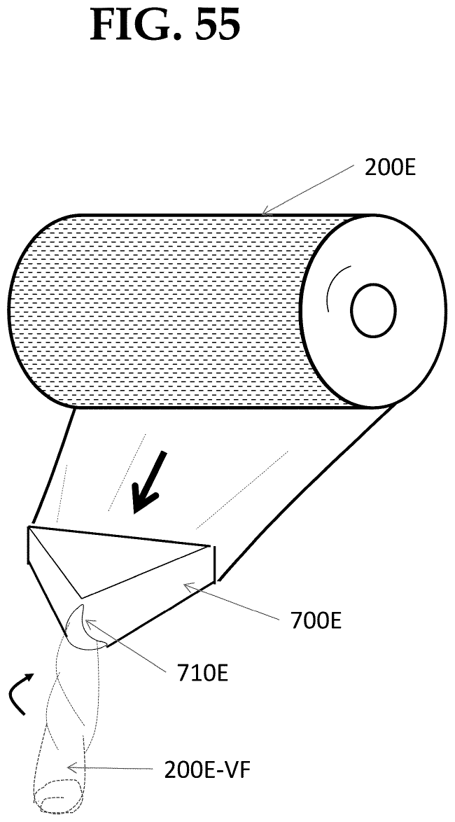

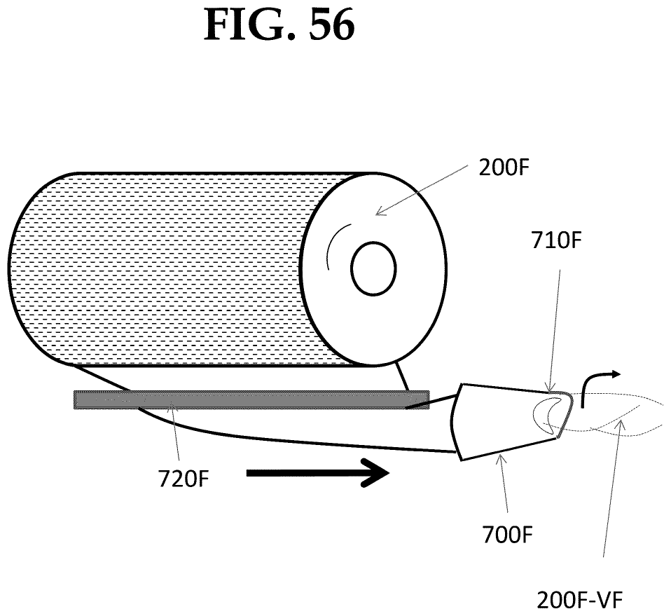

FIG. 56 is a perspective view of another alternative, less preferred, embodiment of a slit sheet paper void fill dispensing mechanism according to another alternative embodiment in which the slit sheet paper is fed laterally to the machine direction into a contraction device.

Towards that end, as shown in FIG. 56, the roll of slit sheet material (which starts as a roll similar to that shown in FIGS. 54A and 54B) is fed transverse to the machine direction (shown by the large black arrow) into a contraction device 700F, which is configured in the shape of a funnel with a wider inlet opening that receives the expandable slit sheet paper and a smaller outlet opening 710f through which the expandable slit sheet paper is dispensed. In some embodiments, in order to facilitate laterally directing the expandable slit sheet material, one or more guide rod 720F can be provided to facilitate guiding of the slit sheet material towards the contraction device 700F, and can facilitate guidance, for example, of the expandable slit sheet paper in a manner that the paper does not prematurely separate from the exterior of the roll 200F.

In some preferred embodiments, as the expandable slit sheet paper is fed through the contraction device, the expandable slit sheet paper is fed in such a manner that regions of the expandable slit sheet paper are caused to contact one another (e.g., at a plurality of locations transverse to the machine direction) such that upon expansion the expandable slit sheet paper has open cells that contact one another in a manner to inhibit retraction after expansion. As illustrated in FIG. 56, in the preferred embodiments, the expandable slit sheet material exiting the outlet of the contraction device preferably forms a generally elongated or tubular configuration 200F-VF in which the expandable slit sheet material has been expanded and a plurality of regions of the expandable slit sheet material along a direction transverse to the machine direction are in contact with one another such as to inhibit retraction of the generally elongated or tubular member.

In the preferred embodiments, as the expandable slit sheet paper is fed through the contraction device, the expandable slit sheet paper is fed in such a manner that regions of the expandable slit sheet paper are caused to contact one another (e.g., at a plurality of locations transverse to the machine direction) such that upon expansion the expandable slit sheet paper has open cells that contact one another in a manner to inhibit retraction after expansion. In some most preferred implementations, the outlet 710F is arranged and configured in a manner such as to impart or facilitate a twisting motion such as to cause the expandable slit sheet paper to expand in a tubular form generally similar to some of the embodiments described herein above. By way of example, in some embodiments, the outlet 710F can be formed in a curved or arcuate manner, or in a spiral manner, such as to initiate a rotational motion as the expandable slit sheet material exits the outlet 710F. In the preferred embodiments, the outlet 710F is configured in such a manner as to enable the slit sheet paper to freely flow through the outlet without tearing, but at the same time to provide sufficient resistance to enable expansion of the expandable slit sheet paper as it is pulled through the outlet. As with other embodiments described herein, in some embodiments, a device similar to FIG. 56 can be a manual dispensing device. On the other hand, in some alternative embodiments, a device similar to FIG. 56 can be configured as an automated device in accordance with embodiments described herein. Moreover, in various embodiments, the outlet 710F could also be configured to have a shape that is similar or the same as that of other outlets described herein with respect to other embodiments of the invention described herein. Furthermore, in some other alternative variations of the embodiment shown in FIG. 56, in some alternative embodiments a mechanism can be provided upstream of the contraction device 700F or within the contraction device 700F that causes the expandable slit sheet paper to twist in a manner similar to that of other embodiments herein. For example, such a device that causes the expandable slit sheet to twist could include one or more guide surface and/or one or more rotating mechanism that imparts rotation to the expandable slit sheet material. However, it should also be appreciated that in some embodiments, such a twisting or rotational motion of the expandable slit sheet material would not be implemented or employed.

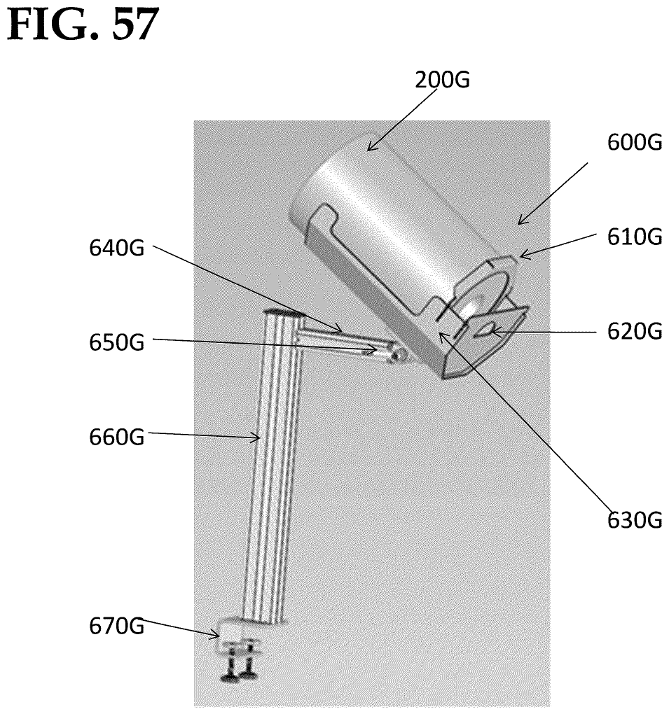

FIG. 57 is a perspective view of another alternative dispenser 600G according to some illustrative embodiments of the invention. In the preferred embodiment, the dispenser shown in FIG. 57 is made of metal or another rigid material.

As shown in FIG. 57, the dispenser 600G includes a support 630G that supports a roll of slit sheet material 200G. In this illustrative embodiment, the support 630G includes a retaining member 610G that holds the roll 200G at a separation distance from the outlet 620G formed in a lower plate member. As with other embodiments described herein-above, in operation, the expandable slit sheet material would be pulled from a center of the roll and extended through the outlet for dispensing. Although the outlet 620G could have a variety of configurations (e.g., any of the configurations described herein), in this illustrative example, the outlet 620G has a semi-circular configuration.

In operation, this illustrative dispenser 600G can be attached to a table or other support surface using an adjustable table mounting device 670G (e.g., employing one or more screw adjustment members as shown to press and hold to a side of a table). Alternatively, other attachments and/or supporting bases and/or the like can be employed. In this illustrative embodiment, the dispenser 600G includes a generally upright support beam 660G, and a laterally extending support arm 640G. In some embodiments, and adjustment mechanism 650G can be provided to adjust the tilting angle of the support 630G and/or to adjust the elevation of the arm 640G along the beam 660G.

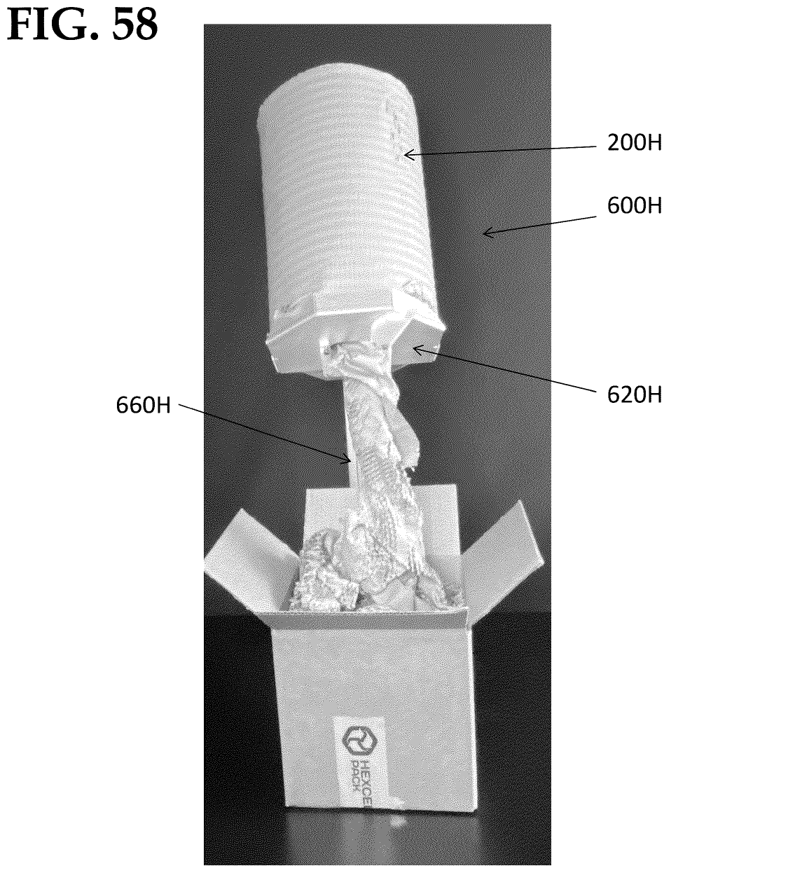

FIG. 58 is a front view of another alternative dispenser 600H according to some other illustrative embodiments, which is similar to that shown in FIG. 57. In the preferred embodiment, the dispenser shown in FIG. 58 is made of metal or another rigid material.

As shown in FIG. 58, the dispenser 600H includes a support that supports a roll of slit sheet material 200G. In this illustrative embodiment, the outlet 620H is configured similar to the outlet shown in FIGS. 39 and 40. Although FIG. 58 shows the outlet in an open state similar to that shown in FIG. 39, upon closing of the outlet to a condition similar to that shown in FIG. 40, the outlet would have a crescent shape opening in this example similar to opening 605D shown in FIG. 40. Alternatively, the outlet 620H can be modified to have any of the various configurations described herein.

In the example shown in FIG. 58, the dispenser can be conveniently located proximate a container or box within which the void fill is intended to be inserted. In this example, the dispenser is attached to a table and supported via the beam 660H, and a container or box is placed in front of the dispenser so that a user can fill the container or box with void fill as desired. In this manner, a user can readily manually feed the void fill tube into the container or box and then can manually tear the void fill tube once the container or box is sufficiently filled. Thereafter, a new container or box can be placed at the same location and the void fill filling cycle repeated.

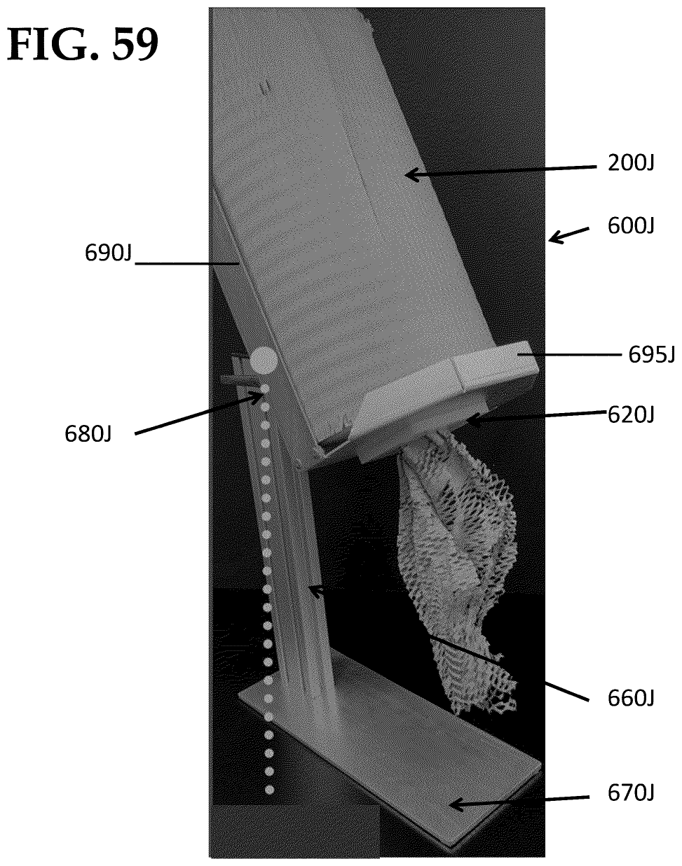

FIG. 59 is a perspective view of another alternative dispenser 600J according to some other illustrative embodiments, which is similar to that shown in FIGS. 57 and 58. In the preferred embodiment, the dispenser shown in FIG. 59 is similarly made of metal or another rigid material.

As shown in FIG. 59, the dispenser 600J includes a support that supports a roll of slit sheet material 200J. In this illustrative embodiment, the outlet 620J is configured similar to the outlet shown in FIG. 41. Towards that end, in some illustrative embodiments, the outlet 620J is crescent shaped. Moreover, in this illustrative embodiment, the outlet 620J is constructed as a plastic insert or donut member. Towards that end, in some preferred implementations metal dispenser systems, the outlet is advantageously made with a plastic to facilitate providing a sufficient smoothness so that the expandable slit sheet material can properly flow through the outlet without being prematurely severed due to sharp or jagged edges. Alternatively, the outlet 620H can be modified to have any of the various configurations described herein.

In the example shown in FIG. 59, the dispenser can be conveniently located proximate a container or box in a similar manner to that shown with respect to FIG. 58. In this example, the dispenser is supported on a table via a widened base 670J that in turn supports the supporting beam 660J. Additionally, in the preferred implementation an adjustment mechanism 680J is also included that enables the support to raise and/or lower the dispensing height of the dispenser along the beam 660J.

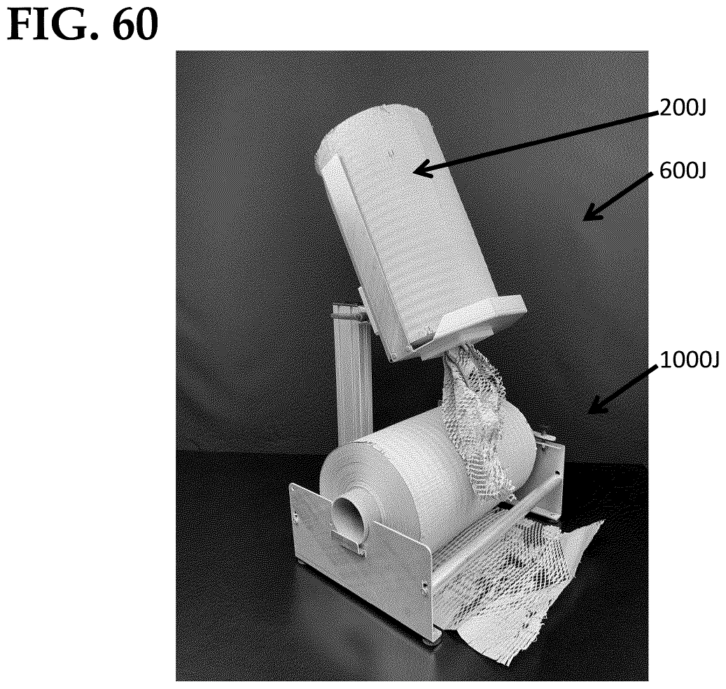

With reference to FIG. 60, FIG. 60 shows an advantageous combination system in which a dispenser 600J similar to that shown in FIG. 59 is placed proximate an expansion device 1000J that is used to wrap items by, e.g., placing an item on the expanded sheet pulled from the expansion device 1000J and then wrap the item. In this manner, as shown, a compact system can be provided whereby a user has both of these synergistic devices proximate the user (e.g., as shown, in preferred instances, the devices can be aligned such that the feed of the void fill tube of the dispenser 600J is aligned and extends over the feed of the flat expanded sheet of the expansion device 1000J.

Thus, in use, a user can obtain a container or box, the user can then wrap one or more items with the expansion device 1000J and can place the wrapped item in the container or box. Then, the user can use the dispenser 600J to dispense void fill and fill the remaining space in the box as desired. Notably, in this advantageous combination system, the expanded cells of the void fill can also conveniently interlock with the expanded cells of the sheet that is wrapped around the item(s) with the expansion device 1000J achieving a highly effective packaging.

It should be appreciated that all of the dispensers described herein can be similarly advantageously employed in a synergistic combination usage with expansion devices used for wrapping in various embodiments. Moreover, it should also be appreciated that various embodiments herein can be employed with any existing expansion devices for wrapping as are known in the art, including any and all of the devices described herein and/or in any of the patents incorporated herein by reference.

Moreover, although this illustrative and advantageous use of some void fill dispensers according to illustrative embodiments of the invention is described, it should be appreciated that the void fill dispensing systems and devices herein can be used in a variety of methods, a variety of applications, and in a variety of manners of use.

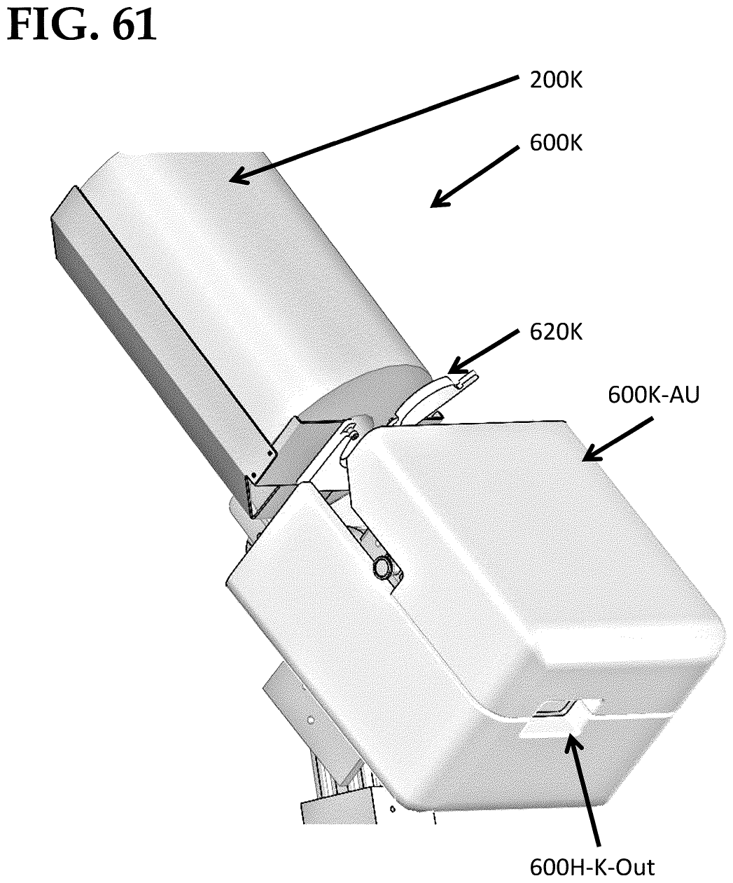

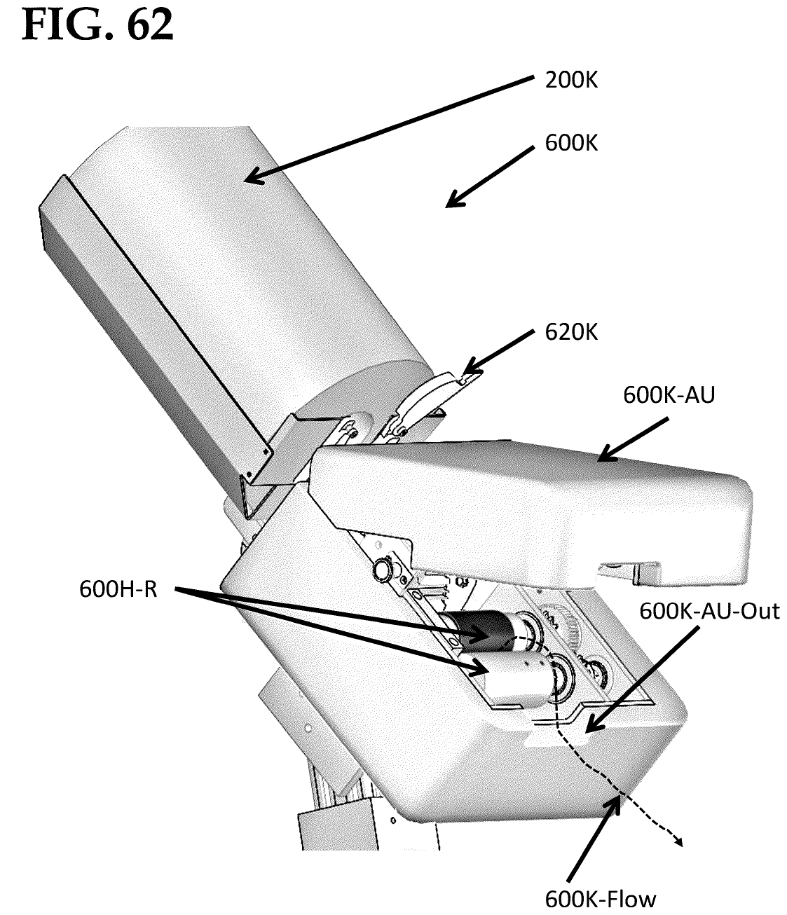

FIGS. 61 to 62 are perspective views of another alternative dispenser 600K according to some further illustrative embodiments. Here, this embodiment is similar to the embodiment shown in FIG. 58, with additional mechanisms to impart automated dispensing. In the preferred embodiment, the dispenser shown in FIGS. 60 to 61 is made of metal or another rigid material.

As shown in FIG. 61, the dispenser 600K includes a support that supports a roll of slit sheet material 200K. In this illustrative embodiment, the outlet 620K is configured similar to the outlet shown in FIGS. 39 and 40. Although FIG. 61 shows the outlet in an open state similar to that shown in FIG. 39, upon closing of the outlet to a condition similar to that shown in FIG. 40, the outlet would have a crescent shape opening in this example similar to opening 605D shown in FIG. 40. Alternatively, the outlet 620K can be modified to have any of the various configurations described herein.

In the example shown in FIG. 61, the dispenser can be conveniently located proximate a container or box within which the void fill is intended to be inserted. In this example, the dispenser can be, e.g., attached to a table and supported via the beam, and a container or box can be, e.g., placed in front of the dispenser so that a user can fill the container or box with void fill as desired. In this manner, a user can readily place the void fill tube into the container or box and then can manually tear the void fill tube once the container or box is sufficiently filled. Thereafter, a new container or box can be placed at the same location and the void fill filling cycle repeated.

In contrast to the embodiment shown in FIG. 58, the device shown in FIGS. 61 to 62 include an automated compartment 600K-AU that contains an electric motor (not shown) and a plurality of drive rollers 600H-R as shown to help drive or pull the expandable slit sheet material through the outlet 620K and to effect expansion of the cells as described herein. In operation, the expanded sheet would follow the flow path shown by the dashed line arrow in FIG. 61 and be dispensed via the outlet 600K-AU-Out. In some illustrative embodiments, the rollers 600H-R can include a hook roller similar to that described above that is configured to engage with the slits of the expandable slit sheet paper in order to grab the sheet and effect expansion as described herein.

In use, an operator would lift the lid of the automated compartment as shown in FIG. 61, and would feed the expandable slit sheet paper through the outlet 620K and into a rear opening of the automated compartment (not shown) and then between the rollers 600H-R and through the path 600K-Flow. Then, the user would close the lid and the system could then operated by the user employing the automated expansion of the expandable slit sheet paper. In some preferred embodiments, the system can include a switch or pedal via which a user can turn on and off the system to start and stop the process of expansion. In that manner, the user can use the automated system to dispense the void fill to an extent as desired. In some alternative embodiments, the system could be computer controlled such that a computer processor is configured to drive the system and expand the paper at a rate determined by programming of the computer.

FIGS. 63 to 66 show another illustrative embodiment which pertains to a non-automated dispenser made of, e.g., recyclable material such as, e.g., cardboard or paper or the like. In particular, FIGS. 63 to 66 depict a novel dispenser support 100L-S that can be provided to support a dispenser 100L as shown. Although the support 100L-S is shown as supporting a dispenser 100L, it should be appreciated that a similar support could be employed to support various other dispensers described herein, and, especially, various dispensers described herein formed of recyclable material and/or formed in a substantially box-shape configuration.

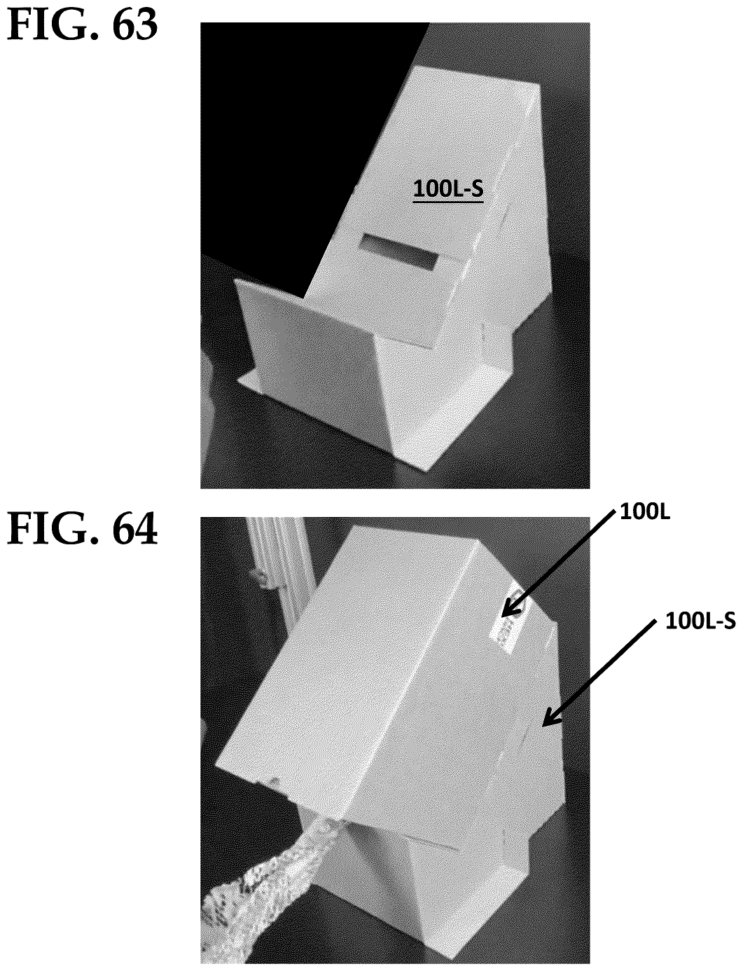

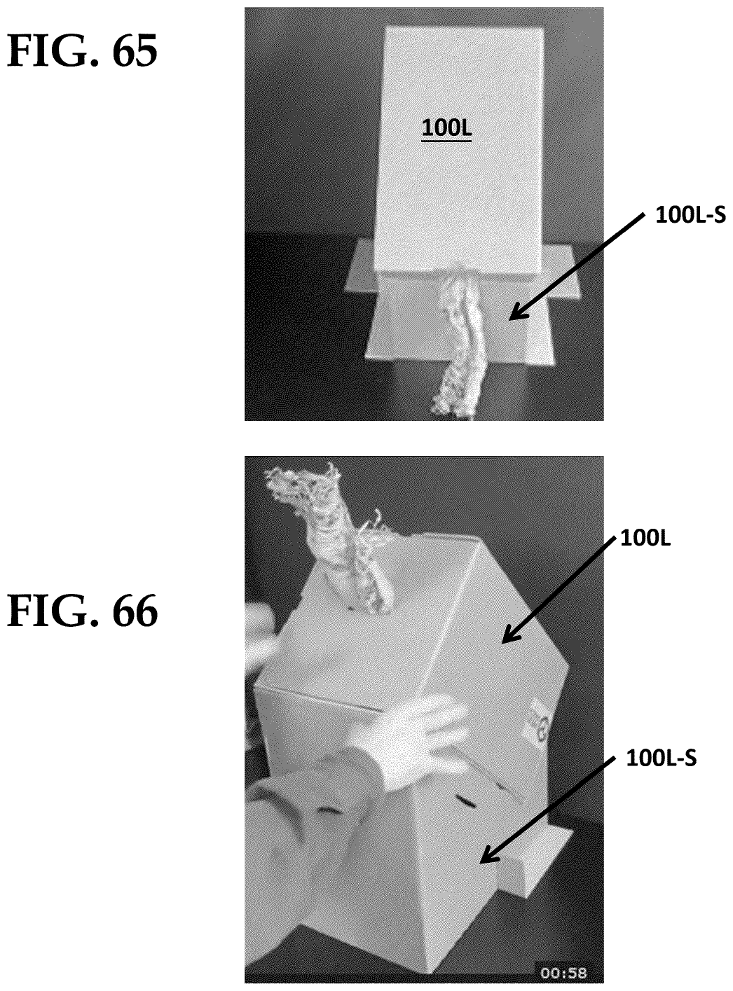

In the preferred embodiment, the support 100L-S is made of recyclable material, and, most preferably, cardboard as shown. In the preferred embodiment, the support 100L-S provides a substantially L-shaped upper support surface as best seen in FIG. 63, which is inclined at an angle as shown. In this manner, the support 100L-S preferably is configured to alternatively support the dispenser 100L in either an inverted dispensing position (such as, e.g., shown in FIGS. 64 and 65) or in an upward dispensing position (such as, e.g., shown in FIG. 66). In this manner, the support 100L-S can advantageously enable users to adjust their work space as desired based on circumstances.

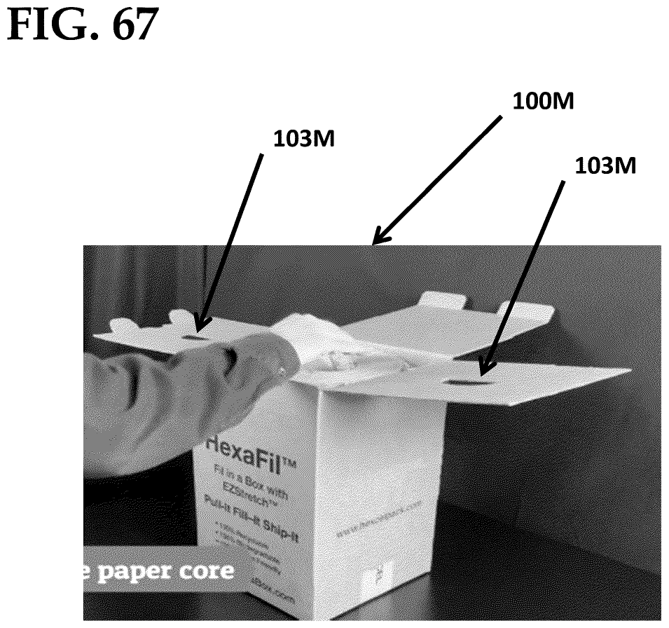

FIG. 67 shows another illustrative embodiment which also pertains to a non-automated dispenser 100M made of, e.g., recyclable material such as, e.g., cardboard or paper or the like. In particular, the embodiment shown in FIG. 67 is similar to the embodiments shown in FIGS. 34-37 and 48-52 which include a semi-circular opening. However, the embodiment shown in FIG. 67 depicts another advantageous panel structure according to some alternative embodiments. In particular, as shown in FIG. 67, in some illustrative embodiments, rather than having the outlet of the dispenser 100M formed within a thickness of a single panel, the embodiment shown in FIG. 67 employs multiple panels each having an corresponding outlet 103M, which outlets are aligned to form a single common outlet opening having two layers of panels upon one another. In this manner, the thickness of the container or box at the outlet(s) 103M can be twice that of a single panel. Among other things, this can help to enhance the strength and rigidity during operation, and can also present a larger friction surface to facilitate applying sufficient friction to desirably achieve smooth and reliable expansion of the expandable slit sheet paper as it is pulled through the outlet(s) 103M. In the illustrative embodiment shown in FIG. 67, in use, the operator can manually grasp the inner end of the roll of slit sheet material (as shown), then the operator can rotate the panel shown at the right side of the figure so as to be placed over the roll within the box, while threading the paper through the outlet 103M of that panel, and then the user can fold the panel shown at the left side of the figure so as to be placed over the first panel while threading the paper through the outlet 103 of that second panel. Then, the user can extend the tabs shown at the left side of the second panel in FIG. 67 within two respective slots formed proximate the hinge of the first panel, such as to retain the panels in alignment such with the expandable slit sheet material extending through the aligned outlet 103M.

Although FIG. 67 shows a semi-circle shaped outlet, it should be appreciated that other embodiments can employ any other outlet configuration as described herein.

In some embodiments that employ recyclable cardboard or corrugated board materials such as, e.g., shown in various embodiments described herein-above, in some cardboard box configurations, the outlet is formed in a substantially semi-circular configuration as shown. In such embodiments, the arc of the semi-circle does not have to be of constant radius of curvature, but can be varied in alternative embodiments. In cardboard embodiments, having a structure of a configuration which includes a straight side of the outlet can help create a stronger outlet rigidity. For example, if a crescent shape is employed or another shape in which a portion of the perimeter of the outlet extends inward, such inwardly extending portion could be subject to bending forces. Accordingly, some preferred recyclable box constructions include such a semi-circular configuration as shown in some illustrative embodiments. However, other embodiments can employ other configurations of outlets as described herein, such as, e.g., crescent shape, etc.

In some embodiments that employ metal or other rigid material dispensers (e.g., non-recyclable rigid materials), the outlet can be formed of plastic or polymeric materials in some embodiments. For example, as shown in FIGS. 41, 59 and 60, in some embodiments employing metal dispensers, a plastic outlet can be provided. Among other things, a plastic outlet can advantageously avoid sharp edges that often occur when cutting holes within metal panels. In some preferred embodiments, the outlet openings in such plastic outlets can be formed in a crescent shape or in a smile-shape or lune-shape. In particular, by forming the outlet in a manner such that rather than having a straight edge (as with a semi-circle), the edge curves or extends inward to some extent, the friction applied by such an edge can be increased. Accordingly, which a plastic or polymeric outlet is provided, due to the smooth nature of the plastic or polymeric edge of the outlet, the inward extension can help to achieve a desirable degree of friction to ensure smooth expansion of the void fill. Moreover, in such embodiments, because the outlet can be made with a strong plastic or polymeric material, the strength of the outlet can be maintained without concern. Nevertheless, in various other embodiments, the shape of the outlet in a metal or other rigid material dispenser can be similar to any of the outlet configurations described herein. By way of example, FIG. 57 shows an illustrative metal or other rigid material dispenser having a semi-circular outlet, and other figures herein show various other outlet configurations in other metal or rigid material dispensers (see, e.g., FIGS. 7, 14 and 27).

In some embodiments of the invention, in order to facilitate feeding of the expandable slit sheet material from the center of the roll of slit sheet material, a mechanism is advantageously provided to help maintain the position of the roll of slit sheet material within the support. For example, in the embodiment shown in FIG. 59 (by way of one illustrative example), the edges 690J can be arranged to apply pressure on the side of the roll 200J supported thereon. Similarly, the edges 695J can be arranged to apply pressure on the side of the roll 200J supported thereon.

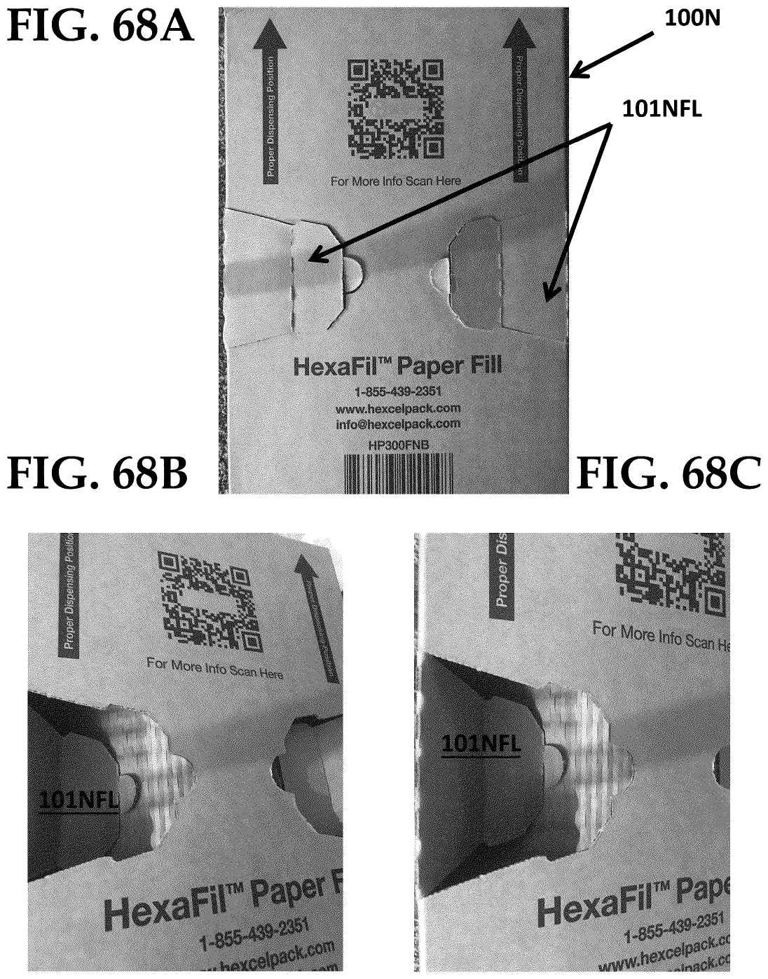

As another example, in embodiments that employ a dispenser box for supporting the roll of expandable paper, which box is made with recyclable cardboard or corrugated board materials, the box can be adapted to have one or more panel or member that applies a supporting pressure against the roll during use. In some embodiments, such a panel or member can be an additional member or insert that is located inside the box to facilitate placement of the roll within the box. In some embodiments, as shown in FIGS. 68A to 68C, one or more outer wall of the box (such as, e.g., one or more of the walls of the box that is perpendicular to the wall of the box having the outlet) can include one or more tab members 101NFL that can be pressed inward from a shipping position as shown in FIG. 68A in which the tab members 101NFL are co-aligned with the outer wall of the box to a roll-contacting position as shown in FIGS. 68B and 68C. Towards that end, in the preferred embodiments, as shown, the tab members 101NFL can include perforations around 3 sides thereof, such that during shipment the tab members can serve as part of the exterior walls, but upon assembly and usage, the tab members can be pressed inwards, thus tearing the perforations, and the tab members 101NFL can be pressed inwards such as to support the perimeter of the roll as shown.

Among other things, these supporting members can help to retain the positioning of the roll with respect to the respective support, and can also help to prevent the roll from rotating within the support.

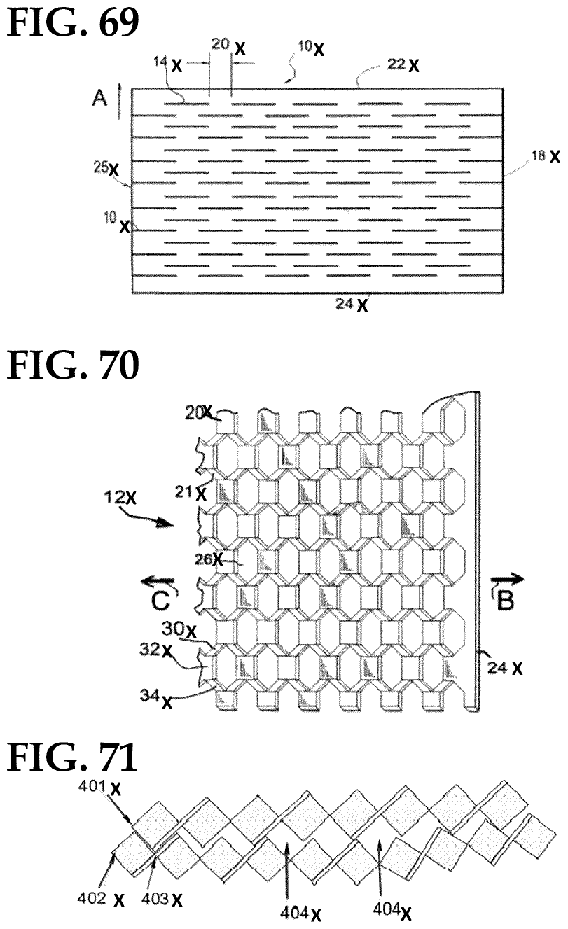

For reference, FIGS. 69-73 describe illustrative expansion of expandable slit sheet paper in some embodiments, as well as the potential for interlocking between adjacent layers of expanded slit sheet paper in some circumstances. In this regard, FIGS. 69 and 70 correspond to FIGS. 1 and 3 of U.S. Pat. No. 5,667,871 (the '871 patent) incorporated herein by reference above. These figures describe existing “slit sheet” expandable paper structure. As explained in the '871 patent:

“The slit paper, indicated generally as 10[x], is illustrated in FIG. [69] as it would come off the slitting machine. The sheets can be formed on a flat-bed slitter and produced directly as rectangular sheets, as well as on a rotary slitter and cut into individual sheets or stored directly as a continuous sheet in roll form. The flexible sheet 10[x] is preferably manufactured from exclusively recycled paper with the grain of the paper running in the direction of arrow A. The flexible sheet 10[x] is provided with slits 14[x] and slits 16[x] are parallel to the edges 22[x] and 24[x] of the flexible sheet 12[x] and perpendicular to the paper grain. The slits 14[x] and slits 16[x] are placed in rows and separated from one another by land 20[x] and legs 21[x][shown in FIG. 70]. The land 20[x] is a consistent size and provides the support required to prevent the paper from tearing into strips when opened. The cushioning effect is produced by the flexing of the lands and legs under a load. It is therefore necessary that the land 20[x] be of sufficient size to provide cushioning. The spacing between the rows of slits 14[x] and slits 16[x] must also be of sufficient size to prevent the paper from tearing. The offset positioning of the rows of slits 14[x] and slits 16[x] gives the paper resiliency when opened . . . .”

“When expanded, the expanded sheet, indicated generally as 12[x], is formed of hexagonal cells 26[x], legs 21[x] and land 20[x] areas, as illustrated in [FIG. 70]. [When in a planar state, in some embodiments], at least a majority of the land 20[x] areas lie in a plurality of parallel planes. The planes of the land 20[x] areas form an angle of at least about 45[x] degrees with the plane of the sheet in flat form.”

FIG. 71 is cross-sectional side view showing two expanded sheets layered against one another for explanatory purposes. In particular, this figure illustrates how adjacent expanded cells can interlock under some conditions. Notably, when the layers are flat or substantially flat as shown in FIG. 71, interlocking is more readily achieved. When the layers are highly curved or folded, interlocking can be reduced or eliminated. In the preferred embodiments of the invention, when a void fill tube is created, layers can be curved with respect to one another. However, with preferred embodiments described herein, in most preferred examples, interlocking between a sufficient number of expanded cells between adjacent layers can be achieved in order to inhibit or limit retraction in some embodiments.

As shown in FIG. 71, the figure shows a side view of two expanded layers 401x and 402x, having regions 403x where side walls of adjacent layer contact each other and nest and interlock. In this illustrative example, nesting is shown at a lower extent than may occur in conditions in which cells in adjacent layers are evenly expanded and laid upon one another. However, FIG. 71 helps to illustrate that even with variation in expansion or unevenness between layers, nesting and interlocking can occur as shown.

For further reference, FIG. 72 shows an illustrative expandable slit sheet paper in an expanded state, showing open cells 26Y (which are substantially hexagonal) and land portions 20Y and leg portions 21Y. As shown, the land portions have upper ends HSY and lower ends LSY. During interlocking and/or nesting, these upper ends and lower ends can contact and interlock or nest with upper ends and lower ends in layers above and/or below.

For further reference, FIG. 73 shows another expandable slit sheet paper in an expanded state. As with the examples shown in FIGS. 69-72, in some embodiments an expandable slit sheet paper can be employed that is expandable into a state similar to that shown in FIG. 73, and, similarly to the above discussion, adjacent layers of expanded slit sheet paper shown in FIG. 73 can interlock and nest. In some embodiments, the expandable slit sheet paper can expand similarly to any of the expandable slit sheet papers disclosed in the present inventor's co-pending U.S. application Ser. No. 16,929,843 filed on Jan. 6, 2021, the entire disclosure of which is incorporated herein by reference.

### Extensible Paper Employed in Preferred Embodiments

As described herein above, in the most preferred embodiments, the slit sheet paper is made with an extensible paper. In some most preferred embodiments, extensible papers as set forth in the present inventor's above-referenced U.S. Pat. No. 10,669,086 are employed, the entire disclosure of which is incorporated herein by reference.

According to some embodiments, the extensible paper is extensible in a machine direction in a range of at least 5%. According to some embodiments, the extensible paper is extensible in a cross direction in a range of at least 5%. According to some embodiments, the extensible paper is extensible in a machine direction in a range of at least 5% and in a cross direction in a range of at least 5%. According to some embodiments, the extensible paper is extensible in a machine direction in a range of at least 6% and in a cross direction in a range of at least 6%. According to some embodiments, the extensible paper is extensible in a machine direction in a range of at least 7% and in a cross direction in a range of at least 7%. According to some, most preferred, embodiments, the extensible paper is extensible in a machine direction in a range of at least 8% and in a cross direction in a range of at least 8%. According to some embodiments, the extensible paper is extensible in a machine direction in a range of between 5% to 15% and in a cross direction in a range of between 5% to 15%. According to some embodiments, the extensible paper is extensible in a machine direction in a range of between 7% to 15% and in a cross direction in a range of between 7% to 15%.

According to some illustrative embodiments, the plurality of slits each have a width of between 0.35 and 0.65 inches; according to some embodiments, the plurality of slits each have a width of between 0.45 and 0.55 inches. According to some embodiments, the plurality of slits each have a width of about 0.5 inches. According to some embodiments, the plurality of slits each have a width of less than 0.5 inches. According to some embodiments, the plurality of slits each have a width of less than 0.45 inches. According to some embodiments, the plurality of slits each have a width of less than 0.4 inches.

As indicated above, in some most preferred embodiments, extensible papers as set forth in the above-referenced U.S. Pat. No. 10,669,086 are employed. Towards that end, the following paragraphs (in quotations) under this section are quoted from the '086 patent set forth details of extensible papers according to some preferred embodiments that can be employed in preferred embodiments of the present invention.

“For the purposes of the present invention, the term ‘extensible’ as applied to paper sheets, means a paper sheet that is able to stretch in a longitudinal direction of the paper sheet upon applying a force in the longitudinal direction of the paper sheet. Illustrative extensible sheets are disclosed in U.S. Pat. No. 3,908,071, U.S. patent application Ser. No. 14,901,977 (U.S. Pat. No. 9,945,077), International Application No. WO 1984002936, U.S. Publication Nos. 2002/0060034, 2007/0240841 (U.S. Pat. No. 7,918,966), and U.S. Pat. Nos. 3,104,197, 3,220,116, 3,266,972, 3,269,393, 3,908,071, 6,024,832, 6,458,447, and 6,712,930, the entire disclosures of which are incorporated by reference herein, as though recited in full. It should be understood that the stretching of an extensible paper must be measured in an unslit sheet of paper. As disclosed in U.S. Pat. No. 3,266,972, the test and characterization procedures employed in measuring elongation (extensibility) properties can be in accordance with standard TAPPI test Elongation T457. In addition, as disclosed in U.S. Pat. No. 3,266,972, the expression ‘extensible papers’ means a paper having an increasable elongation in the machine direction as compared to standard, non-extensible Kraft paper.”

“In some preferred embodiments, extensible paper can be produced by varying the accumulation of paper fibers by essentially slowing the paper feeding process during the drying method to trap extra fibers that make the paper appear to have microscopically sized rows of paper that you would see if one were to pleat the paper. The difference is that extensible paper's microscopic rows are adhered to each other through the use of binders and other types of adhesives in conjunction with the drying process. Reference is made to patent U.S. Application No. 2007/0240841 (U.S. Pat. No. 7,918,966) where the purpose is to create a non-creped extensible paper that does not easily disconnect from itself. In addition, the surface of the extensible paper is still fairly flat.”

“In the preferred embodiments of the present invention, the extensible paper that is employed has low extensible properties as compared to other types of extensible papers. In this regard, an optimal extensible paper enables a smooth transition from an unexpanded to the expanded slit sheet by providing a small amount of stretching at the very start of expansion of the extensible slit sheet paper material.”

“In some exemplary constructions, during expansion of a slit sheet, the force required to initiate expansion is substantially higher than the force required to continue expansion. For example, once the paper initially starts to bend at the slits, the expansion continues more easily during continued bending at the slits. The force required to continue the expansion of the slit sheet during this continued bending is dramatically reduced beyond the above-noted initial expansion. In some preferred embodiments, the extensible slit sheet paper substantially reduces the force required to initiate expansion. On the other hand, in some preferred embodiments, during the above-noted continued expansion, the extensible paper does not substantially stretch simultaneously with the process of expanding the slit sheet paper; otherwise, the expanded sheet might not optimally be made into a cushioning wrap.”

“It should be noted that in this application, all theories related to functioning of the invention are provided to facilitate appreciation of concepts of the invention, rather than by way of limitation. Extensible paper, as designed, stretches as part of an increase in paper strength. In some embodiments, the functioning of the invention involves that the extensible slit sheet paper substantially utilizes the extensible property to ease the rotating the cells into the stretched shape and to resist tearing of the slit sheet during the expansion step. This means that at the initial point at which the cell rotates (i.e., initiating rotation between legs 38a and 38b on each side of the slit and land 20) the extensible slit sheet paper is substantially enhanced by the extensible paper's ability to stretch. In some embodiments, the functioning of the invention, thus, involves that extensible papers' properties are substantially utilized at this initial point and substantially finished as soon as the cell begins to rotate into its three dimensional shape (i.e., after this initial point, the reliance on the extensible nature of the paper may be less substantial or even non-existent). After that initial point, the slit pattern properties, regardless of paper type, opens with greater ease to the point at which it forms a hexagon. Accordingly, in some embodiments, the extensible property substantially merely comes into play at the initial moment of expansion. In some other embodiments, while the extensible features of the paper comes into play most substantially at this initial point of rotation, the extensible features of the paper can have some affect during further expansion of the paper, whereby the initial point of expansion can be substantially facilitated due to extensibility and further expansion can also be, at least, somewhat facilitated due to extensibility.”

“In some of the preferred embodiments, preferable extensible papers that can be employed include extensible papers where the purpose of the extensible nature is to provide the type of stretching found for the use of multi-wall bags for heavy weight items like cement, or seed and the like. U.S. Patent Publication No. 2016/0355985 (U.S. application Ser. No. 14,901,997) and U.S. Pat. Nos. 3,104,197 and 3,266,972 teach the manufacture and properties of this form of extensible paper. Further teachings can be found in “Understanding sheet extensibility”, R. S. Seth, Pulp & Paper Canada T31, 106:2 (2005) III, pages 33-40 (T31-T38). The disclosures of the foregoing patents, patent publication, and printed publication are incorporated herein by reference, as though recited in full.”

“The prior expanded slit sheet art (See, e.g., U.S. Pat. Nos. 5,538,778, 5,667,871, 5,688,578, and 5,782,735) focused on paper strength to inhibit tearing during the expansion process and Kraft paper was satisfactory because the strength required coincided with the thickness required to make a satisfactory wrapping product. The increased strength of an expandable sheet does not contribute to or increase the value/performance of the expansion of the slit sheet material. It has now been found by the present inventor that an expandable slit sheet paper can be substantially improved by the use of an extensible sheet. In the preferred embodiments, this use of an extensible slit sheet paper advantageously provides a reduction in force required to open the slit sheet and therefore provides a faster and easier expanding process for the user of the expanded slit sheet. The unexpected benefit resulting from the reduction in force at the very start of the expansion of the slit sheet provides an unexpected improvement to the slit sheet packaging product and renders the employment of the extensible paper highly unique. Notably, the prior expanded slit sheet paper persisted in and was widely used in the marketplace for decades without the contemplation of the present invention or the potential advantages therefrom.”

“As set forth in this application, the present inventor has discovered that the force needed to expand an expandable slit sheet paper is far greater than the force required to expand an extensible slit sheet paper. By way of example, a 50 pound Kraft paper expandable slit sheet that is 15″ wide prior to expansion requires approximately 4-6 pounds or 0.4 pounds per inch, whereas the force required to expand an extensible slit sheet of the same paper weight is 0.15-0.22 pounds per inch. This is a marked difference between the papers. Kraft paper has the strength to provide an acceptable expandable slit sheet. However, unexpectedly, the extensible slit sheet imparts an ease of expansion that greatly reduces the force required to expand the slit sheet, not based on the main purpose for extensible paper which is to increase its tensile strength but, rather, its capability to stretch. Since extensible paper is higher in cost and Kraft paper was strong enough, it was not previously known that extensible paper could be of benefit for making slit paper sheets of the types found in, e.g., U.S. Pat. Nos. 5,538,778, 5,667,871, 5,688,578, and 5,782,735, and U.S. Non-Provisional application Ser. No. 15/428,144. For example, it was not appreciated that an extensible slit sheet could have provided an equivalent strength to light weight, thin papers that previously had no applicability as a wrapping product. Light weight Kraft paper tears more easily than heavier weights of Kraft paper. It has now been found that the extensible paper enables the use of the lighter weight expanded slit-sheet papers that also advantageously provide gentler cushioning required by fragile items when a slit sheet is expanded, in contrast to the more rigid cushioning provided by heavier weight expanded slit-sheet papers.”

“Reference is particularly made to the graph of Table 1 on page 5 of U.S. Patent Publication No. 2016/0355985 (now U.S. Pat. No. 9,945,077) as if recited in full, that describes paper strength based on certain manufacturing techniques. Within the graph is a column describing elongation at the point of paper break (or tearing of fibers) separated into two sub columns of the machine direction (MD) and cross direction (CD), also referred to as transverse direction. The elongation percentage of Table 1 ranges from 5.3% to 7.1% in the cross direction (CD) and 3.3% to 10.6% in the machine direction (MD).”

“Reference is also made to U.S. Pat. No. 3,266,972 within Table III of column 5 which references elongation in the percentage range from 3.7% to 4.6% in the CD or cross direction and 9.7% to 11.1% in the machine direction.”

“In both '985 and '972, the variations are based on the manufacturing process that places an emphasis on tensile strength and stretch in either the cross direction or machine direction accordingly.”

“The present inventor has discovered that for the purposes of expanding an extensible slit sheet paper for use as a packaging wrap and/or void fill, machine direction extensible ranges from 1%-9% provide an adequate extensibility, with 1% to 6% preferred, and 1% to 4% most highly preferred. The lower the extensibility coincides with lower costs of the paper per square foot. As indicated above, it should be understood that extensibility is measured on unslit paper.”

“In some alternative embodiments, machine direction extensibility ranges of the extendible slit sheet paper can have ranges of:
a) from 1.5%-9%, or more preferably from 1.5% to 6% preferred, or even more preferably from 1.5% to 4%; or
b) from 2%-9%, or more preferably from 2% to 6% preferred, or even more preferably from 2% to 4%; or
c) from 3%-9%, or more preferably from 3% to 6% preferred, or even more preferably from 3% to 4%.”

“For the purposes of expanding the slit sheet paper for use as a packaging wrap and/or void fill, it has been found that cross direction extensible ranges from 1%-5% provides an adequate extensibility with 1% to 4% preferred, and 1% to 3% most highly preferred.”

“In some alternative embodiments, cross direction extensibility ranges of the extendible slit sheet paper can have ranges of: a) from 1.5%-5%, or more preferably from 1.5% to 4%, or even more preferably from 1.5% to 3%; or b) from 2%-5%, or more preferably from 2% to 4%, or even more preferably from 2% to 3%.”

“In combination with the extensible paper, a smaller, lighter weight, and recyclable version of an expander can be employed (such as, e.g., made entirely or substantially entirely with recyclable cardboard in some illustrative embodiments). This expands the market to customers that use a very small amount of wrap as compared to the industrial market. It also provides for a less expensive expansion device to be employed for expanding the slit paper. Additionally, it enhances the ease of use by the packer by providing for less ripping during the wrapping process that occurs when the tension is not properly set. This occurs as the roll, during its continued use, becomes smaller and lighter in weight. As the roll of expanded slit sheet becomes lighter the tension required increases. Thus, there need for a varying tensioning method. With the use of the extensible paper, the tension required is significantly decreased and the strength of the paper is increased. Both benefit the person wrapping by making the tensioning required much less precise to the point at which, a single tension setting can be used with little or no adjustment. If the tension is set higher than necessary, the increase in strength from the extensible paper keeps the product from tearing and therefore makes it easier for the packer to use. Therefore, the packer can make fewer adjustments as the slit sheet roll becomes smaller and smaller.”

“The reduction in the force required to expand the slit paper enables a new product to be created using lighter weight papers. In the past, expanded slit sheet paper is primarily used as a wrapping product whereas its use as a void fill would be in limited circumstances due to void fill being typically the cheapest, that is, the lowest cost of all packaging products. The increased strength of the extensible sheet enables the use of a thinner and lighter weight slit sheet paper as a void fill product. If the expanded slit sheet is not being used as a wrap, then the thicker 0.005″, 50 pounds per 3,000 square feet paper and above is not required and a lighter weight 0.003-0.0045″ thick, 30-40 pounds per 3,000 square feet paper can be used as void fill. It can also be used to provide cushioning that other paper void fill products have not been able to provide. It has now been found that even though the extensible paper has a 10% higher price, the use of a thinner paper provides much more square footage per ton and more than compensates for the increased cost of the extensible paper as compared to Kraft paper.”

“Detailed Descriptions of Technologies Employed in the Present Invention Quoted from Disclosures that are Incorporated by Reference”

“The Following are Citations from Clupak's paper patent (U.S. Pat. No. 9,945,077):”

### “Example 1

Heavy-duty Clupak paper having a basis weight of 84.9 g/m2 was made using a gap-former paper-making machine equipped with a Clupak system, at a paper-making speed of 480 m/min and using, as material, 100% unbleached softwood Kraft pulp that had been beaten at high concentration of 28%. The negative draw on the Clupak was set to −4.5%.”

### “Example 2

Heavy-duty Clupak paper was made in the same manner as in Example 1, except that the paper had a basis weight of 76.1 g/m² and the negative draw on the Clupak was set to −6.0%.”

### “Example 3

Heavy-duty Clupak paper was made in the same manner as in Example 1, except that the paper had a basis weight of 73.4 g/m² and the negative draw on the Clupak was set to −4.0%.”

### “Example 4

Heavy-duty Clupak paper was made in the same manner as in Example 1, except that the paper had a basis weight of 85.0 g/m², the negative draw on the Clupak was set to −4.0%, and the pulp blend consisted of 90% unbleached softwood Kraft pulp and 10% unbleached hardwood Kraft pulp.”

### “Comparative Example 1

Heavy-duty Clupak paper was made in the same manner as in Example 1, except that the paper had a basis weight of 71.9 g/m² and the negative draw on the Clupak was set to −10.0%.”

### “Comparative Example 2

Heavy-duty Clupak paper was made in the same manner as in Example 1, except that the paper had a basis weight of 85.4 g/m² and the negative draw on the Clupak was set to −1.0%.”

### “Comparative Example 3

Heavy-duty Kraft paper was made in the same manner as in Example 1, except that the paper had a basis weight of 76.0 g/m2 and the Clupak process was not performed.”

TABLE 1

| | | Clupak | | | | | Tensile | | Elongation | |
|---|---|---|---|---|---|---|---|---|---|---|
| | | negative | Basis | Paper | | Air | index | | at break | |
| | | draw | weight | thickness | Density | resistance | Nm/g | | % | |
| | | % | g/m² | μm | g/cm³ | sec | MD | CD | MD | CD |
| Examples | 1 | −4.5 | 84.9 | 121 | 0.70 | 14 | 88.1 | 31.3 | 7.0 | 7.1 |
| | 2 | −6.0 | 76.1 | 118 | 0.65 | 12 | 69.5 | 33.0 | 8.1 | 5.8 |
| | 3 | −4.0 | 73.4 | 110 | 0.67 | 13 | 72.5 | 30.1 | 6.0 | 6.0 |
| | 4 | −4.0 | 85.0 | 129 | 0.66 | 13 | 83.3 | 39.4 | 7.4 | 6.3 |
| Comparative | 1 | −10.0 | 71.9 | 112 | 0.64 | 12 | 52.0 | 28.0 | 10.6 | 5.3 |
| Examples | 2 | −1.0 | 85.4 | 130 | 0.66 | 15 | 85.0 | 32.1 | 3.7 | 6.7 |
| | 3 | Not used | 76.0 | 119 | 0.64 | 18 | 92.1 | 35.5 | 3.3 | 5.4 |

| | | | | Tensile | | | | | Breaking |
|---|---|---|---|---|---|---|---|---|---|
| | | TEA | | stiffness | | Tear | | | after |
| | | index | | index | | index | | | processsed |
| | | J/g | | kNm/g | | mN · m²/g | | | into heavy- |
| | | MD | CD | MD | CD | MD | CD | Formation | duty sack |
| Examples | 1 | 3.55 | 1.55 | 5.62 | 3.64 | 12.8 | 28.9 | ◯ | ◯ |
| | 2 | 3.22 | 1.47 | 4.18 | 3.07 | 19.7 | 25.8 | ◯ | ◯ |
| | 3 | 2.60 | 1.17 | 4.95 | 3.43 | 14.9 | 20.3 | ◯ | ◯ |
| | 4 | 3.47 | 1.51 | 5.33 | 3.44 | 13.1 | 25.5 | ⊚ | ◯ |
| Comparative | 1 | 3.47 | 1.02 | 3.09 | 3.14 | 19.7 | 27.1 | ◯ | X |
| Examples | 2 | 1.99 | 1.49 | 7.12 | 3.70 | 16.3 | 20.4 | ◯ | X |
| | 3 | 1.89 | 1.49 | 8.92 | 3.85 | 19.1 | 24.9 | ◯ | ◯ |

### “Evaluation Methods:

(Measurement of Tensile Energy Absorption Index)
Measured by the method specified in JIS P8113: 2006.
(Measurement of Breaking Elongation)
Measured by the method specified in JIS P8113: 2006.
(Measurement of Tear Index)
Measured by the method specified in JIS P8116: 2000.
(Measurement of Burst Index)
Measured by the method specified in JIS P8112: 2008.
(Measurement of Tensile Stiffness Index)
Measured by the method specified in ISO/DIS 1924-3.
(Measurement of Freeness after Disintegration)
Measured by the method specified in JIS P8220: 1998 and JIS P8121: 1995.”

“Looking at the properties of the Clupak papers in Examples 1 to 4 and Comparative Examples 1 and 2 as well as those of the Kraft paper in Comparative Example 3, as shown in Table 1, the Clupak papers described in Examples 1 to 4 exhibit a good balance of various strengths and elongation and have excellent strength overall; on the other hand, the Clupak papers described in Comparative Examples 1 and 2 and Kraft paper described in Comparative Example 3 exhibit a poor balance of various strengths and elongation and cannot be said to have excellent strength overall.”

“The following are Citations from “Understanding Sheet Extensibility”, R. S. Seth, (Pulp and Paper Research Institute of Canada 3800 Wesbrook Mall Vancouver, BC, Canada V6S 2L9) Pulp & Paper Canada T31, 106:2 (2005) III, pages 33-40 (T31-T38):

Tensile strength and extensibility or stretch are two important failure properties of paper. They are defined by the end-point of the sheet's load-elongation curve (FIG. 1). Individually and together, they are important for many product performance properties. For example, TEA, the tensile energy absorbed by the sheet before failure is proportional to the area under the load-elongation curve. Thus, it depends on both the tensile strength and extensibility of the sheet. A high TEA is desired in sack papers [1]. The bursting strength of paper has been shown to be proportional to the product of tensile strength and the square-root of stretch [2]. The fracture toughness of paper has been found to depend strongly on the sheet's tensile strength and stretch [3, 4]. Sheet stretch has also been regarded as important for paper runnability both at the paper machine's dry-end and in the pressroom [5-8]. Papers with high stretch also seem to have a somewhat higher tearing resistance [9], and folding endurance; they are found to be more dimensionally unstable as well [10]. The factors that control sheet tensile strength are fairly well understood [4]. The tensile strength is high if fibres are strong, long, fine and thin-walled. The fibres should be conformable and have a high fibre-fibre bond strength. The sheet tensile strength is also high if fibres are straight, free from deformations and the sheets are well formed. Otherwise, the stress is unevenly distributed when the sheet is strained, leading to premature failure.”

“This report deals with the factors that control sheet stretch.”

“Factors that Control Sheet Stretch:

A specimen under tensile load extends more, the longer it is. Therefore, extensibility or stretch or strain at failure as a material property, is expressed as a percentage of the original specimen length (FIG. 1).”

### “Role of Bonding:

Regardless of how bonding between the fibres is increased—by wet pressing, beating or refining, or additives, the sheet stretch of a furnish generally increases with increased fibre-fibre bonding. This is observed for almost all papermaking fibres—chemical, mechanical, wood, non-wood, or recycled. The reasons are as follows. Fibres have a certain “stretch-potential”. However, this potential is realized in paper only when fibres form a bonded network. If the bonding is weak, the network fails before the stretch-potential is realized; the sheet stretch is low. As bonding in the network is increased, the stretch-potential of fibres is increasingly realized, the sheet stretch increases. Since increased inter-fibre bonding also increases sheet tensile strength, an increase in stretch with tensile strength is often observed for handsheets (FIG. 2). The stronger the sheet, the more the fibres' stretch-potential is utilized. Because of this relationship between tensile strength and stretch, factors such as sheet grammage or formation that tend to affect tensile strength also affect sheet stretch [11]. A comparison of handsheet stretch values at similar tensile strengths provides a meaningful comparison of the stretch-potential of various furnishes.”

“The Following are Citations from Trani et al.'s Extensible Paper Patent (U.S. Pat. No. 7,918,966):”

“Extensible paper is a known paper which, because of special treatment during its production, presents considerable extensibility both in the longitudinal direction (i.e. in the direction of its advancement along the production line) and in the transverse direction (i.e. in the direction perpendicular to the preceding). This treatment consists essentially of passing the paper web not yet formed and presenting a moisture content of about 35%/45% between two rollers rotating at different speeds. One of these rollers, generally the lower roller, is made of rubber and is rotated at lower speed, while the upper roller is made of steel and comprises in its cylindrical surface a continuous spiral-shaped groove. The different material nature and the different speed of the two rollers results in a sort of longitudinal accumulation of the paper forming material and prepares it for longitudinal extensibility, by an amount which can reach 15-20%. At the same time, the spiral groove performs a double function: on the one hand it causes a sort of transverse accumulation of the material forming the paper to prepare it for transverse extensibility. By an amount which can reach 10-15%. On the other band the spiral groove contributes to maintaining longitudinal advancement of the processed paper web along the machine.”

“The Following are Citations from Cabell et al.'s Extensible Paper Web Patent (U.S. Pat. No. 6,458,447):”

### “Tensile and Percent Stretch Test:

The tensile test is used for measuring force versus percent elongation properties. The tests are performed on a Thwing Albert Intellect II-STD Model No. 1451-24PGB, available from the Thwing-Albert Co. of Philadelphia, Pa.”

“The samples used for this test are 1″ wide×6″ long with the long axis of the sample cut parallel to the direction of maximum extensibility of the sample. The sample should be cut With a sharp Exacto knife or some suitably sharp cutting device design to cut a precise 1″ wide sample. (If there is more than one direction of extensibility of the material, samples should be taken parallel to representative direction of elongation). The sample should be cut so that an area representative of the symmetry of the overall pattern of the deformed region is represented. There will be cases (due to variations in either the size of the deformed portion or the relative geometries of regions 1 and 2) in which it will be necessary to cut either larger or smaller samples than is suggested herein. In this case, it is very important to note (along with any data reported) the size of the sample, which area of the deformed region it was taken from and preferably include a schematic of the representative area used for the sample. Three samples of a given material are tested.”

“The Following are Citations from Cramer et al.'s Extensible Paper Patent (U.S. Pat. No. 3,266,972):”

### “Test and Characterization Procedures:

The test and characterization procedures employed in measuring various properties reported herein are listed in Table I below. Unless otherwise indicated the code letter numerals indicate standard TAPPI tests.”

### “Elongation T457:

By the expression “extensible papers” is meant a paper having an increased elongation (generally a minimum of about 6%) in the machine direction.

In runs IA and IB of this example, rosin size (0.3% by weight based on the weight of pl up) is added at the beater and the pH is adjusted to 4.5 with alum. The stock, having a consistency of 3.6% is dropped to the beater chest and is then pumped to a second chest, passed through a Jordan and continuously diluted with “white water” at the Fourdrinier headbox to a consistency of 0.3%. Properties measured on the various papers is reported in Table III. Each paper has a basis weight of from 49.4 to 50.3 pounds per ream.”

TABLE III

| Property | | IA | 1B | IC | ID |
|---|---|---|---|---|---|
| Tensile (lbs/in.) | MD | 15.6 | 16.0 | 18.2 | 22.4 |
| | CD | 12.6 | 13.0 | 14.3 | 15.4 |
| Elongation | MD | 10.1 | 11.2 | 9.9 | 9.7 |
| (percent) | CD | 3.7 | 4.3 | 4.4 | 4.6 |
| Work-to-break | MD | 1.01 | 1.05 | 1.14 | 1.34 |
| (in.-lbs./in.²) | CD | 0.34 | 0.41 | 0.47 | 0.50 |
| MIT Fold | MD | 380 | 398 | 496 | 1,021 |
| | CD | 106 | 94 | 132 | 167 |
| CSI Abrasion | MD | 14 | | 20 | 25 |
| (cycles) | CD | 7 | | 37 | 64 |

“The Following are Citations from Trani et al.'s Multilayer Paper Material Patent (U.S. Pat. No. 8,518,522):”

“These and other objects which will be apparent from the ensuing description are attained according to the invention by a multilayer papery material comprising at least one first three dimensional structure sheet exhibiting reliefs having maximum sizes which are lower than the width of the original sheet, said reliefs being obtained through localized stretching of said first sheet which has an original degree of extensibility of not less than 5% in all the directions, and at least one second sheet made of papery material coupled to said first structure sheet and defining empty spaces with the reliefs thereof.”

“As it can be seen from the figures, in the embodiment shown in FIG. 1 the multilayer material of the invention consists of two layers 2, 4 of paper presenting extensibility characteristics of not less than 5% both in a longitudinal and in a transverse direction, and preferably not less than 15%.”

“The Following are Citations from Trani et al.'s Extensible Paper Material Application (U.S. Application No. 2007/0240841):”

“Extensible paper is a known paper which, because of special treatment during its production, presents considerable extensibility both in the longitudinal direction (i.e. in the direction of its advancement along the production line) and in the transverse direction (i.e. in the direction perpendicular to the preceding). This treatment consists essentially of passing the paper Web, not yet formed and presenting a moisture content of about 35%/45%, between two rollers rotating at different speeds. One of these rollers, generally the lower roller, is made of rubber and is rotated at lower speed, While the upper roller is made of steel and comprises in its cylindrical surface a continuous spiral-shaped groove. The different material nature and the different speed of the two rollers results in a sort of longitudinal accumulation of the paper forming material and prepares it for longitudinal extensibility, by an amount which can reach 15-20%. At the same time, the spiral groove performs a double function: on the one hand it causes a sort of transverse accumulation of the material forming the paper, to prepare it for transverse extensibility, by an amount which can reach 10-15%. On the other hand the spiral groove contributes to maintaining longitudinal advancement of the processed paper web along the machine.”

Further details related to extensible papers that can be employed in some preferred embodiments are also quoted in the '086 patent as follows.

“The following is a direct quote of the paragraph on column 1, lines 4-19, of U.S. Pat. No. 3,908,071 incorporated by reference in the preceding paragraph: “Extensible (compacted) paper produced, for example, in accordance with the apparatus and process disclosed in U.S. Pat. No. 2,624,245 has certain well recognized advantages and commercial uses. Such paper is subjected, while in a partially moistened condition, to compressive compaction in the direction of web movement (machine direction or MD) between a pressure nip, thus compacting and forcing the fibers together to produce an inherent stretchability without creping. Compacted paper has improved tensile energy absorption (TEA) burst and tear characteristics which are highly desirable for such end uses as the manufacture of paper sacks.” In addition, the following is a direct quote of the Abstract of U.S. Pat. No. 6,024,832 incorporated by reference in the preceding paragraph: “A method for producing extensible paper, comprising the following stages: feeding a mix of vegetable fibres to a kneader member, mixing the mix with water in the kneader, beating the fibres to obtain a pulp, transferring the beaten pulp into a flow chest, feeding the beaten pulp from the flow chest onto a paper web formation cloth with consequent reduction of the water percentage by gravity and vacuum, pressing the web, with consequent further reduction of its water content, initial drying of the paper web to a substantially constant moisture content of between 15% and 65%, compacting, final drying to a moisture content of between 15% and 4%, preferably 10%-8%, glazing, wherein: the beating stage is carried out by rubbing the fibres in a multistage unit to obtain a pulp having a degree of beating of at least 30.degree. SR, the compacting stage is carried out between at least a pair of rollers of which one is of hard material comprising circumferential surface ribs and driven at greater speed, and the other is of soft material with a smooth surface and driven at lesser speed.” In addition, the following is a direct quote of the 2^{nd} paragraph of the Background section of U.S. Pat. No. 9,945,077 incorporated by reference in the preceding paragraph: “On the other hand, Clupak refers to equipment that inserts a paper web between a roll and an endless rubber blanket to compress the paper web with a nip bar and the rubber blanket, while at the same time the pre-stretched blanket shrinks to cause the paper web to also shrink and thereby increase its breaking elongation, and this equipment is used to provide increased breaking elongation to kraft paper used in heavy packaging applications as mentioned above.” In addition, the following is a direct quote of the paragraph on column 2, lines 41-56 of U.S. Pat. No. 3,104,197 incorporated by reference in the preceding paragraph: “The use of rubber or rubberous material in conjunction with a hard surface in the manner described is known in the treatment of paper as well as fabrics but only in a general way and the present invention includes the use of rubber considerably softer and more elastic than previously used. Also of great importance in the production of an extensible paper by creping it in this manner is the differential in speeds at which the rolls are driven. If the proper combination of hard and soft surfaces is provided, a semi-dry paper web passing through the nip of the rolls will be carried by the contracting rubber against the direction of web travel toward the nip and over the surface of the hard roll. This creates a uniformly compressed crepe in the paper web giving toughness, pliability and extensibility.”

“The following are direct quotes of paragraphs [0003] and [0028] of U.S. Patent Publication No. 2016/0355985 incorporated by reference in the preceding paragraph: (1) “[0003] On the other hand, Clupak refers to equipment that inserts a paper web between a roll and an endless rubber blanket to compress the paper web with a nip bar and the rubber blanket, while at the same time the pre-stretched blanket shrinks to cause the paper web to also shrink and thereby increase its breaking elongation, and this equipment is used to provide increased breaking elongation to kraft paper used in heavy packaging applications as mentioned above;” and “[0028] The manufacturing method using this Clupak system is such that a paper web is inserted between a roll and an endless rubber blanket to compress the paper web with a nip bar and the rubber blanket, while at the same time the pre-stretched blanket shrinks to cause the paper web to also shrink and thereby increase its breaking elongation. The Clupak system allows for adjustment of the breaking elongation of kraft paper in the longitudinal direction according to the ratio of the manufacturing speed on the inlet side of the Clupak system and manufacturing speed on the outlet side of the Clupak system, and also according to the pressurization force applied by the nip bar.”

In some embodiments, extensible paper employed can involve an extensible paper that can include one or more of the following features, as set forth in the '086 patent.

Example 1: An extensible slit sheet paper cushioning product, comprising: a roll of slit sheet paper having a slit pattern including a plurality of slits extending in a cross direction that forms a plurality of open cells upon expansion in a machine direction, said roll resisting pulling of a length of slit sheet paper along the machine direction to enable expansion of the length of slit sheet paper in the machine direction, said slit sheet paper being formed from a paper that is extensible in the machine direction and the cross direction prior to providing said slit pattern, said extensible paper having an extensible range of 3 to 20% in the machine direction prior to providing said slit pattern.

Example 2: The extensible slit sheet paper cushioning product of example 1, wherein said extensible range is not less than 5% in both the machine direction and cross direction.

Example 3: The extensible slit sheet paper cushioning product of example 1, wherein said extensible range is 3-15% in the machine direction.

Example 4: The extensible slit sheet paper cushioning product of example 1, wherein said slit sheet paper is configured such that expansion is performed by applying an expansion force of 0.15 to 0.22 pounds per inch to form said open cells.

Example 5: The extensible slit sheet paper cushioning product of example 2, wherein said slit sheet paper is configured such that expansion is performed by applying an expansion force of 0.15 to 0.22 pounds per inch to form said open cells.

Example 6: The extensible slit sheet paper cushioning product of example 5, wherein said slit sheet paper has a weight, prior to expansion, from about 30 to 50 pounds per 3,000 sq. ft.

Example 7: The extensible slit sheet paper cushioning product of example 1, wherein said slit sheet paper has a weight, prior to expansion, from about 30 to 50 pounds per 3,000 sq. ft.

Example 8: The extensible slit sheet paper cushioning product of example 1, wherein said extensible range is 3-11.1% in the machine direction.

Example 9: extensible slit sheet paper cushioning product of example 1, wherein said extensible range is 3-11.1% in the machine direction.

Example 10: The extensible slit sheet paper cushioning product of example 1, wherein said extensible range is 3.3-10.6% in the machine direction.

Example 11: The extensible slit sheet paper cushioning product of example 1, wherein said extensible range is 9.7-11.1% in the machine direction.

Example 12: The extensible slit sheet paper cushioning product of example 1, wherein said extensible paper is formed by imparting a treatment prior to providing the slit pattern comprising inserting said paper between a roll and an endless pre-stretched blanket to compress the paper with a nip bar and the blanket (or otherwise compressing the paper between two different (e.g., differently moving) surfaces, such as between two different rollers).

Example 12: The extensible slit sheet paper cushioning product of example 1, wherein said extensible paper is a nonwoven fibrous material with fibre-to-fibre bonding that resists tearing upon 3-15% expansion in the machine direction as measured prior to providing the slit pattern.

Example 13: The extensible slit sheet paper cushioning product of example 1, wherein said roll of slit sheet paper is wound on a cylindrical core, and said length of slit sheet paper extends from said roll of slit sheet paper.

Example 14: The extensible slit sheet paper cushioning product of example 1, wherein said extensible range is 5-15% in a cross-direction.

Example 15: The extensible slit sheet paper cushioning product of example 1, wherein said extensible range is 7.1-15% in a cross-direction.

Example 16: The extensible slit sheet paper cushioning product of example 58, wherein said slit sheet paper is configured such that expansion is performed by applying an expansion force of 0.15 to 0.22 pounds per inch to form said open cells.

In some preferred embodiments, the slit paper pattern of slits advantageously has slits in the range from 0.2 to 0.3 inches (i.e., in the lengthwise dimension of the slits) and spaces between rows in the range from 0.06 to 0.7 inches (i.e., the distance between adjacent rows of slits). Preferably, the slit paper pattern of slits advantageously has slits of about 0.25 inches (i.e., in the lengthwise dimension of the slits) and spaces between rows of about 0.06 to about 0.065 inches (i.e., the distance between adjacent rows of slits) and most preferably spaces between rows of about 0.0625 inches.

In some embodiments, the space between the slits of each row is in the range from about 0.1 to about 0.09 inches and, in some examples, the space between the slits of each row is about 0.094 inches.

The foregoing dimensions produce a slit pattern that creates more cells per square foot, provides crush resistance and resiliency for cushioning items. In some examples, a “thin expanded sheet” can be provided that employs a slit paper pattern of slits in the range from 0.2 to 0.3 inches (i.e., in the lengthwise dimension of the slits) and spaces between rows in the range from 0.06 to 0.7 inches (i.e., the distance between adjacent rows of slits).

In order to expand an expandable slit sheet paper, an expansion force is required to pull the paper to cause the paper to expand and to open the cells. Existing expandable slit sheet paper can be somewhat difficult to expand and requires a substantially higher force for expansion. Additionally, existing expandable slit sheet paper requires a larger slit length in order to enable opening of the cells. Varying slit patterns with expanded slit sheet material require varying force to stretch. The previous slit pattern used in the market requires approximately 6 pounds of pulling force for slit material that is 15 inches wide utilizing 50 # Kraft paper. However, the present inventor has discovered that extensible paper reduces the force required for the same slit pattern and paper weight to, e.g., 2 pounds.

The present inventor has also discovered that this decrease enables further slit pattern opportunities that can provide greater resiliency and a reduced thickness is desired where, in the past, they would be too difficult to stretch manually and provide a burden to the automated expanding equipment. In general terms, the present inventor has discovered that a 10% reduction in slit, land, and row size increases the number of supporting legs by 23.7%—a more than doubling of the strength of the material. This provides cushioning solutions where greater resiliency of the same or smaller leg height can be accomplished.

Additionally, and well known in paper die cutting art, leg height impacts stiffness. As the leg height is reduced, the leg becomes stiffer. This is due to the fiber length that becomes more difficult to bow or flex as the height becomes shorter. According to preferred embodiments of the present invention, the leg height, the number of legs per square foot, and the paper weight is balanced to provide optimal cushioning while providing the least amount of pulling strength to open.

The automated equipment is also impacted with a heavy pulling strength as it requires more maintenance changes to the hook rollers due to them wearing out proportionally to the pulling force required. With the advent of the present inventor's discovery of the unique and unexpected advantages of extensible paper employed in expandable slit sheet products, these limitations based on pulling force are greatly diminished and enable greater market opportunities where greater strength is required.

Presently there is a move towards environmentally friendly packaging products that includes the use of non-powered equipment eliminating the need for electricity.

The use of a manual system to dispense rolls of expanded slit material that can have varying properties of cushioning and provides greater flexibility for protecting a wider variety of weights and densities of fragile items. Accordingly, very substantial benefits and advancements are achieved.

Presently, the crush strength for the current commercial pattern using a 0.5″ slit is 2.2 pounds per square inch of strength.

According to some preferred embodiments of the present invention, a preferred reduced slit pattern utilizing 50 # Kraft paper with a slit pattern of 0.45″ slit (i.e., length of slit), 0.1688″ land (i.e., distance between adjacent slits in a lengthwise direction of the slits), 0.1125″ row width (i.e., distance between adjacent rows of slits) is provided. In some embodiments, such a configuration yields 2.72-2.92 pounds of per inch of crush strength, which yields a 27% increase in strength with a 10% decrease in thickness from 0.1875″ to 0.16875″. In the preferred implementations of this slit pattern, the paper employed is an extensible paper.

According to some other embodiments of the present invention, another preferred slit pattern is 0.40″ slit, 0.15″ land, 0.1125″ row width. In some embodiments, this latter configuration yields 3.1-3.3 pounds per inch crush strength, which yields a 40% increase in crush strength with a 10% decrease in thickness from 0.1875″ to 0.16875.″ In the most preferred implementations of this slit pattern, the paper employed is an extensible paper.

According to the preferred embodiments, this increase in strength can advantageously be used to allow for a reduced thickness of the expanded slit sheet paper, which can, thus, provide, e.g., an equivalent crush strength while providing for a reduction in overall height. For example, in the above illustrative embodiments employing a 50 # paper, the use of 40 # paper would reduce the leg stiffness, but would reduce the cost of the paper.

According to some other preferred embodiments, an expandable slit paper sheet includes a pattern of slits having slit lengths in the range from 0.30 to 0.45 inches and spaces between rows of slits in the range from 0.1125 to 0.1688. In the most preferred implementations of this slit pattern, the paper employed is an extensible paper.

According to some other preferred embodiments, an expandable slit paper sheet includes a pattern of slits having slit lengths in the range of 0.45 inches plus 5% (e.g., 0.4725 inches) to 0.45 inches minus 33% (e.g., 0.30 inches). In the most preferred implementations of this slit pattern, the paper employed is an extensible paper.

According to some other preferred embodiments, an expandable slit paper sheet includes a pattern of slits that upon expansion produces an expandable slit paper having a number of legs per square foot that is at least 20% greater than a slit paper sheet with slit lengths of 0.5 inches which is configured to create hexagonal cells (e.g., with equilateral hexagons).

According to some other preferred embodiments, an expandable slit paper sheet includes a pattern of slits that upon expansion produces an expandable slit paper having a number of legs per square foot that is at least 15% greater than a slit paper sheet with slit lengths of 0.5 inches which is configured to create hexagonal cells (e.g., with equilateral hexagons), and, more preferably, in the range from 20% to 50% greater than such slit paper with slit lengths of 0.5 inches which is configured to create hexagonal cells (e.g., with equilateral hexagons)

In the most preferred embodiments, the paper employed is an extensible paper as described herein-above. The use of such extensible paper highly advantageously enables a reduced slit pattern size in comparison to prior slit patterns. Notably, non-extensible paper has limitations in relation to the viable sizes and dimensions of the slits, and such non-extensible paper does not enable reduction in sizes to that of preferred embodiments described herein because such prior papers would be inoperable and would not adequately expand if such small sizes were attempted to be employed.

Additionally, while the present inventor has discovered novel means to improve cushioning characteristics of expandable slit sheet paper, which involves “reducing” the slit pattern dimensions, it is notable that this reduction of slit pattern dimensions is “not only” unviable with prior expandable slit sheet paper (i.e., which could not achieve such small sizes), but is also “counter-intuitive” to the existing understanding of cushioning properties afforded by such expandable slit sheet papers. Notably, the cushioning of expandable slit sheet papers is directly related to the “width” of the expandable slit sheet paper in an expanded state. Accordingly, for enhancing cushioning, those in the art have sought to actually “increase” this width of the expanded slit sheet paper. However, the present inventor discovered means by which smaller slit patterns could be achieved (e.g., via the use of the extensible paper) and that such smaller slit patterns with such extensible papers could, in fact, provide enhance cushioning despite the losses in cushioning due to the reduced “width” of the expandable slit sheet paper. Additionally, the present inventor also discovered other desirable applications and uses of such novel expandable slit sheet paper.

Notably, non-extensible expanded slit paper sheets do not operate appropriately with slit lengths of less than about 0.5 inches. Accordingly, for expandable slit paper sheets of smaller slit sizes according to the present invention, an extensible paper according to the present invention is advantageously employed.

According to some more preferred embodiments of the invention, a slit pattern is provided which includes slit lengths of 0.35″ slits (i.e., the lengths of the slits), 0.13125″ lands (i.e., the distances between adjacent slits in the same row of slits in a lengthwise direction of the slits), and 0.0875″ row width (i.e., the distances between adjacent rows of slits). In this regard, such a slit pattern is preferably implemented within a pattern of slits similar to that shown in, e.g., FIG. 6(A), in which all of the slits of the expandable slit sheet have the same lengths, the distances between adjacent rows is consistently the same, in which the distance between slits in the same row is consistently the same, and in which the locations of the slits in adjacent rows is arranged with equal overlap to form symmetrical cells. For these embodiments, an extensible slit sheet paper is preferably employed; notably, a non-extensible paper cannot be used to viably operationally function with such a slit pattern.

While, preferably, all of the expanded slit sheet paper would include a same slit pattern throughout the sheet, in some embodiments such a pattern could be employed within a portion or region of the paper and/or some regions of the paper may potentially include some differences in the pattern. Additionally, although the slit lengths and dimensions are preferably consistently the same as indicated above, in some embodiments, there could be some variations in sizes, positions of the slits as long as operation of the product is not impeded.

In some embodiments, a slit pattern having 0.35″ slits, 0.13125″ lands, and 0.0875″ row width can yield 3.52-3.82 pounds per inch crush strength which yields a 60% increase in crush strength with a 30% decrease in thickness from 0.1875″ to 0.1125.″

In some preferred implementations of all of the embodiments of the invention described above, the lands distance (i.e., the distance SS shown in FIG. 6(A) between the slits) is approximately ⅓ the length of the slits (i.e., the distance SL shown in FIG. 6(A)). When the distance SS is about ⅓ the length of the slits, the lengths of the perimeter sides of the created cell openings a26 and b26 are equal. However, in some preferred embodiments, the distance of the lands (i.e., SS) is preferably slightly greater than ⅓ the length of the slits. For example, in the lattermost embodiments above employing a 0.35″ slit length, with 0.13125″ land length, the ratio is approximately 0.375. Accordingly, in this example, the length of the lands are approximate 12.5% larger than ⅓ the length of the slits.

In some preferred embodiments, the lengths of the lands would be about ⅓ the length of the slits plus or minus about 25%. In some other preferred embodiments, the lengths of the lands would be about ⅓ the length of the slits plus or minus about 20%. In some preferred embodiments, the lengths of the lands would be about ⅓ the length of the slits plus or minus about 15%. In some other preferred embodiments, the lengths of the lands would be about ⅓ the length of the slits plus or minus about 10%.

In some other preferred embodiments, the lengths of the lands would be between about ⅓ the length of the slits to 25% greater than ⅓ the length of the slits. In some other preferred embodiments, the lengths of the lands would be between about ⅓ the length of the slits to 20% greater than ⅓ the length of the slits. In some other preferred embodiments, the lengths of the lands would be between about ⅓ the length of the slits to 15% greater than ⅓ the length of the slits. In some other preferred embodiments, the lengths of the lands would be between about ⅓ the length of the slits to 10% greater than ⅓ the length of the slits.

In some other preferred embodiments, the lengths of the lands would be between about 5% greater than ⅓ the length of the slits to about 25% greater than ⅓ the length of the slits. In some other preferred embodiments, the lengths of the lands would be between about 10% greater than ⅓ the length of the slits to about 20% greater than ⅓ the length of the slits. In some other preferred embodiments, the lengths of the lands would be between about 10% greater than ⅓ the length of the slits to about 15% greater than ⅓ the length of the slits. In some other preferred embodiments, the lengths of the lands are such that the slit length SL is approximately set in relation to the split spacing SS as follows: SL=2.6667×SS.

In some preferred embodiments, the dimensions of the expandable slit sheet paper are proportionally reduced from an expandable slit sheet paper having a 0.5″ slit length, a ⅛″ (0.125 inch) spacing between rows, and a spacing between slits within the same row (i.e., land length) of 3/16″ (0.1875 inch) as follows: a) the row spacing is proportionally reduced by a ratio SL(new)/0.5 and b) the slit spacing is set at SL(new) divided by 2.6667. For example, some preferred embodiments include dimensions as set forth below Table A:

| | Slit Length (SL) | | Slit Spacing (SS) | | Row Spacing (RS) | |
|---|---|---|---|---|---|---|
| Example A | 0.45 | inches | 0.1687 | inches | 0.1125 | inches |
| Example B | 0.425 | inches | 0.1594 | inches | 0.1063 | inches |
| Example C | 0.40 | inches | 0.1500 | inches | 0.1000 | inches |
| Example D | 0.375 | inches | 0.1406 | inches | 0.09375 | inches |
| Example E | 0.35 | inches | 0.13125 | inches | 0.0875 | inches |
| Example F | 0.325 | inches | 0.1219 | inches | 0.0813 | inches |
| Example G | 0.30 | inches | 0.1125 | inches | 0.0750 | inches |
| Example H | 0.275 | inches | 0.1031 | inches | 0.0688 | inches |
| Example I | 0.25 | inches | 0.09375 | inches | 0.0625 | inches |
| Example J | 0.225 | inches | 0.08438 | inches | 0.0563 | inches |
| Example K | 0.20 | inches | 0.07500 | inches | 0.05 | inches |
| Example L | 0.175 | inches | 0.06562 | inches | 0.4375 | inches |

In some preferred embodiments, the corresponding row spacings of the Examples A to L in the above Table A are substantially as shown in Table A. In some preferred embodiments, the row spacings of Examples A to L can be substantially as shown in Table A plus or minus 20%, or, more preferably, substantially as shown in Table A plus or minus 15%, or, more preferably, substantially as shown in Table A plus or minus 10%, or, more preferably, substantially as shown in Table A plus or minus 5%.

Furthermore, in some preferred embodiments, the corresponding row spacings of the Examples A to L in the above Table A are, more preferably, within a range that is the same or lower than the row spacings shown in Table A for the respective slit lengths; notably, with reduced slit length, there can be increased difficulty to open the cells, which difficulty is increased with larger row spacings. Accordingly, as the slit lengths are decreased, in some preferred embodiments, the row spacing decreases an extent that is proportionally the same or more than the proportional decrease in the slit length. Notably, while the present inventor discovered that slit lengths could be viably decreased by the use of extensible papers as described herein, the present inventor also noted that even with extensible papers reduction in slit lengths can increase difficulty to open cells in the event that row spacings are proportionally too large.

Although the preceding Table A shows row spacings that are substantially reduced well below the ⅛″ (0.125 inch) row spacing of the background art, in some alternative embodiments, the row spacings for various embodiments of the invention (including that of, e.g., Examples A to L in the preceding Table) can still be larger. That is, while the present invention very advantageously enables such a reduced row spacing due to the greatly improved cushioning characteristics that enable the row spacing to be reduced (e.g., the reduction in cushioning resultant from reduced row spacing can be offset by the improved cushioning characteristics of the present invention), such a substantial reduction is not necessarily required, as long as the cell structure can be opened for expansion.

For example, in some alternative embodiments, any of the embodiments of the invention having slit lengths within a range of 0.40 to 0.25 can employ row spacings that are less than that of the existing art, such as, e.g., less than 0.125 inches, or, more preferably, less than 0.12 inches, or, more preferably, less than 0.115 inches, or, more preferably, less than 0.1125 inches, or, more preferably, less than 0.0875 inches, or, in some embodiments more preferably, less than 0.08 inches.

In some other alternative embodiments, the various embodiments of the invention shown in the preceding Table A can be modified such that:
a) the slit spacing (which is shown in Table A as approximately based on the formula SL=2.6667×SS), can be adapted to be based on the formula SL=K×SS, where K is a value between 2.4 and 3.3, or, more preferably, where K is a value between 2.5 and 3, or, more preferably, where K is a value between 2.6 and 2.8); and/or
b) the row spacing (which is shown in Table A as approximately based on the row spacing being proportionally reduced by a ratio SL(new)/0.5, such as to be based on the formula RS(new)=0.125/0.5×SL(new) or RS(new)=0.25×SL(new)), can be adapted to be based on the formula RS(new)=Y×SL(new), where Y is a value between 0.2 to 0.4, or, more preferably, where Y is a value between 0.22 and 0.3, or, more preferably, where Y is a value between 0.23 and 0.27.

In some preferred embodiments, the slit paper pattern of slits advantageously has slits in the range from 0.2 to 0.3 inches (i.e., in the lengthwise dimension of the slits) and spaces between rows in the range from 0.06 to 0.7 inches (i.e., the distance between adjacent rows of slits). Preferably, the slit paper pattern of slits advantageously has slits of about 0.25 inches (i.e., in the lengthwise dimension of the slits) and spaces between rows of about 0.06 to about 0.065 inches (i.e., the distance between adjacent rows of slits) and most preferably spaces between rows of about 0.0625 inches.

In some preferred embodiments, the space between the slits of each row is preferably in the range from about 0.1 to about 0.09 inches and, in some examples, the space between the slits of each row is about 0.094 inches.

In all of the embodiments of the present invention, the paper is, most preferably, an extensible paper. In various embodiments, the extensible paper is an extensible paper according to any of the embodiments or examples of extensible paper disclosed herein.

In various embodiments, the extendable paper can employ extensibility according to any of the embodiments described herein, including, e.g., any of the Examples described above. Moreover, the extendable paper can include features of any of the extensible papers described herein in relation to, e.g., opening forces required, paper weight or type, etc.

In some illustrative examples, in some embodiments, an extensible paper is employed having an extensible range of 3 to 20% in the machine direction. In some illustrative examples, in some embodiments, an extensible paper is employed having an extensible range of 3 to 20% in the cross direction. In some illustrative examples, in some embodiments, an extensible paper is employed having an extensible range of 3 to 15% in the machine direction. In some illustrative examples, in some embodiments, an extensible paper is employed having an extensible range of 3 to 15% in the cross direction. In some illustrative examples, in some embodiments, an extensible paper is employed having an extensible range of 7 to 15% in the machine direction. In some illustrative examples, in some embodiments, an extensible paper is employed having an extensible range of 7 to 15% in the cross direction. In some illustrative examples, the extensible range is not less than 5% in both the machine direction and cross direction.

Moreover, in some illustrative examples, the slit sheet paper is an extensible slit sheet configured such that expansion is performed by applying an expansion force of 0.15 to 0.22 pounds per inch to form said open cells.

Moreover, in some illustrative examples, the slit sheet paper is an extensible slit sheet, wherein said slit sheet paper has a weight, prior to expansion, from about 30 to 50 pounds per 3,000 sq. ft. Notably, all of the embodiments of the invention described herein (e.g., the various slit patterns, including slit lengths, slit spacings, row spacings, etc.) can be employed in various implementations of papers with weights within this range in some embodiments, such as, e.g., on 30 # paper, 35 # paper, 40 # paper, 45 # paper, 50 # paper, 55 # paper and on any papers within these ranges. Moreover, in other embodiments, papers can be employed lower than this range of 30 # to 50 #, such as, e.g., 20 # or less, or larger than this range, such as, e.g., 60 # or more.

Slit-Sheet-Paper Expansion Systems and Methods Using Friction Brush(es) and/or Other Friction Members for Expanding Wrap and Void Fill

The present section describes illustrative embodiments of the present invention involving slit-sheet-paper expansion systems and methods using friction brush(es) and/or other friction members for expanding wrap and void fill.

### a. Embodiments from Co-Pending Parent Application Ser. No. 18,586,916

The present sub-section presents illustrative embodiments of the present invention involving slit-sheet-paper expansion systems and methods using friction brush(es) and/or other friction members as set forth in co-pending parent application Ser. No. 18,586,916, the entire disclosure of which application is incorporated herein by reference as though recited herein in full.

As set forth in the introduction of 18,586,916 application: “Various preferred embodiments of the present invention can be implemented in the contexts of the environments of any-and-all of the above-note patents and applications of the present inventor. By way of example, as discussed herein-below, some embodiments of the present invention can be used for expanding any of the expandable slit sheet papers set for in any of the foregoing patents and/or applications. Additionally, aspects of the present application can be implemented in the contexts of any of the various dispenser mechanisms described in such patents, such as, e.g., dispensers of expandable slit sheet paper for wrapping products (e.g., for use within packaging), for wrapping pallets or the like, and/or in any other contexts described in such patents and applications.”

As further set forth in the Summary of the 18,586,916 application:

“The preferred embodiments overcome and improve upon the foregoing and/or other related art.
1. According to some illustrative embodiments of the invention, an expansion system for expanding expandable slit sheet paper is provided that includes:
a friction member for applying friction along a lateral side of said expandable slit sheet paper.
2. According to other illustrative embodiments of the invention, an expansion system for expanding expandable slit sheet paper is provided that includes: a roll of expandable slit sheet paper;
a friction member for applying friction along a lateral side of said expandable slit sheet paper.
3. In some examples, the embodiments set forth in the above paragraphs 1 or 2 further include wherein said friction member includes a brush.
4. In some examples, the expansion system of any of the preceding paragraphs 1 to 3 include wherein said friction member includes a plurality of elongated members.
5. In some examples, the expansion system of any of the preceding paragraphs 1 to 4 include wherein said friction member includes a plurality of elongated bristles or fibers.
6. In some examples, the expansion system of any of the preceding paragraphs 1 to 5 include wherein said friction member imparts sufficient resistance to an expandable slit sheet paper that is pulled past said friction member such that said expandable slit sheet paper expands to form fully opened cells.
7. In some examples, the expansion system of any of the preceding paragraphs 1 to 5 include wherein said friction member imparts sufficient resistance to an expandable slit sheet paper that is pulled past said friction member such that said expandable slit sheet paper expands to form fully opened cells in a region downstream from the friction member.
8. In some examples, the expansion system of any of the preceding paragraphs 1 to 7 include wherein said expansion system further includes a guide upstream of said friction member.
9. In some examples, the expansion system of any of the preceding paragraphs 1 to 7 include wherein said expansion system further includes a guide upstream of said friction member that is configured to impart sufficient resistance to said expandable slit sheet paper to cause said expandable slit sheet paper to a state of beginning expansion.
10. In some examples, the expansion system of paragraphs 8 or 9 include wherein said guide includes a conveyor roller guide.
11. In some examples, the expansion system of paragraphs 8 or 9 include wherein said guide includes at least one rod, shaft or roller guide.
12. In some examples, the expansion system of paragraph 11 includes wherein said guide includes a rod or shaft that is non-rotatable mounted on said expansion system.
13. In some examples, the expansion system of paragraph 12 includes wherein said friction member is located at a first side of said roll, and said guide includes a rod or shaft located at a second side of said roll.
14. In some examples, the expansion system of paragraph 10 includes wherein said conveyor roller guide includes at least one conveying roller.
15. In some examples, the expansion system of paragraph 14 includes wherein said conveyor roller guide includes a plurality of conveying rollers.
16. In some examples, the expansion system of paragraph 15 includes wherein said plurality of conveying rollers include rollers located on opposite sides of said expandable slit sheet paper.
17. In some examples, the expansion system of any of paragraphs 14 to 16 include wherein said plurality of conveying rollers include three conveying rollers.
18. In some examples, the expansion system of paragraphs 8 or 9 includes wherein said guide includes a friction member.
19. In some examples, the expansion system of paragraph 15 includes wherein said friction member of said guide includes a brush.
20. In some examples, the expansion system of any of the preceding paragraphs 15 to 16, wherein said friction member of said guide includes a plurality of elongated members.
21. In some examples, the expansion system of any of the preceding paragraphs 15 to 17 include wherein said friction member of said guide includes a plurality of elongated bristles or fibers.
22. In some examples, the expansion system of any of the preceding paragraphs 1-21 further including an adjuster for adjusting the position of the friction member.
23. In some examples, the expansion system of paragraph 22 includes wherein said adjuster is configured to adjust a distance of the friction member from an opposing surface and/or the angular orientation of said friction member.
24. In some examples, the expansion system of any of the preceding paragraphs 1-23 include wherein said expansion system is a manual expansion system for manually expanding expandable slit sheet paper.
25. In some examples, the expansion system of any of the preceding paragraphs 1-23 include wherein said expansion system is a manual expansion system for manually expanding expandable slit sheet paper and wrapping the expanded paper around an object or item.
26. In some examples, the expansion system of any of the preceding paragraphs 1-23 include wherein said expansion system is a manual expansion system for manually expanding expandable slit sheet paper and wrapping the expanded paper around an object or item for protection within a package, box or container.
27. In some examples, the expansion system of any of the preceding paragraphs 1-23 include wherein said expansion system is an automated system that automatedly expands expandable slit sheet paper.
28. In some examples, a method of using the expansion system of any of the preceding paragraphs includes:
expanding an expandable slit sheet paper with said friction member applying a resistance against a lateral side of said expandable slit sheet paper.
29. In some examples, the method of paragraphs 28 further including said friction member applying a sufficient resistance against the lateral side of said expandable slit sheet paper such that as said expandable slit sheet paper is pulled past said friction member said expandable slit sheet paper expands to form fully opened cells.
30. In some examples, the method of paragraphs 28 or 29 further including providing a guide upstream of said friction member that is configured to impart sufficient resistance to said expandable slit sheet paper to cause said expandable slit sheet paper to assume a state of beginning expansion.
31. In some examples, any of the preceding paragraphs 1-30 include wherein said expandable slit sheet paper is made with a Clupak paper.
32. In some examples, any of the preceding paragraphs 1-31 include wherein said expandable slit sheet paper is made with a paper having an extensibility in a pre-slit configuration of at least 3% in a machine direction, or, in some preferred embodiments, at least 4% in the machine direction, or, some preferred embodiments, at least 5% in the machine direction, or, in some preferred embodiments, at least 6% in the machine direction.
33. In some examples, any of the preceding paragraphs 1-31 include wherein said expandable slit sheet paper is made with a paper having an extensibility in a pre-slit configuration of between 3-20% in a machine direction, or, in some preferred embodiments, between 4-20% in the machine direction, or, in some preferred embodiments, between 5-20% in the machine direction, or, in some preferred embodiments, between 6-20% in the machine direction, or, in some preferred embodiments, between 3-15% in a machine direction, or, in some preferred embodiments, between 4-15% in the machine direction, or, in some embodiments, between 5-15% in the machine direction, or, in some preferred embodiments, between 6-15% in the machine direction.
34. In some examples, any of the preceding paragraphs 1-33 include wherein said expandable slit sheet paper is made with a paper that weighs at least 25 (lbs.) per 3,000 square feet (i.e., 25 # paper), or, in some embodiments, at least 30 pounds per 3,000 square feet (i.e., 30 # paper), or, in some embodiments, at least 40 pounds per 3,000 square feet (i.e., 40 # paper), or, in some embodiments, at least 50 pounds per 3,000 square feet (i.e., 50 # paper), or, in some embodiments, at least 60 pounds per 3,000 square feet (i.e., 60 # paper), or, in some embodiments, at least 70 pounds per 3,000 square feet (i.e., 70 # paper), or, in some embodiments, between about 25 pounds per 3,000 square feet to 70 pounds per 3,000 square feet, or, in some embodiments, between about 35 pounds per 3,000 square feet to 60 pounds per 3,000 square feet, or, in some embodiments, between about 40 pounds per 3,000 square feet to 50 pounds per 3,000 square feet.”

As further set forth in the section entitled “Further Discussion of Illustrative Embodiments” of the 18,586,916 application:

“According to some preferred embodiments of the invention, in order to impart a desired resistance to the expandable slit sheet paper that is dispensed from a roll of expandable slit sheet paper for manual wrapping of items, at least one friction member is employed that applies a friction to the expandable slit sheet paper after being unwound from the roll of expandable slit sheet paper.”

“In some embodiments, the at least one friction member can be provided as an alternative to or in addition to the use of a pressure member, such as, e.g., a pressure member 101 shown in FIG. 1 [of the 18,586,916 application].”

“In some preferred embodiments, the at least one friction member includes at least one flexible member. In some preferred embodiments, the at least one flexible member includes a flexible brush. In some of the preferred embodiments, the at least one flexible brush is a brush having a plurality of elongated flexible bristles, filaments, wires or other elongated flexible elements. In some preferred embodiments, the flexible brush includes a plurality of elongated flexible elements wherein each elongated flexible element is made of a flexible plastic or polymer, of a flexible metal, of a flexible natural fiber or element, and/or other elongated flexible elements. In some illustrative embodiments, a brush can include bristles made of one or more of aluminum, brass, bronze, copper, steel, stainless steel, plastic, PVC, nylon, synthetic or polymeric fibers, Kevlar™, foam (e.g., polypropylene foam), animal hair (e.g., horse hair, goat hair, etc.), plant fibers (e.g., Ixtle, Tampico fiber, etc.). In some embodiments, bristles can be elongated members with a substantially consistent diameter or width along a length thereof or can have a relatively varied diameter or width along a length thereof. In some embodiments, bristles can have a generally rounded peripheral surface, a generally cylindrical peripheral surface, a generally polygonal (e.g., square, hexagonal, etc.) peripheral surface, an irregular peripheral surface, etc. In some embodiments, the shapes of the bristles can be relatively consistent along lengths thereof, while in some embodiments, the shapes of the bristles can vary along the lengths thereof. In preferred embodiments, the bristles have a substantially consistent structure along the lengths thereof for consistency in qualities, such as, e.g., stiffness and flexibility.”

“In some illustrative embodiments, bristles can be between about ½ inch to 4 inches long, or, in some preferred embodiments, between about ¾ inch to 3½ inches long, or, in some preferred embodiments, between about 1 inch to 3 inches long, or, in some preferred embodiments, between about 1½ inches to 2½ inches long.”

“In some illustrative embodiments, bristles can be employed having a width or diameter of less than about 0.2 inches, or, in some preferred embodiments, less than about 0.1 inches, or, in some preferred embodiments, less than about 0.05 inches, or, in some preferred embodiments, less than about 0.04 inches, or, in some preferred embodiments, less than about 0.03 inches, or, in some preferred embodiments, less than about 0.02 inches. In some illustrative embodiments, bristles can have a diameter of between about 0.005 to 0.05 inches, or, in some preferred embodiments, between about 0.0075 to 0.025 inches, or, in some preferred embodiments, between about 0.01 to 0.02 inches.”

“In some other alternative embodiments, the flexible member or flexible brush can include other types of flexible members, such as, e.g., an elastomeric member, a flexible rubber member, a flexible plastic or polymeric member, a flexible metal member, a flexible sponge and/or another flexible member. In preferred embodiments, the flexible member includes a plurality of independently flexible or substantially independently flexible portions proximate a distal end (e.g., a distal end that is situated to contact the expandable slit sheet paper). In some preferred embodiments, such independently flexible or substantially independently flexible portions contact a single cell in a widthwise direction (e.g., cross direction) across the expandable slit sheet paper, such that forces imparted from a single cell during opening is substantially imparted to such independently flexible or substantially independently flexible portions. For example, in a brush containing flexible bristles or wires, each such flexible bristle or wire is independently flexible or substantially independently flexible. It should be appreciated that in a brush containing numerous bristles, such bristles would not be entirely independently flexibly movable due to their close proximity, such that bristles would necessarily press against one another during use. For example, in some embodiments, a flexible member can include a flexible member, such as, e.g., a flexible rubber member, a flexible plastic or polymeric member, a flexible metal member, or a flexible sponge member having a distal end with depending regions, such as, e.g., depending nubs, or tines, or arms, or elements. In some embodiments, the flexible member can be a flexible rake, with substantially independently movable tines. By way of example, [FIG. 76] shows an illustrative embodiment employing a friction member *550 having a plurality of depending portions *551. In some embodiments, the member *550 can be a unitary member, made with a flexible plastic or polymer, a flexible metal, or a flexible sponge. The lengths L, widths W, and depths D of the depending portions *551 can be selected based on the materials employed. In some preferred embodiments, the widths W would be less than or equal to the corresponding widths of the slits of the expandable slit sheet paper, such as, e.g., less than or equal to about ½ inch, or, in some embodiments, less than or equal to ⅓ inch, or, in some embodiments, less than or equal to ¼ inch.”

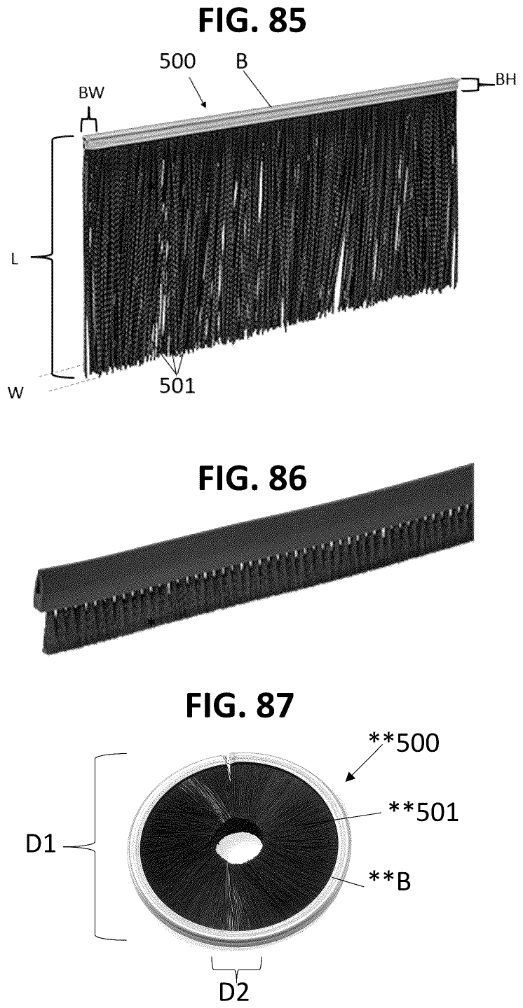

“In some illustrative and non-limiting embodiments, brushes employed can include brushes made by McMaster-Carr™ (https://www.mcmaster.com/catalog/129/1550/). By way of example, in some embodiments, as described at the above URL, brushes can include dense bristles that can be held in place by a binding wire. The larger the bristle diameter, the stiffer the bristles. Additionally, the shorter the bristle length, the less lateral flexibility at the distal ends of the bristles. In some embodiments, one or more of the bristles set forth at the above URL, which are inserted in [FIGS. 8A to 8I of the 18,586,916 application, wherein FIGS. 85-86 correspond to FIGS. 8A-8B of the 18,586,916 application] can be employed. In some illustrative preferred embodiments, the bristles employed can be the bristles identified by the red arrow in FIG. 8F [of the 18,586,916 application], including a “Tight-Seal Strip Brush” with Nylon bristles, supported by a galvanized steel backing that is 3/16 inches wide (see width BW in [FIG. 85]) by 7/32 inches high (see height BH in [FIG. 85]), with a 0.014 inch bristle diameter, and with an overall bristle length of 2 inches (see length L in [FIG. 85]).”

As further set forth in the section entitled “Further Discussion of Illustrative Embodiments” of the 18,586,916 application:

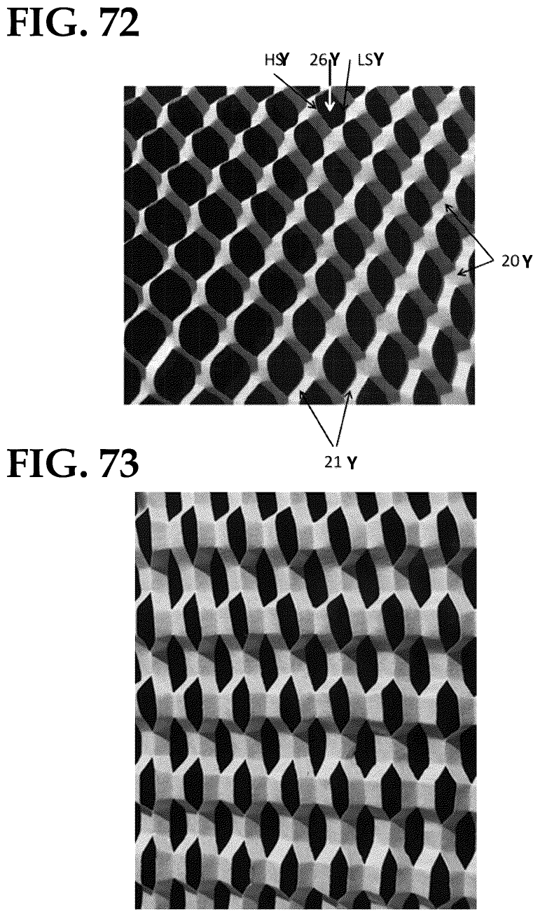

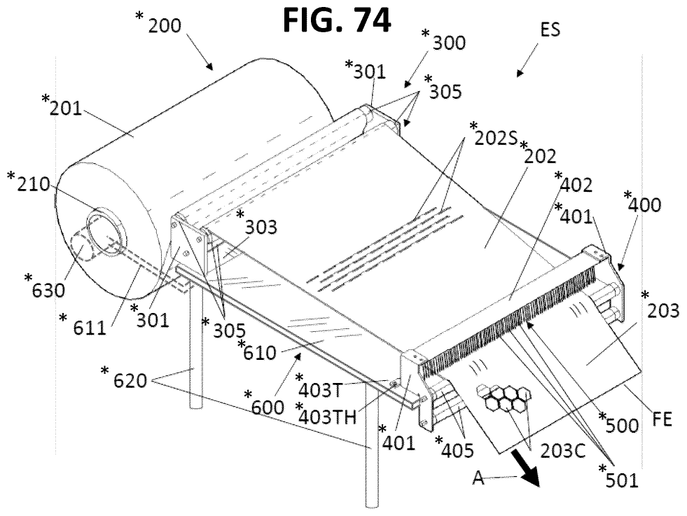

“With reference to [FIG. 74], [FIG. 74] is a top perspective view of an expansion system for expandable slit sheet paper employing a friction brush according to a first illustrative embodiment of the invention. In the illustrate example shown in [FIG. 74], an expansion system ES is provided that includes a brush friction member *500 made with a plurality of bristles *501.”

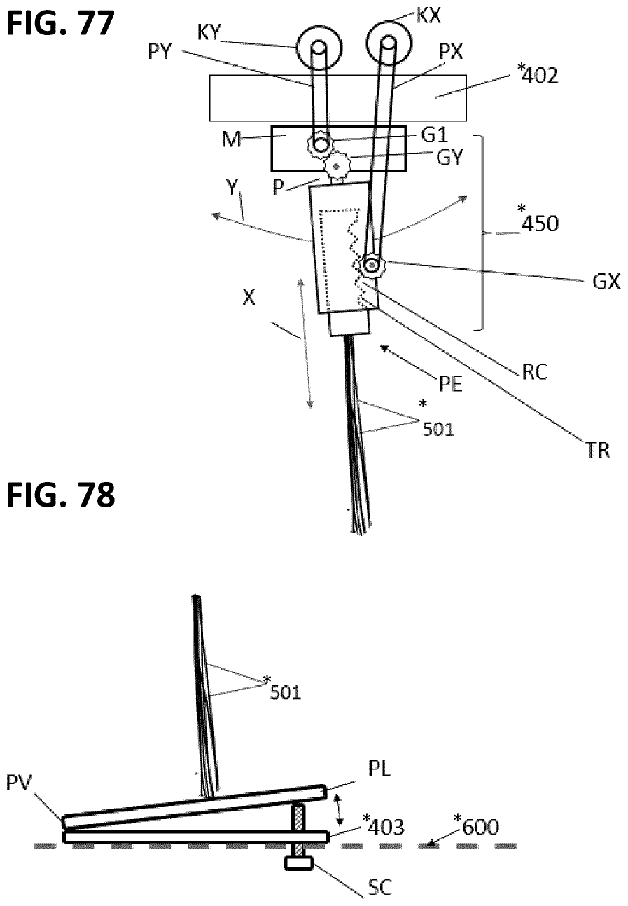

“As shown in [FIG. 74], the expansion system ES includes a roll *201 of expandable slit sheet paper *200 that is mounted upon a support member *600. In some embodiments, the support member *600 includes a table or other member having a support surface *610. In some illustrative embodiments, the support surface *610 includes at least one support holder *620 for locating the support surface *610, such as, by way of example, support holding legs or the like (as shown in [FIG. 74]). In the illustrated example, the roll *201 of expandable slit sheet paper *200 includes a central core member *210 (such as, e.g., a substantially cylindrical cardboard or corrugated board central core member) around which the expandable slit sheet paper *200 is wound. In the illustrated embodiment, the support member *600 further supports a support shaft *630 which is fixed to the support member *600 via a connecting member or connecting arm *611 (as shown in [FIG. 74]). In some preferred embodiments, the support shaft *630 is configured to axially receive the roll *201 of expandable slit sheet paper, which is wound around a central core *210. In some embodiments, the wound roll *201 can be axially slid around the support shaft *630 in a direction of the black arrow shown in [FIG. 77], and retained upon the support shaft via a retaining member, such as, e.g., an enlarged distal flange member *630H (as shown in [FIG. 77]). In some embodiments, the enlarged distal flange member has a diameter smaller than an inner diameter of the core *210 to facilitate axially sliding over the support shaft *630.”

“As shown in [FIG. 74], in the first illustrated embodiment, the expansion system ES includes a conveying roller guide *300 that guides the expandable slit sheet paper *200 after it separates from the roll *201. In the illustrated embodiment, the conveying roller guide *300 includes lateral conveying roller support walls *301 located at left and right lateral sides of the expansion system ES in a cross direction of the expandable slit sheet material. In some preferred embodiments, the support walls *301 are integrally formed with a lateral floor plate *303 that extends between the support walls, such as to form a U-shaped support bracket member, including the upright walls *301 as seen in [FIG. 77] that receive ends of at least one conveying roller(s)*305 and a lateral floor member *303 integrally connected to the upright walls *301 for placement upon and attachment to the support surface *610.”

“In the preferred embodiments, the conveying rollers each have a smoother outer surface and can be made out of any suitable material, including metals, plastics or polymers and/or other suitable materials. In some preferred embodiments, the conveying rollers include rotary bearings such that the conveying rollers rotate around center axes to facilitate downstream conveyance of the expandable slit sheet paper *200. In some preferred embodiments, the conveying rollers are non-rotatably fixed to the support walls *301 such that the expandable slit sheet paper slides around outer surfaces of the conveying rollers as a user manually grasps and pulls a leading distal end of the expandable slit sheet paper.”

“In some illustrative and non-limiting embodiments, conveying rollers employed can include rollers made by McMaster-Carr™ (https://www.mcmaster.com/catalog/2297t23/). In some illustrative embodiments, the conveying rollers can be substantially cylindrical members having a diameter of between about ½ inch and 3 inches, or, in some preferred embodiments, between about ¾ inch to 3½ inches long, or, in some preferred embodiments, between about 1 inch to 3 inches long, or, in some preferred embodiments, between about 1½ inches to 2½ inches long. In some illustrative and non-limiting embodiments, the rollers can be about 16 inches long, 0.78 inches diameter, PVC plastic rollers as shown in FIG. 9 [of the 18,586,916 application].”

“In some preferred embodiments, the conveying roller guide 300 includes three conveying rollers *305, as shown in [FIG. 74]. In some other embodiments, the conveying roller guide *300 can include less rollers (e.g., a single roller, or two rollers). In some other embodiments, the conveying roller guide *300 can include more rollers (e.g., four rollers, five rollers, or more).”

“In the preferred embodiments, the conveying roller guide *300 maintain the expandable slit sheet paper in a flat state. Additionally, in the preferred embodiments, the conveying roller guide *300 also applies some resistance to the expandable slit sheet paper as it is pulled in the direction of the arrow A shown in [FIG. 74]. In the preferred embodiments, the applied resistance is not sufficient to fully expand the cells of the expandable slit sheet paper. However, in preferred embodiments the resistance imparted at the conveying roller guide *300 is sufficient to cause the cells of the expandable slit sheet paper to begin expansion, such that the expandable slit sheet paper downstream of the conveying roller guide *300 is not fully flat and is not in a fully unexpanded state.”

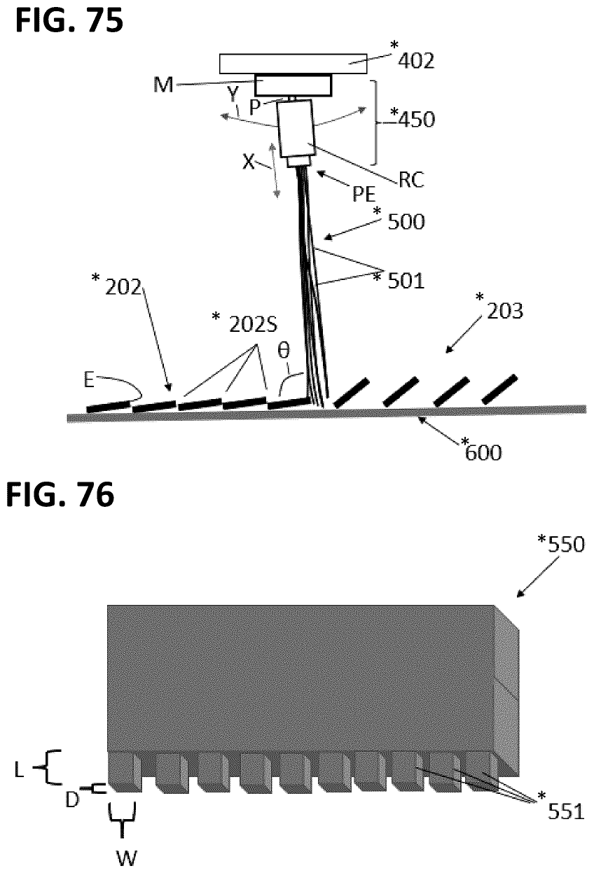

“Preferably, the expandable slit sheet paper within the region *202 that extends from the exit of the conveying roller guide *300 to the friction member unit *400 is in a state of beginning of expansion but prior to a state of full expansion. For example, as shown in [FIG. 75], in some embodiments the expandable slit sheet paper within the region *202 is preferably within a state in which lands (see, e.g., lands *20 shown in FIG. 2 [of the 18,586,916 application]) rotate slightly from the original plane of the paper. In this manner, the edges of the lands present a raised edge E that can be caught (e.g., abutted, frictionally engaged) by the ends of the bristles as shown in [FIG. 75]. Additionally, during the state of beginning of expansion, the expanded cells have begun to open but have not fully opened, which opening of the cells during the state of beginning expansion increases in amount from the initial fully-unopen state in which the expandable slit sheet paper is substantially flat or planar (such as, e.g., the state upon the roll *201 or directly after exiting the roll) to the state of full expansion (such as, e.g., at the region *203 of the expandable slit sheet paper downstream of the brush as shown in, e.g., [FIGS. 74 and 75]) in which the lands are at or substantially at their maximum angle with respect to the original plane of the expandable slit sheet paper and the slits are opened into fully expanded cells.”

“In some embodiments, the expandable slit sheet paper *200 in the region *202 is in a state of beginning expansion wherein the angle of the lands increases from substantially planar to between 1-50% of the angle of the lands in the state of full expansion, or, in some embodiments, between 2-25% of the angle of the lands in the state of full expansion, or, in some embodiments, between 3-20% of the angle of the lands in the state of full expansion, or, in some embodiments, between 4-15% of the angle of the lands in the state of full expansion, or, in some embodiments, between 5-10% of the angle of the lands in the state of full expansion. It should be appreciated that the angle of the lands in a full state of expansion depends upon the particular slit pattern and nature of the paper employed, including, for example, the lengths of slits, the distance between slits, and the distance between rows of slits, as well as the type of expansion pattern achieved by the expandable slit sheet paper (discussed below).”

“As shown in [FIG. 74], the expandable slit sheet paper within the region *202 that extends from the exit of the conveying roller guide *300 to the friction member unit *400 in the state of beginning of expansion as described above. Although the embodiment shown in [FIG. 74] includes a substantial distance of separation between the conveyor roller guide *300 and the friction member unit *400, the distance can be adjusted as desired. For example, in some embodiments, the conveyor roller guide *300 can be directly adjacent the friction member unit *400. Additionally, in some embodiments, the conveyor roller guide *300 can be integrated with the friction member unit *400; for example, the walls *301 and *401 can be formed as a unitary wall structure with the combined size of the walls shown in FIG. 5B [of the 18,586,916 application] in some embodiments.”

“In some illustrative embodiments, the friction member unit *400 is configured to be located at or proximate the edge of a support surface, such as, e.g., at the edge of the support surface *610 shown in [FIG. 74]. Among other things, such a placement can facilitate manual operation related to pulling of the expandable slit sheet paper without interference from the support surface *610 or the like.”

“In the first embodiment shown in [FIG. 74], the friction member unit *400 includes two lateral side walls 401 and a top cross-plate 402. As shown in [FIG. 74], the side walls 401 preferably include a flat lower edge that rests upon the surface 610, a depending section that extends downward alongside a front of the surface 610, as well as a horizontal plate region that extends over the top cross-plate 402 and includes holes or the like for inserting a bolt, screw or other connector to connect together the top cross-plate 402 and the respective side wall 401 and a horizontal plate region that extends parallel to and rests upon the surface 610 and includes holes or the like for inserting a bolt, screw or other connector to connect together the surface 610 and the respective side wall 401.”

“As shown in [FIG. 74], the friction member unit 400 is configured to support a friction member, such as, e.g., a friction brush 500 in a manner to extend laterally across the width of an expandable slit sheet paper that is pulled in the direction of the arrow A. In some illustrative embodiments, as shown in [FIG. 75], the friction member unit 400 can include an adjuster connector 450 that adjustably attaches the friction member (e.g., friction brush 500) to the friction member unit 400. In the preferred embodiments, the adjuster connector enables the friction member to be fixed to the friction member unit in a desired orientation and position. Preferably, the adjuster connector 450 is configured to enable the friction member to be raised and lowered in the direction of the double-sided arrow X shown in [FIG. 75]. Additionally, preferably, the adjuster connector 450 is configured to enable the friction member to be angularly adjusted to a desired angular position in the direction of the double-sided arrow Y shown in [FIG. 75], such as to adjust the angle θ between the brush and the expandable slit sheet paper. In some illustrative embodiments, the adjuster connector 450 is mounted to the underside of the top cross-plate 402 via a mounting plate M that pivotally supports a receiving channel member RC that receives a proximal end PE of the friction brush 500. In some preferred embodiments, the proximal end PE of the friction brush (e.g., which can include, e.g., a backing B for supporting the bristles {such as, e.g., an elongated channel member} as shown in the illustrative examples of FIGS. 8A-8I [of the 18,586,916 application, wherein FIGS. 85-86 correspond to FIGS. 8A and 8B of the 18,586,916 application]. In some embodiments, the depth of the backing B supported within the receiving channel member can be fixed employing a fixing bolt or the like which fixes relative positions. In some embodiments, the angular position of the receiving channel RC with respect to the mounting plate M can be fixed employing a fixing bolt or the like which fixes relative positions. In some embodiments, the angular orientation in the direction Y and the raised and lowered position in the direction X can be adjusted and set by rotation of respective dials that mechanically fix relative positions via ratchet mechanisms, friction mechanisms or the like.”

“In preferred embodiments in which the vertical position (e.g., X direction) and/or the angular orientation (e.g., Y direction) of the friction member or brush 500 can be adjusted, the amount of resistance or force imparted by the friction member or brush 500 to the expandable slit sheet paper can be adjusted or set as desired and/or based on circumstances. For example, in some circumstances an operator can adjust the vertical position and/or the angular orientation to, thus, adjust the resistance applied by the friction member for expanding of an expandable slit sheet paper to a) fine tune the operation, b) adapt to new expandable slit sheet papers (e.g., if new rolls 201 of expandable slit sheet papers are used having different slit patterns, paper qualities or the like), c) re-set the resistance imparted in the event that the friction member (e.g., the bristles 501 of a brush) wear or change over time based on use, and/or d) accommodate a new friction member having different properties from a previously employed friction member. For example, in some embodiments, in the event that bristles of a friction brush wear over time and lose strength and, thus, increase in flexibility, resulting in a decrease in resistance imparted to the expandable slit sheet paper, a user can increase to resistance to a desirable level with the adjustment connector 450 by increasing the angle θ (e.g., to an angle closer to 90 degrees or even beyond 90 degrees) and/or by increasing the distance X such that the distal ends of the bristles extend further downward from the top cross-plate 402 and, thus, increase the resistance or force applied against the expandable slit sheet paper.”

“With reference to [FIG. 77], [FIG. 75] shows an illustrative structure by which the angular orientation in the direction Y and the raised and lowered position in the direction X can be adjusted and set by rotation of respective dials according to some illustrative embodiments. As shown in [FIG. 75], in some embodiments, the top cross plate can include a first rotary dial KY for manually adjusting the angular orientation in the direction Y, and the top cross plate can include a second rotary dial KX for manually adjusting the raised and lowered position in the direction X.”

“In this illustrative example, rotation of the dial KY, which is fixed to a the top cross-plate 402, imparts rotation of the pulley PY, which results in rotation of the gear G1 which is fixed to the mounting plate M. As shown, the gear G1 has perimeter teeth that engage with perimeter teeth of a second gear GY. The second gear GY is mounted on the mounting plate M in a manner to rotate around a central axis. The second gear GY is also fixedly connected to the receiving channel RC, whereby rotation of the gear causes an angular displacement of the receiving channel RC in the direction Y such that the receiving channel RC pivots around the center axis of the second gear GY as a pivot P. In this manner, by rotating the dial KY to a select position, the angular position of the receiving channel RC and, hence, the angle of the friction member supported thereby can be selectively adjusted. In the preferred embodiments, the position of the dial can be maintained by a) locking the dial KY in a selected position (e.g., with a pin or detent member), b) frictionally retaining the dial in a selected position with a friction element that contacts the dial KY and requires a sufficient force (such as, e.g., by applying a manual rotation force on the dial KY to overcome the force of the friction element, c) or the like.”

“In this illustrative example of [FIG. 75], rotation of the dial KX, which is also fixed to a the top cross-plate 402, imparts rotation of the pulley PX, which results in rotation of the gear GX which is fixed to the receiving channel RC. As shown, the gear GX has perimeter teeth that engage with a tooth rack TR along a side of the proximal end PE of the brush member 500 (e.g., in some examples, such a tooth rack TR can be formed along a side of a backing B similar to the backings shown in FIGS. 8A-8I [of the 18,586,916 application]). In this manner, by rotating the dial KX to a select position, the vertical position of the friction member 500 can be selectively adjusted. In the preferred embodiments, the position of the dial KX can also be maintained by a) locking the dial KX in a selected position (e.g., with a pin or detent member), b) frictionally retaining the dial in a selected position with a friction element that contacts the dial KX and requires a sufficient force (such as, e.g., by applying a manual rotation force on the dial KX to overcome the force of the friction element, c) or the like.”

“In some alternative embodiments, rather than or in addition to having the friction member or brush 500 being made adjustable in the direction Y and/or the direction X as described herein, as shown in [FIG. 78] the friction unit 400 can include an adjuster plate PL that is located underneath the friction member or brush 500. In some embodiments, the adjuster plate PL is mounted upon a floor plate 403 that extends between and is connected to the bottom ends of the support walls 401. In some other embodiments, an adjuster plate can be directly mounted upon or supported upon the support member 600. In the example depicted in [FIG. 78], the support plate PL can be raised or lowered such as to move towards or away from the distal end of the brush member or brush 500 via, for example, a pivot connection PV between the support plate PL and the floor plate 403, in conjunction with an adjustor SC, such as, e.g., a bolt or screw or other mechanical mechanism, that can be adjusted to vary the position of the PL in the directions up-and-down depicted by the double-sided arrow shown in [FIG. 78]. In some other embodiments, the support plate PL can be mounted in a manner to adjust both the angle at the PV as well as the height towards the friction member 500. In some other embodiments, rather than being pivoted at the pivot PV or the like, the support plate PL can be raised and lowered while in a non-varying angle with respect to the friction or brush member, such as e.g., maintaining a substantially parallel nature with respect to the support member 600.”

“In summary, in some preferred implementations, in the operation of the first embodiment, at least some of the following steps can be performed:”

“First, a user places a roll 201 of expandable slit sheet paper upon the a support shaft 630 (such as, e.g., by laterally axially sliding the roll 201 over the end of the support shaft 630.”

“Second, a user manually pulls the distal free-end (see, e.g., FE in [FIG. 74]) of the expandable slit sheet paper 200, an directs the paper over the closest of the three conveying rollers 305, down under the lowest (e.g., middle roller) of the conveying rollers 305, and back over the top side of the third conveying roller 305.”

“Third, the user manually pulls the free end FE towards the friction member unit 400, and then directs the free end FE underneath the distal end of the friction member or brush 500. In some preferred embodiments, in which the position of the friction member or brush 500 is adjustable (such as, e.g., employing an adjuster connector 450 as described herein), in order to facilitate directing of the free end FE underneath the distal end of the friction member or brush 500, a user can adjust the friction member or brush by raising and/or angularly tilting the friction member or brush 500 such that the distal end of the bristles (or other friction member) are raised and sufficiently separated from the surface 610 to facilitate directing the free end FE of the expandable slit sheet paper 200 underneath the friction member or brush 500 towards a position similar to that shown in [FIG. 74].”

“Fourth, after the expandable slit sheet paper 200 is located upon the expansion system to a position similar to, e.g., that shown in [FIG. 74], in some preferred embodiments the user can set the position of the friction member or brush 500 to an operating or use position so that the friction member or brush 500 imparts sufficient resistance against the expandable slit sheet paper 200 when a user manually pulls the distal end region in the direction of the arrow A shown in [FIG. 74]. For example, in some embodiments, a user can adjust the resistance applied by the friction member or brush 500 employing an adjuster connector 450 or another adjuster that is adapted to enable adjustment of the position (e.g., distance from surface 610 and/or orientation) of the friction member or brush 500.”

“Fifth, after the expandable slit sheet paper 200 is installed and the expansion system ES is ready for use, a user preferably manually pulls the distal end of the paper and causes some or all of the expandable slit sheet paper 200 in the region 203 downstream from the friction member unit 400 to the free end FE such as to expand the cells to a state of full expansion or substantially a state of full expansion such as to include fully or substantially open cells 203C as shown in [FIG. 74].”

“Sixth, then a user can wrap the expanded slit sheet paper around an item and tear the expandable slit sheet paper within the region 203 once wrapped around the item or, alternatively, the user can tear off a second of the expanded slit sheet paper within the region 203 and then wrap the expandable slit sheet paper around an item. Although the expansion system shown in [FIG. 74] is preferably employed in the context of the wrapping of items, which items can be, e.g., placed within a package, box, container or the like for shipping, storage or the like, in other embodiments the expandable slit sheet paper can be employed for any other desired purposes. For example, in some embodiments, the expanded slit sheet paper can be rolled, bunched or the like and placed within a package, box, container or the like as package [void] fill, rather than and/or in addition to use as a wrap around one or more item. As another example, in some embodiments, the expanded slit sheet paper can be used to wrap and/or support large items and/or to be stretched around or across large surfaces, such as, e.g., for use as a pallet wrap (see, e.g., U.S. patent application Ser. No. 17/802,012, the entire disclosure of which is incorporated herein by reference).”

“Although the embodiment shown in [FIG. 74] depicts the shaft 630 mounting the roll 201, the conveyor roller guide 300, the surface 610 and the friction member unit 400 in a substantially horizontal orientation, various other embodiments can be implemented in which the orientations of some or all of the shaft 630, the conveyor roller guide 300, the surface 610, and the friction member unit 400 can be non-horizontally oriented. For example, in some embodiments, the shaft 630 mounting the roll 201, the conveyor roller guide 300, the surface 610 and the friction member unit 400 can be vertically or substantially vertically oriented (such as, e.g., when a similar expansion system is used to wrap pallets). Additionally, the orientations of the shaft 630 mounting the roll 201, the conveyor roller guide 300, the surface 610 and the friction member unit 400 can be any angle between 0-360 degrees from horizontal. Notably, the device could even be mounted overhead (e.g., upside-down from that shown in [FIG. 74] by inverting 180 degrees) whereby a user can access and manually grasp the expandable slit sheet paper from overhead. Among other things, overhead arrangements can be employed for space-saving considerations, ergonomic considerations and/or the like in various implementations.”

“With further reference to the first embodiment shown in [FIG. 74], in this illustrative embodiment the friction member unit 400 further includes at least one conveyor roller 405 (two shown in the illustrated embodiment) to facilitate smooth and uninhibited pulling of the expandable slit sheet paper 200 after it has been expanded at the friction member unit 400. In the preferred embodiments, the conveyor roller(s) 405 can include any of the same rollers as described herein employed as conveyor rollers 305.”

“FIGS. 3 [of the 18,586,916 application] and [FIG. 83] both depict expandable slit sheet papers in a state of full expansion in which the expandable slit sheet paper expands into a common expansion pattern, in which fully expanded cells form open cells with land regions 20 that extend in a like direction with low sides LS and high sides HS of the lands as shown. In this manner, the open cells of this common expansion pattern include low and high sides as shown in [FIG. 83].”

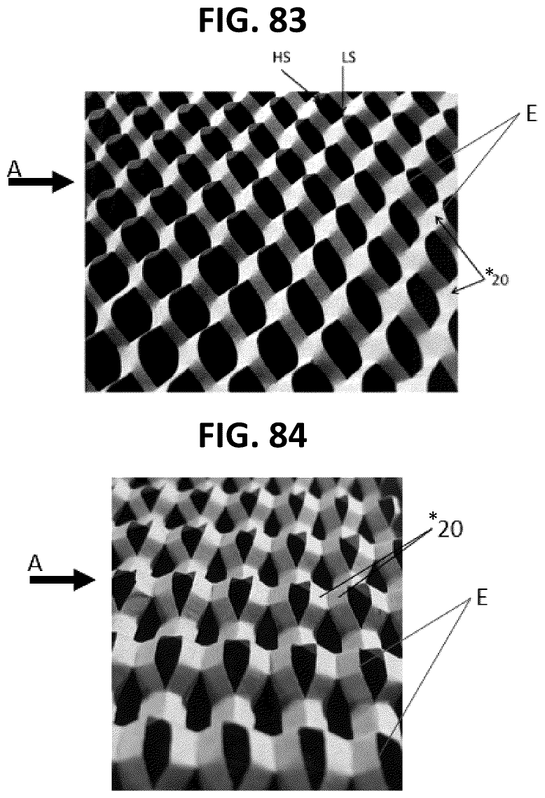

“On the other hand, [FIG. 84] depicts an expandable slit sheet paper in a state of full expansion in which the expandable slit sheet paper expands into a novel expansion pattern as described in the present inventor's U.S. Pat. No. 11,401,090, in which fully expanded cells form open cells with land regions 20 that are bent into a substantially V-shape with downwardly extending portions and upwardly extending portions connected together. In this manner, the open cells of this novel expansion pattern include opposite sides that are at like levels as shown in [FIG. 84]. Additionally, the novel expansion pattern also includes alternating rows in which cells open in opposite directions.

“In the preferred embodiments, the friction member, such as, e.g., a friction brush having a plurality of bristles, can frictionally engage the expandable slit sheet papers of [FIGS. 83 and 84], such as, e.g., by engaging the leading or raised edges E of the lands as the expandable slit sheet paper is pulled in the direction of the arrows A shown. Although [FIGS. 83 and 84] depict states of full expansion, it should be appreciated that in the state of beginning expansion, the expandable slit sheet paper will twist slightly from the initial fully unexpanded state towards the respective patterns shown in the figures.”

“In the context of an expandable slit sheet paper that expands into the novel expansion pattern of [FIG. 84], due to the symmetrical nature of the expanded cells (e.g., with similar heights of the cells on forward and rearward sides of the open cells), the operation of the friction member, such as, e.g., a friction brush, will advantageously be the same regardless of the direction of the pulling of the paper shown at arrow A.”

“In the context of an expandable slit sheet paper that expands into the common expansion pattern of [FIG. 83], due to the asymmetrical nature of the expanded cells (e.g., with high sides and low sides of the cells on forward and rearward sides of the open cells), the operation of the friction member, such as, e.g., a friction brush, will be facilitated when the expansion of the cells is similar in relation to the direction of the pulling of the paper like that shown in [FIG. 83]. Nevertheless, in various embodiments, such a friction member can be employed for the expansion into a common expansion pattern regardless of the direction of the arrow A with respect to the angles of the lands. Additionally, in some embodiments, the friction member, such as, e.g., a friction brush, can advantageously initiate expansion of the cells of the expandable slit sheet paper such as to assume an expansion similar to that shown in [FIG. 83] in relation to the direction of the arrow A; for example, in some embodiments, the friction member can engage the leading edges E in such a manner as to coax or push the leading edges E in a direction of opening similar to that shown in [FIG. 83].”

As further set forth in the section entitled “Further Discussion of Illustrative Embodiments” of the 18,586,916 application:

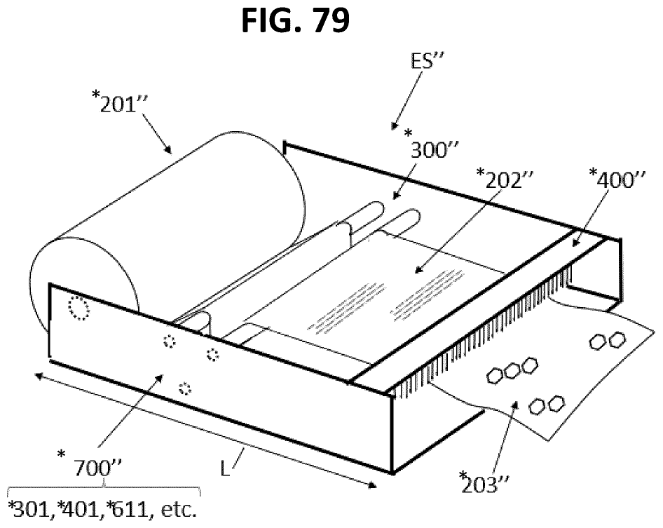

“With reference to [FIG. 79], [FIG. 79] is a top perspective view of an expansion system for expandable slit sheet paper employing a friction brush according to a third illustrative embodiment of the invention. The embodiment shown in [FIG. 79] is similar to that shown in [FIG. 74] and [FIG. 5B of the 18,586,916 application]. In [FIG. 79], same or similar elements to that shown in [FIG. 74] and [FIG. 5B of the 18,586,916 application] include the same numbers followed by a quote (ax). It should be appreciated that some or all aspects or features of these same or similar elements can be the same or similar to that of the corresponding elements within the first and second embodiments.”

“In particular, the embodiment shown in [FIG. 79] involves a unitary expansion system ES″ that includes a single support or frame 700″ for supporting a roll 201″ of expandable slit sheet paper, a conveyor roller guide 300″, and a friction member unit 400″, which are similar to the corresponding structure in the first and second embodiments. For example, as depicted in [FIG. 79], the support or frame 700″ can perform supporting functions including that of, e.g., elements 301, 301, 611 etc., shown in [FIG. 74]. In the illustrative third embodiment shown in [FIG. 79], the expansion system ES″ can be managed and handled as a unitary item with all component parts supported by the same support or frame 700″.

“In some variations of the embodiment shown in [FIG. 79], the unitary expansion system ES″ can be constructed with a shorter length L, such as, e.g., by reducing the length of the region 202″, such that the conveyor roller guide 300″ and the friction member unit 400“are directly adjacent one another.”

“In some variations of the embodiment shown in [FIG. 79], the unitary expansion system ES″ can be provided without any conveyor roller guide 300″, such that the friction member unit 400″ is employed for imparting required resistance to enable expansion without such a conveyor roller guide 300″. Notably, in some variations of all of the embodiments of expansion systems (e.g., ES, ES′, ES″, ES′″, ES″″) disclosed herein, conveyor roller guides (e.g., 300, 300′, 300″, 300′″, 300″″) can be omitted.”

“In the third embodiment shown in [FIG. 79], the expansion system ES″ does not include a conveying roller adjacent (e.g., downstream) of the friction member unit 400″. However, in alternate embodiments, the expansion system ES″ can be adapted to include one or more conveying rollers downstream of the friction member unit 400” similar to that shown and described with reference to other embodiments described herein.”

As further set forth in the section entitled “Further Discussion of Illustrative Embodiments” of the 18,586,916 application:

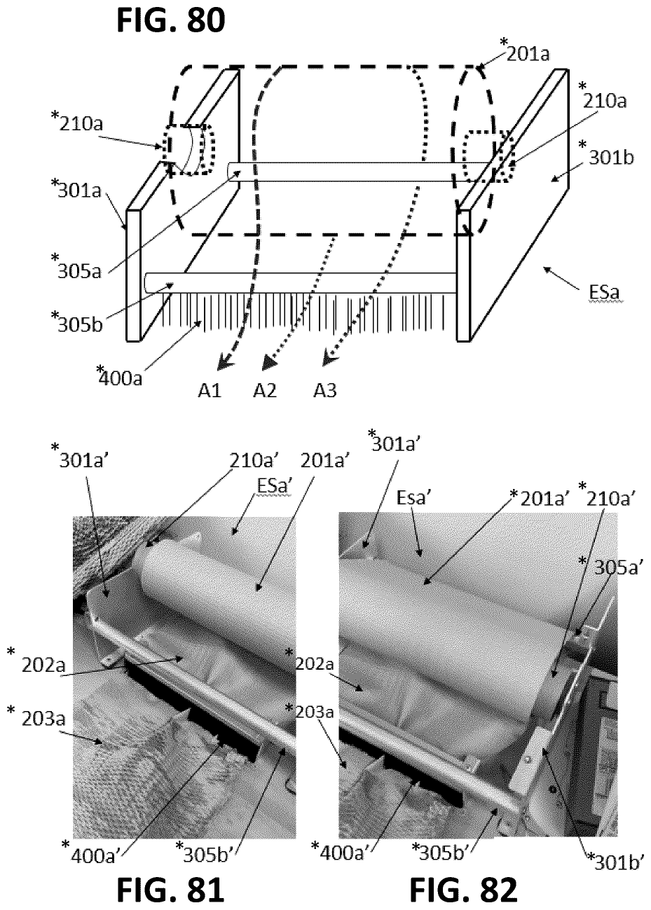

“With respect to [FIG. 80] and [FIGS. 81-82], these figures show perspective views of expansion systems for expandable slit sheet paper employing friction brushes according to other embodiments of the invention.”

“In [FIG. 80] and [FIGS. 81-82], same or similar elements to that shown in the foregoing embodiments include the same numbers followed by an a, a′, b, or b′. It should be appreciated that in some implementations some or all aspects or features of these same or similar elements can be the same or similar to that of the corresponding elements within the foregoing embodiments.”

“The embodiments shown in [FIG. 80] and [FIGS. 81-82] are similar to the first embodiment shown in [FIG. 74]. The embodiment shown in [FIGS. 81-82] are photographs of an actual expansion system formed in a manner similar to that depicted in the drawing shown in [FIG. 80]. Together, [FIGS. 81 and 82] show a complete perspective view of the same expansion system. In the embodiments shown in [FIG. 80] and [FIGS. 81-82], an expansion system ESa, ESa′ is provided that includes a compact frame structure. In the embodiment shown in [FIG. 80], a frame structure is provided that includes a first side wall 301a and a second side wall 302b which are connected together with a first rod or shaft 305a and a second rod or shaft 305b. Similarly, in the embodiment shown in [FIGS. 81-82], a frame structure is provided that includes a first side wall 301a′ and a second side wall 301b′ which are connected together with a first rod or shaft 305a′ and a second rod or shaft 305b′.”

“In the illustrated embodiments shown in [FIG. 80] and [FIGS. 81-82], the first rod or shaft 305a, 305a′ has a smooth perimeter surface around which the expandable slit sheet paper feeds from a roll 201a, 201a′ of expandable slit sheet paper during use. In the preferred embodiments, the outer perimeter surface of the first rod or shaft 305a, 305a′ is cylindrical or substantially cylindrical (i.e., having a circular or substantially circular cross-sectional shape). In other embodiments, the outer perimeter surface of the first rod or shaft 305a, 305a′ can have other configurations, such as, e.g., square, pentagonal, hexagonal, or another shape. In the preferred embodiments, a region of contact between the first rod or shaft 305a, 305a′ and the expandable slit sheet paper that extends around the first rod or shaft 305a, 305a′ is curved or arcuate such as to present a smooth and continuous guide surface for the expandable slit sheet paper as the expandable slit sheet paper is pulled around the perimeter surface of the first rod or shaft 305a, 305a′. In the preferred embodiments, the first rod or shaft is non-rotatably fixed to the first and second side walls. However, in some alternative embodiments, the first rod or shaft can be rotatably fixed to the first and second side walls. In the preferred embodiments, the first rod or shaft provides a function similar to the conveyor roller guide(s) and/or the friction member unit guide(s) described above in relation to the foregoing embodiments.”

“Although the illustrated embodiments shown in [FIG. 80] and [FIGS. 81-82] include a single first rod or shaft 305a, 305a′, in various modifications, the expansion systems ESa, ESa′ can include multiple first rods or shafts, such as, e.g., two, three or more first rods or shafts in some implementations. For example, in some implementations, three first rods or shafts can be provided in a substantially triangular arrangement similarly to that shown in [FIG. 79]. However, in some preferred embodiments, only a single first rod or shaft is provided as shown in [FIG. 80] and [FIGS. 81-82].”

“Additionally, in other variations of the embodiments shown in [FIG. 80] and [FIGS. 81-82], the first rod or shaft can be omitted. In the latter variation, the expandable slit sheet paper can be fed downstream directly to the brush or friction member without passing around such a first rod or shaft. Similarly, in some embodiments employing a first rod or shaft, in use, rather than feeding the expandable slit sheet paper downstream around the first rod or shaft and then to the brush or friction member, the expandable slit sheet paper can alternatively (i.e., in some alternative implementations or methods of use) be fed from the periphery of the roll of expandable slit sheet paper directly to the brush or friction member.”

“In various implementations, the roll of expandable slit sheet paper of the embodiments shown in [FIG. 80] and [FIGS. 81-82] can be removably mounted to the first and second side walls by employing any of the mounting structures shown in the following U.S. Patents and U.S. Patent Publications, the entire disclosures of which are incorporated herein by reference as if recited herein in full: (1) U.S. Pat. No. 11,220,395, (2) U.S. Pat. No. 11,608,222, (3) U.S. Pat. No. 11,479,009, (4) U.S. Patent Application Publication No. 2021/0315426, and (5) U.S. Patent Application Publication No. 2019/0248092.”

“By way of example, as shown in [FIG. 80] and [FIGS. 81-82], in some embodiments, the roll of expandable slit sheet paper is mounted upon an elongated central core member having a length greater than a width of the roll such as to extend outwardly from the ends of the roll as shown in [FIG. 80] and [FIGS. 81-82](e.g., ends 210a in [FIG. 80] and ends 210a′ in [FIGS. 81-82]). In some embodiments, the first and second side walls can include cut-out regions or holes (e.g., yokes) for rotatably receiving the extended regions of the core member similarly to that shown in [FIG. 81]. In some embodiments, a first of the side walls can include a cut-out region or hole (e.g., yoke) for rotatably receiving one of the extended regions of the core member similarly to that shown in [FIG. 81], and a second of the side walls can include a support projection that extends partly within the other end of the core member similarly to that shown in [FIG. 82], whereby a user can slide the end of the core member over a support projection as shown in [FIG. 82] and then rest the opposite end of the core member within a yoke similarly to that shown in [FIG. 81]. As indicated above, [FIG. 81] and [FIG. 82] are views of the same device, with [FIG. 81] more completely showing the first support wall 301a′ and related structure and [FIG. 82] more completely showing the second support wall 301b′ and related structure according to some embodiments.”

“As shown in [FIG. 80] and [FIGS. 81-82], the expansion systems ESa, ESa′ also include a friction member 400a, 400a′ that is similar to the friction members of the foregoing embodiments. In some embodiments, any of the friction members described herein-above related to the foregoing embodiments can be employed in various implementations of the embodiments shown in [FIG. 80] and [FIGS. 81-82]. In the illustrative implementation of the embodiments shown in [FIG. 80] and [FIGS. 81-82], the friction member is mounted to the second rod or shaft members 305b, 305b′. In other embodiments, a friction member can be mounted to the frames via other structures.”

“In the illustrative embodiments shown in [FIG. 80] and [FIGS. 81-82], the friction member is formed with the same or similar structure to that of any of the friction members described herein above. Similarly, in some variations, the friction member can have i) having a varied structure (e.g., employing a different type of friction member or employing a similar friction member (such as, e.g., a brush having bristles with different qualities or characteristics, such as, e.g., different flexibility, length, diameter, etc.) and/or by ii) adjusting the positioning of the friction member (e.g., distance from the surface and/or angular orientation) in a similar manner to that described above with respect to the foregoing embodiments.”

“As with some of the foregoing embodiments, in the embodiments shown in [FIG. 80] and [FIGS. 81-82], the rod(s) or shaft(s) 305a, 305a′ can help maintain the expandable slit sheet paper in a flat state. Additionally, in the preferred embodiments, the rod(s) or shaft(s) 305a, 305a′ also apply some resistance to the expandable slit sheet paper as it is pulled in the direction of the arrows A1, A2 or A3 shown in [FIG. 80]. In the preferred embodiments, the applied resistance is not sufficient to fully expand the cells of the expandable slit sheet paper. However, in some preferred embodiments the resistance imparted by such rod(s) or shaft(s) 305a, 305a′ is sufficient to cause the cells of the expandable slit sheet paper to begin expansion, such that the expandable slit sheet paper downstream of the rod(s) or shaft(s) 305a, 305a′ is not fully flat and is not in a fully unexpanded state. In some preferred embodiments, the expandable slit sheet paper within the region 202a that extends from the exit of the rod(s) or shaft(s) 305a, 305a′ to the friction member 400a, 400a′ is in a state of beginning of expansion but prior to a state of full expansion similarly to that described above with respect to, e.g., the first, second and third embodiments. Additionally, preferably the expandable slit sheet paper within the region 203a downstream of the friction member 400a, 400a′ is in a state of full expansion in which the lands are at or substantially at their maximum angle with respect to the original plane of the expandable slit sheet paper and the slits are opened into fully expanded cells similarly to that described above with respect to the first, second and third embodiments.”

“In some variations of all of the embodiments of [FIG. 80] and [FIGS. 81-82], the respective friction members 400a, 400a′ can include multiple friction members or brushes, such as, e.g., two, three or more friction members or brushes.”

“In some embodiments, components (e.g., the side wall members and the rods or shafts) of the embodiments of [FIG. 80] and [FIGS. 81-82] can be made with metal (e.g., aluminum) or other rigid material. Additionally, in some embodiments, the roll 201a, 201a′ of expandable slit sheet paper is mounted to freely rotate upon the support or frame. In some embodiments, the expansion system can be adapted to apply some resistance to the rotation of the roll 201a, 201a′ similarly to that described above (such as, e.g., in relation to FIG. 5G [shown in parent application Ser. No. 18,586,916]). In the preferred embodiments, the expansion system does do not apply sufficient resistance to the rotation of the roll 201a, 201a′ to cause the expandable slit sheet material to expand to create open cells if manually pulled by a user (e.g., pulled in a manner similar to that shown in FIG. 4 [shown in parent application Ser. No. 18,586,916]). However, if desired, such a friction member can be added to reduce requirements of mechanisms (described below) downstream of the roll within the expansion system for imparting resistance required to expand the expandable slit sheet paper.”

“With reference to [FIGS. 80-82], in the preferred implementation, a roll of expandable slit sheet material is supported on the expansion system such that a distal end of the expandable slit sheet paper is directed from the perimeter of the roll 201a, 201a′ proximate the upper end of the roll, to extend around the rod or shaft 305a, 305a′, and then to extend underneath the roll (i.e., preferably, without contacting a bottom surface of the roll), and then to extend underneath the friction member 400a, 400a′ (such as, for example, underneath distal ends of bristles of a brush), such that upon a user manually pulling of the distal end of the expandable slit sheet paper, the expandable slit sheet paper will follow a path A3 shown in dotted lines in [FIG. 80] and as also shown in [FIG. 82].”

“Although the path A3 of the expandable slit sheet paper, in which the expandable slit sheet paper first extends around the rod or shaft *305a, *305a′ and then proceeds downstream beneath the friction member *400a, *400a′, has substantial advantages and is employed in some preferred embodiments, in some alternative implementations a user can direct the expandable slit sheet paper along different paths from the perimeter of the roll *201a, *201a′ beneath the friction member *400a, *400a′. For example, as shown in [FIG. 80], in some implementations, rather than having the expandable slit sheet paper extend around the rod or shaft *305a, *305a′, the expandable slit sheet paper can be pulled directly from a lower end of the roll in the direction of the arrow A2 shown in [FIG. 80] and beneath the friction member *400a, *400a′. In this alternative embodiment, the expandable slit sheet paper can, thus, be directed a shorter distance from the perimeter of the roll directly to beneath the friction member.”

“In the implementations in which the expandable slit sheet paper follows either the path of arrow A3 or the path of arrow A2, the direction of the rotation of the roll *201a, *201a′ is the same (e.g., in either case in the example shown in [FIG. 80], the roll would rotate in a clockwise direction as seen at rightmost edge of the roll in [FIG. 80]). In another alternative implementation, rather than having the expandable slit sheet paper extend around the rod or shaft *305a, *305a′, the expandable slit sheet paper can be pulled directly from an upper or front end of the roll in the direction of the arrow A1 shown in [FIG. 80] and beneath the friction member *400a, *400a′ (e.g., in contrast to the arrows A2 and A3, in this case of the arrow A1, the roll would rotate in a counter-clockwise direction as seen at rightmost edge of the roll in [FIG. 80]). In this alternative embodiment, the expandable slit sheet paper can, thus, similarly be directed a shorter distance from the perimeter of the roll directly to beneath the friction member. However, in this latter example, the expandable slit sheet paper would not proceed towards the friction member in a manner that is as parallel to the plane of the support surface (e.g., table top or the like) as in implementations in which the paper follows a path A2 or A3.”

“In the embodiments shown in [FIG. 80 and FIGS. 81-82], the friction member *400a, *400a′ operates to impart frictional resistance causing the expandable slit sheet paper to expand into open cells by having the distal end of the friction member (e.g., distal ends of bristles of a brush) in close proximity or in contact with a support surface (e.g., a table top or the like) upon which the expansion system ESa, ESa′ is supported during use. In some alternative embodiments, the support or frame can include a bottom plate member or the like that extends beneath the friction member, such that the friction imparted by the friction member is not dependent on the structure of the support surface beneath the expansion system ESa, ESa′.”

“Although various illustrative manual expansion systems are described herein above, any-and-all of the embodiments described herein can be implemented within automated expansion systems. For example, rather than having a user manually grasp a distal end of the expandable slit sheet paper, any-and-all of the embodiments described herein can be implemented in an environment in which a distal end of the expandable slit sheet paper is engaged for expansion via one or more automated drive roller. For example, in some embodiments, systems and methods for pulling and advancing expandable slit sheet paper as described in any of the U.S. Patents and U.S. Patent Application publications described herein can be employed, and, in some embodiments, systems and methods for pulling and advancing expandable slit sheet paper as described in U.S. Pat. No. 11,691,374 can be employed. For example, in some embodiments, a distal end of the expandable slit sheet paper can be grasped between a plurality of rollers, wherein the rollers have friction elements configured to engage the expandable slit sheet paper, such as, e.g., hooks (e.g., Velcro hooks), rubber pips or projections, or other friction members configured to engage the slits of the expandable slit sheet paper.”

As further set forth in the section entitled “Further Discussion of Illustrative Expandable Slit Sheet Papers Employed in Various Illustrative Embodiments” of the 18,586,916 application:

“In some of the preferred embodiments, the expandable slit sheet paper employed can be made from any type of paper sheet, such as, e.g., a paper made with fibers, such as, e.g., natural fibers, plant-based fibers, cellulose fibers, or the like. In some embodiments, the paper is a Kraft paper. In some embodiments, the paper is an extensible paper, such as, e.g., any of the extensible papers describe in U.S. Pat. No. 10,669,086, the entire disclosure of which is incorporated herein by reference as if recited herein in full. In the preferred embodiments, the paper is made of a recyclable paper material. In some embodiments, the paper can be made entirely from recycled paper. In some embodiments, the paper can be made entirely from virgin, non-recycled, paper. In some embodiments, the paper can be made with a combination of recycled paper and virgin paper. In some embodiments, the paper is a paper that weighs greater than 25 pounds (lbs.) per 3,000 square feet (i.e., 25 # paper). In some embodiments, the paper is a paper that weighs greater than 30 pounds per 3,000 square feet (i.e., 30 # paper). In some embodiments, the paper is a paper that weighs greater than 40 pounds per 3,000 square feet (i.e., 40 # paper). In some embodiments, the paper is a paper that weighs greater than 40 pounds per 3,000 square feet (i.e., 40 # paper). In some embodiments, the paper is a paper that weighs greater than 50 pounds per 3,000 square feet (i.e., 50 # paper). In some embodiments, the paper is a paper that weighs greater than 60 pounds per 3,000 square feet (i.e., 60 # paper). In some embodiments, the paper is a paper that weighs greater than 70 pounds per 3,000 square feet (i.e., 70 # paper). In some embodiments, the paper is a paper that weighs between about 30 pounds per 3,000 square feet to 70 pounds per 3,000 square feet. In some embodiments, the paper is a paper that weighs between about 40 pounds per 3,000 square feet to 60 pounds per 3,000 square feet. In some embodiments, the paper is a paper that weighs between about 35 pounds per 3,000 square feet to 55 pounds per 3,000 square feet. In some embodiments, the paper is a paper that weighs between about 45 pounds per 3,000 square feet to 55 pounds per 3,000 square feet. In some embodiments, the paper is a paper that weighs between about 30 pounds per 3,000 square feet to 70 pounds per 3,000 square feet. In some embodiments, the paper is a paper that weighs between about 50 pounds per 3,000 square feet to 60 pounds per 3,000 square feet.”

“The reduction in the force required to expand the [extensible] slit paper enables a new product to be created using lighter weight papers. In the past, expanded slit sheet paper is primarily used as a wrapping product whereas its use as a void fill would be in limited circumstances due to void fill being typically the cheapest, that is, the lowest cost of all packaging products. The increased strength of the extensible sheet enables the use of a thinner and lighter weight slit sheet paper as a void fill product. If the expanded slit sheet is not being used as a wrap, then the thicker 0.005”, 50 pounds per 3,000 square feet paper and above is not required and a lighter weight 0.003-0.0045″ thick, 30-40 pounds per 3,000 square feet paper can be used as void fill. It can also be used to provide cushioning that other paper void fill products have not been able to provide. It has now been found that even though the extensible paper has a 10% higher price, the use of a thinner paper provides much more square footage per ton and more than compensates for the increased cost of the extensible paper as compared to Kraft paper.”

“Of the various ranges of extensibility that may be employed, in some most preferred embodiments, the ranges of extensibility employed are greater than 4% in the machine direction, or, more preferably, greater than 5% in the machine direction, or, more preferably, greater than 6% in the machine direction. In some embodiments, these ranges of extensibility are up to 20% in the machine direction. In some other embodiments, these ranges of extensibility are up to 15% in the machine direction. In some other embodiments, these ranges of extensibility are up to 10% in the machine direction. In some other embodiments, these ranges of extensibility are up to 9% in the machine direction.”

### b. Further Embodiment Employing a Brush for Expanding Void-Fill

Further to the embodiments shown in FIGS. 74-86 employing, e.g., brushes for expanding wrap and void fill described in the preceding section, FIG. 87 shows a further embodiment of a brush for expanding void fill. In particular, FIG. 87 shows a circular brush **500 having brush bristles **501 extending radially inwardly from a peripheral ring **B. In this further embodiment, the brush is brush model number SK50369 sold by Precision Brush™ (www.precisionbrush.com/inside-disk-sk50369). In this further embodiment, the diameter D1 of the outer peripheral ring **B is 3½ inches and the inside diameter D2 (i.e., of the inside circular opening at the distal end of the bristles) is ¾ inches. Additionally, in this embodiment, the brush bristles are made with nylon and have a diameter of 0.008 inches.

In this further embodiment, the circular brush **500 is implemented to replace the circular dispensing donut type circular outlet employed in the automated dispenser for void fill shown and described herein in relation to FIG. 15. In this further embodiment, rather than employing inwardly extending projections of the type as shown in FIG. 17 that apply substantial friction that facilitates tearing of the expandable slit sheet paper, the automated dispenser shown in FIG. 15 is modified to replace the circular donut outlet with the circular brush **500 having inwardly extending projections in the form of the bristles of the circular brush **500, wherein the bristles of the circular brush **500 apply friction facilitating expansion of the expandable slit sheet paper without tearing of the expandable slit sheet paper.

As explained in the Definitions Section above, a “dispensing donut is specially configured to control the friction applied to achieve unique expansion while avoiding pre-mature tearing and while facilitating movement of the paper there-through that leads to contact of expanded cells in a manner to inhibit retraction after expansion. In some preferred embodiments, the dispensing donut is made of molded paper, plastic, metal or the like, and has a smooth surface that reduces the friction created from the edges of the dispensing area of the dispenser (such as, e.g., to avoid rough cardboard edges of a dispensing box or sharp cut edges of a metal dispenser).” In this further embodiment shown in FIG. 87, the circular dispensing donut includes a “smooth surface that reduces friction” made of “plastic” (i.e., nylon) by employing nylon plastic bristles that present a smooth surface facilitating expansion of the expandable slit sheet paper.

In this further embodiment, the circular brush **500, thus, operates to facilitate expansion of the expandable slit sheet paper in a like manner to the various dispensing donuts and other outlet embodiments described in the preceding sections.

### c. Further Embodiments for Expanding Void-Fill

In further embodiments according to inventor Goodrich, a circular brush, like that of the circular brush **500 employed in the embodiment shown in FIG. 87, can be implemented in the context of any of the forgoing embodiments of inventor Goodrich shown and described in relation to FIGS. 1-74. As some examples: i) in some embodiments, the donut 500, shown in the embodiments of FIGS. 5-6 and/or FIGS. 19-20, can be replaced with a circular brush **500 like that shown in FIG. 87; ii) in some embodiments, the aperture 1402 shown in FIG. 14 can be replaced with a circular brush **500 like that shown in FIG. 87; iii) in some embodiments, the adjuster 201B having the restriction area 202B shown in FIGS. 27-28 can be replaced with a circular brush **500 like that shown in FIG. 87.

In further embodiments according to inventor Goodrich, a circular brush **500 like that shown in FIG. 87 can be adapted to be adjustable similarly to that of embodiments of inventor Goodrich described above in relation to FIGS. 1-74, such as, e.g., similarly to the foregoing embodiments of inventor Goodrich shown and described in relation to, e.g.: a) FIG. 14 (e.g., wherein the aperture can be adjusted with, e.g., an adjustment screw or the like such that the hole diameter can be optimized in size); b) FIG. 27 (e.g., wherein the brush can be adjusted by separating the peripheral ring **B into two or more subsections that are reciprocated towards and away from one another for adjustment of the outlet); and c) FIG. 39 (e.g., wherein the brush can be adjusted by separating the peripheral ring into two or more subsections that are pivotally connected so as to pivotally move towards and away from one another for adjustment of the outlet).

In further embodiments according to inventor Goodrich, a circular brush **500 like that shown in FIG. 87 can be modified to have various diameters similar to that of diameters of outlets or donut members described in relation to embodiments of inventor Goodrich described above in relation to FIGS. 1-74. For example, in some embodiments, the diameter D1 of the outer peripheral ring can be similarly sized to the maximum dimension across the outlet set forth in embodiments of inventor Goodrich described in relation to FIGS. 1-74, such as, in some embodiments, e.g., i) wherein said diameter across said peripheral ring is less than 4 inches, ii) wherein said diameter across said peripheral ring is less than 3 inches, iii) wherein said diameter across said peripheral ring is less than 2.75 inches, iv) wherein said diameter across said peripheral ring is less than 2.5 inches. In various embodiments, the diameter across said peripheral ring is preferably between about 1 to 6 inches, and, more preferably, between about 1-½ to 5 inches, and, more preferably, between about 2 to 4 inches, and, more preferably, between about 2-½ to 3½ inches, and, more preferably, about 3 inches.

In further embodiments according to inventor Goodrich, a brush **500 like that shown in FIG. 87 and/or like that modified in the present section c) can be further modified to have non-circular configurations similar to any of the embodiments of inventor Goodrich described in relation to FIGS. 1-74. For example, in various embodiments, rather than employing a circular shape as shown in FIG. 87, the brush **500 can be non-circular, oval, D-shaped, lune shaped, irregularly shaped, and/or any other shape as shown or described in relation to any of the embodiments of inventor Goodrich described above in relation to FIGS. 1-74.

In further embodiments according to inventor Goodrich, a brush **500 like that shown in FIG. 87 and/or like that modified in the present section c) can be further modified to have other configurations like that of other friction members described herein above related to any of the embodiments of inventor Goodrich described in relation to any of FIGS. 74-86. For example, in some embodiments, the friction member can include any suitable flexible member(s). Additionally, in some embodiments, a brush *500 can include any of the brush structures or configurations as described herein related to the embodiments of inventor Goodrich described in relation to any of FIGS. 74-86. For example, in some embodiments, the brush can include a plurality of elongated flexible elements wherein each elongated flexible element is made of a flexible plastic or polymer, of a flexible metal, of a flexible natural fiber or element, and/or other elongated flexible elements. In some illustrative embodiments, a brush can include bristles made of one or more of aluminum, brass, bronze, copper, steel, stainless steel, plastic, PVC, nylon, synthetic or polymeric fibers, Kevlar™, foam (e.g., polypropylene foam), animal hair (e.g., horse hair, goat hair, etc.), plant fibers (e.g., Ixtle, Tampico fiber, etc.). In some embodiments, bristles can be elongated members with a substantially consistent diameter or width along a length thereof or can have a relatively varied diameter or width along a length thereof. In some embodiments, bristles can have a generally rounded peripheral surface, a generally cylindrical peripheral surface, a generally polygonal (e.g., square, hexagonal, etc.) peripheral surface, an irregular peripheral surface, etc. In some embodiments, the shapes of the bristles can be relatively consistent along lengths thereof, while in some embodiments, the shapes of the bristles can vary along the lengths thereof. In preferred embodiments, the bristles have a substantially consistent structure along the lengths thereof for consistency in qualities, such as, e.g., stiffness and flexibility. For further example, in some illustrative embodiments, bristles can be between about ½ inch to 4 inches long, or, in some preferred embodiments, between about ¾ inch to 3½ inches long, or, in some preferred embodiments, between about 1 inch to 3 inches long, or, in some preferred embodiments, between about 1½ inches to 2½ inches long.” For further example, in some illustrative embodiments, bristles can be employed having a width or diameter of less than about 0.2 inches, or, in some preferred embodiments, less than about 0.1 inches, or, in some preferred embodiments, less than about 0.05 inches, or, in some preferred embodiments, less than about 0.04 inches, or, in some preferred embodiments, less than about 0.03 inches, or, in some preferred embodiments, less than about 0.02 inches. In some illustrative embodiments, bristles can have a diameter of between about 0.005 to 0.05 inches, or, in some preferred embodiments, between about 0.0075 to 0.025 inches, or, in some preferred embodiments, between about 0.01 to 0.02 inches.

In further embodiments according to inventor Goodrich, a brush **500 like that shown in FIG. 87 and/or like that modified in the present section c) can be replaced with other friction members like of any of the friction members described above relation to any of the embodiments of inventor Goodrich described above in relation to any of FIGS. 74-86. For example, in other embodiments, the brush **500 can be replaced with other types of flexible members, such as, e.g., an elastomeric member, a flexible rubber member, a flexible plastic or polymeric member, a flexible metal member, a flexible sponge (or a plurality of flexible sponge elements), a flexible fabric (or a plurality of flexible fabric elements) and/or another flexible member or members. As another example, in some preferred embodiments, the flexible member includes a plurality of independently flexible or substantially independently flexible portions proximate a distal end (e.g., a distal end that is situated to contact the expandable slit sheet paper). As another example, in some preferred embodiments, such independently flexible or substantially independently flexible portions contact a single cell in a widthwise direction (e.g., cross direction) across the expandable slit sheet paper, such that forces imparted from a single cell during opening is substantially imparted to such independently flexible or substantially independently flexible portions. For example, in a brush containing flexible bristles or wires, each such flexible bristle or wire is independently flexible or substantially independently flexible. It should be appreciated that in a brush containing numerous bristles, such bristles would not be entirely independently flexibly movable due to their close proximity, such that bristles would necessarily press against one another during use. For example, in some embodiments, a flexible member can include a flexible member, such as, e.g., a flexible rubber member, a flexible plastic or polymeric member, a flexible metal member, or a flexible sponge member having a distal end with depending regions, such as, e.g., depending nubs, or tines, or arms, or elements. In some embodiments, the flexible member can be a flexible rake, with substantially independently movable tines. By way of example, [FIG. 76] shows an illustrative embodiment employing a friction member *550 having a plurality of depending portions *551. In some embodiments, the member *550 can be a unitary member, made with a flexible plastic or polymer, a flexible metal, or a flexible sponge. The lengths L, widths W, and depths D of the depending portions *551 can be selected based on the materials employed. In some preferred embodiments, the widths W would be less than or equal to the corresponding widths of the slits of the expandable slit sheet paper, such as, e.g., less than or equal to about ½ inch, or, in some embodiments, less than or equal to ⅓ inch, or, in some embodiments, less than or equal to ¼ inch.”

In further embodiments according to inventor Goodrich, a brush **500 like that shown in FIG. 87 and/or like that modified in the present section c) can be modified to be similar to any of the friction members described above relation to any of the embodiments of inventor Goodrich described above in relation to any of FIGS. 74-86. For example, in some variations, the friction member can have i) having a varied structure (e.g., employing a different type of friction member or employing a similar friction member (such as, e.g., a brush having bristles with different qualities or characteristics, such as, e.g., different flexibility, length, diameter, etc.) and/or by ii) adjusting the positioning of the friction member (e.g., distance from the surface and/or angular orientation) in a similar manner to that described above with respect to the foregoing embodiments.

In further embodiments according to inventor Goodrich, in contrast to the embodiment shown in FIG. 87, the brush bristles (or other friction members) do not extend entirely around the periphery of the outlet. For example, in some embodiments, brush bristles can extend along a portion of the periphery of the outlet. For example, in some embodiments, rather than extending 360 degrees around the outlet like the embodiment shown in FIG. 87, the bristles can extend around less than 270 degrees around the outlet, or, in some embodiments, less than 180 degrees around the outlet, or, in some embodiments, less than 90 degrees around the periphery of the outlet, or, in some embodiments, less than 45 degrees around the periphery of the outlet.

In further embodiments according to inventor Goodrich, a brush **500 like that shown in FIG. 87 and/or like that modified in the present section c) can be incorporated into any dispensers for expanding void fill or the like expandable slit sheet papers, including any other dispenser systems as shown in U.S. patent application Ser. No. 18,587,110 to inventor Goodrich, filed Feb. 26, 2024, the entire disclosure of which is incorporated herein by reference as though recited herein in full.

### Broad Scope of the Invention

While illustrative embodiments of the invention have been described herein, the present invention is not limited to the various preferred embodiments described herein, but includes any and all embodiments having equivalent elements, modifications, omissions, combinations (e.g., of aspects across various embodiments), adaptations and/or alterations as would be appreciated by those in the art based on the present disclosure. The limitations in the claims are to be interpreted broadly based on the language employed in the claims and not limited to examples described in the present specification or during the prosecution of the application, which examples are to be construed as non-exclusive. For example, in the present disclosure, the term “preferably” is non-exclusive and means “preferably, but not limited to.” In this disclosure and during the prosecution of this application, means-plus-function or step-plus-function limitations will only be employed where for a specific claim limitation all of the following conditions are present in that limitation: a) “means for” or “step for” is expressly recited; b) a corresponding function is expressly recited; and c) structure, material or acts that support that structure are not recited. In this disclosure and during the prosecution of this application, the terminology “present invention” or “invention” may be used as a reference to one or more aspect within the present disclosure. The language present invention or invention should not be improperly interpreted as an identification of criticality, should not be improperly interpreted as applying across all aspects or embodiments (i.e., it should be understood that the present invention has a number of aspects and embodiments), and should not be improperly interpreted as limiting the scope of the application or claims. In this disclosure and during the prosecution of this application, the terminology “embodiment” can be used to describe any aspect, feature, process or step, any combination thereof, and/or any portion thereof, etc. In some examples, various embodiments may include overlapping features. In this disclosure, the following abbreviated terminology may be employed: “e.g.” which means “for example.”

The use of individual numerical values is stated as approximations as though the values were preceded by the word “about”, “substantially”, or “approximately.” Similarly, the numerical values in the various ranges specified in this application, unless expressly indicated otherwise, are stated as approximations as though the minimum and maximum values within the stated ranges were both preceded by the word “about”, “substantially”, or “approximately.” In this manner, variations above and below the stated ranges can be used to achieve substantially the same results as values within the ranges. As used herein, the terms “about”, “substantially”, and “approximately” when referring to a numerical value shall have their plain and ordinary meanings to a person of ordinary skill in the art to which the disclosed subject matter is most closely related or the art relevant to the range or element at issue. The amount of broadening from the strict numerical boundary depends upon many factors. For example, some of the factors which may be considered include the criticality of the element and/or the effect a given amount of variation will have on the performance of the claimed subject matter, as well as other considerations known to those of skill in the art. As used herein, the use of differing amounts of significant digits for different numerical values is not meant to limit how the use of the words “about”, “substantially”, or “approximately” will serve to broaden a particular numerical value or range. Thus, as a general matter, “about”, “substantially”, or “approximately” broaden the numerical value. Also, the disclosure of ranges is intended as a continuous range including every value between the minimum and maximum values plus the broadening of the range afforded by the use of the term “about”, “substantially”, or “approximately”. Thus, recitation of ranges of values herein are merely intended to serve as a shorthand method of referring individually to each separate value falling within the range, unless otherwise indicated herein, and each separate value is incorporated into the specification as if it were individually recited herein. To the extent that determining a given amount of variation of some the factors such as the criticality of the slit patterns, paper width differential pre- and post- expansion, paper weights and type, as well as other considerations known to those of skill in the art to which the disclosed subject matter is most closely related or the art relevant to the range or element at issue will have on the performance of the claimed subject matter, is not considered to be within the ability of one of ordinary skill in the art, or is not explicitly stated in the claims, then the terms “about”, “substantially”, and “approximately” should be understood to mean the numerical value, plus or minus 15%. It is to be understood that any ranges, ratios and ranges of ratios that can be formed by, or derived from, any of the data disclosed herein represent further embodiments of the present disclosure and are included as part of the disclosure as though they were explicitly set forth. This includes ranges that can be formed that do or do not include a finite upper and/or lower boundary. Accordingly, a person of ordinary skill in the art most closely related to a particular range, ratio or range of ratios will appreciate that such values are unambiguously derivable from the data presented herein.

What is claimed is:

1. A dispenser for expanding and dispensing paper void fill, comprising:
a supply of expandable slit sheet paper;
a support for holding the supply of expandable slit sheet paper;
a friction member arranged proximate the supply of expandable slit sheet paper and arranged such that an end of the expandable slit sheet paper contacts said friction member as said expandable slit sheet paper is manually or automatically pulled based said friction member; and
said friction member including a plurality of inwardly extending projections configured to provide frictional resistance to the expandable slit sheet paper to cause the expandable slit sheet paper to expand into an expanded state with open cells.

2. The dispenser of claim 1, wherein said friction member is an outlet arranged proximate the supply of expandable slit sheet paper and arranged such that the end of the expandable slit sheet paper extends through said outlet, said outlet having a maximum cross dimension that is substantially smaller than the width of the expandable slit sheet paper

3. A dispenser for expanding and dispensing paper void fill, comprising:
a supply of expandable slit sheet paper;
a support for holding the supply of expandable slit sheet paper;
an outlet arranged proximate the supply of expandable slit sheet paper and arranged such that an end of the expandable slit sheet paper extends through said outlet, said outlet having a maximum cross dimension that is substantially smaller than the width of the expandable slit sheet paper; and
said outlet including a plurality of inwardly extending projections configured to provide frictional resistance to the expandable slit sheet paper to cause the expandable slit sheet paper to expand into an expanded state with open cells.

4. The dispenser of claims 1 or 3, wherein said inwardly extending projections are configured to facilitate expansion of the expandable slit sheet paper without tearing the expandable slit sheet paper.

5. The dispenser of claim 4, wherein said inwardly extending projections include bristles.

6. The dispenser of claim 5, wherein said bristles have a length of between about ½ inch and 1½ inch.

7. The dispenser of claims 1, 5 or 6, wherein said bristles are flexible.

8. The dispenser of any of claims 5 to 7, wherein said bristles have a diameter of between about 0.005 to 0.01 inches.

9. The dispenser of any of claims 5 to 8, wherein said bristles are made with plastic.

10. The dispenser of claim 9, wherein said bristles are made with nylon.

11. The dispenser of any of the preceding claims, wherein said supply of expandable slit sheet paper is a roll of expandable slit sheet paper.

12. The dispenser of claim 11, wherein said outlet is arranged to receive said slit sheet paper from a center of the roll of expandable slit sheet paper.

13. The dispenser of any of claims 11 or 12, wherein said outlet is aligned with a center axis of said roll of expandable slit sheet paper.

14. The dispenser of any of claims 11 or 12, wherein said outlet is laterally positioned adjacent a lateral side of the roll to receive said slit sheet paper from a center of the roll of expandable slit sheet paper.

15. The dispenser of any of the preceding claims, wherein the outlet includes a donut member fixed within a plate or panel.

16. The dispenser of claim 15, wherein the donut member is made with plastic or metal.

17. The dispenser of any of the preceding claims, wherein the dispenser is configured for manual operation with a user manually pulling the expandable slit sheet paper through the outlet.

18. The dispenser of any of the preceding claims, wherein the dispenser is configured for automated operation and includes at least one roller configured to move the expandable slit sheet paper through said outlet.

19. The dispenser according to any of the preceding claims, wherein said plurality of inwardly extending projections extend inwardly around at least ¼ of the perimeter of the outlet.

20. The dispenser according to any of the preceding claims, wherein said plurality of inwardly extending projections extend inwardly around at least ½ of the perimeter of the outlet.

21. The dispenser according to any of the preceding claims, wherein said plurality of inwardly extending projections extend inwardly around at least ¾ of the perimeter of the outlet.

22. The dispenser according to any of the preceding claims, wherein said plurality of inwardly extending projections extend inwardly around substantially the entire perimeter of the outlet.

23. The dispenser according to any of the preceding claims, wherein:
said outlet has a substantially circular perimeter.

24. The dispenser according to any of the preceding claims, wherein:
said outlet has a substantially D-shape perimeter.

25. The dispenser according to any of the preceding claims, wherein:
the outlet has a configuration that includes an arc that extends around at least ½ of the perimeter of the outlet.

26. The dispenser according to any of the preceding claims, wherein:
the outlet has a configuration that includes an arc that extends around at least ⅔ of the perimeter of the outlet.

27. The dispenser according to any of the preceding claims, wherein:
the outlet has a configuration in the shape of a semi-circle or half-circle or partial-circle.

28. The dispenser according to any of the preceding claims, wherein said outlet has a maximum dimension across said outlet of less than 5 inches.

29. The dispenser according to any of the preceding claims, wherein said outlet has a maximum dimension across said outlet of less than 4 inches.

30. The dispenser according to any of the preceding claims, wherein said outlet has a maximum dimension across said outlet of between 1-½ to 5 inches.

31. The dispenser according to any of the preceding claims, wherein said outlet has a maximum dimension across said outlet of between 2 to 4 inches.

32. The dispenser according to any of the preceding claims, wherein said expandable slit sheet paper is made of an extensible paper having an extensibility in a machine direction in a range of between 5-20%.

33. The dispenser according to any of the preceding claims, wherein said outlet is adjustable.

34. The dispenser according to any of the preceding claims, wherein said outlet includes at least a portion that is movable such as to adjust the size or shape of the outlet.

35. The dispenser of claim 1, wherein said inwardly extending projections are configured to facilitate tearing of the expandable slit sheet paper.

36. The dispenser of claim 35, wherein said inwardly extending projections are projecting teeth.

37. A method of forming a void fill product, comprising:
providing a sheet of expandable slit sheet paper in an unexpanded state, said sheet of expandable slit sheet paper having a length that is substantially greater than a width across the expandable slit sheet paper;
directing the expandable slit sheet paper through an outlet, said outlet having a maximum cross dimension that is substantially smaller than the width of the expandable slit sheet paper, and said outlet including a plurality of inwardly extending projections configured to provide frictional resistance to the expandable slit sheet paper; and
expanding the expandable slit sheet paper to an expanded state in which the slits of the expandable slit sheet paper expand into open cells due to friction applied by the outlet and causing regions of the expandable slit sheet paper across a widthwise direction of the expandable slit sheet paper to contact one another during said expanding or shortly after said expanding.

38. The method of claim 37, further comprising:
during directing of the expandable slit sheet paper through the outlet, causing the expandable slit sheet paper to twist, rotate or move around an axis extending through the outlet.

39. The method of any of claims 37 to 38, further comprising:
wherein said inwardly extending projections include bristles, said bristles engaging said expandable slit sheet paper as said expandable slit sheet paper is pulled through said outlet and said bristles flexibly bending while applying friction to said expandable slit sheet paper.

40. The method of any of claims 37 to 39, further comprising:
wherein said bristles are made with plastic.

41. The method of any of claims 37 to 39, wherein said bristles have a length of between about ½ inch and 1½ inch.

42. The method of claim 41, wherein said bristles have a diameter of between about 0.005 to 0.01 inches.
